(19) United States
(12) Patent Application Publication
(10) Pub. No.: US 2019/0384776 A1
(43) Pub. Date: Dec. 19, 2019

(54) INFORMATION PROCESSING APPARATUS AND NON-TRANSITORY COMPUTER READABLE MEDIUM

(71) Applicant: FUJI XEROX CO., LTD., Tokyo (JP)

(72) Inventors: Tomoyuki ITO, Kanagawa (JP); Shigehiro FURUKAWA, Kanagawa (JP); Masato ANDO, Kanagawa (JP)

(73) Assignee: FUJI XEROX CO., LTD., Tokyo (JP)

(21) Appl. No.: 16/437,081

(22) Filed: Jun. 11, 2019

(30) Foreign Application Priority Data
Jun. 18, 2018 (JP) 2018-115246
Jun. 18, 2018 (JP) 2018-115249

(51) Int. Cl. G06F 16/28; G06F 16/215; G06F 17/24

(52) U.S. Cl. CPC G06F 16/284; G06F 17/246; G06F 16/215

(57) ABSTRACT

An information processing apparatus includes: a correcting unit that corrects a relationship diagram corresponding to a deployment table when the deployment table is corrected; and a display unit that displays parts in the relationship diagram corrected by the correcting unit in such a way that a corrected part is displayed in a different mode from uncorrected parts.

### CROSS-REFERENCE TO RELATED APPLICATIONS

This application is based on and claims priority under 35 USC 119 from Japanese Patent Application No. 2018-115246 filed Jun. 18, 2018 and Japanese Patent Application No. 2018-115249 filed Jun. 18, 2018.

### BACKGROUND

### Technical Field

The present invention relates to an information processing apparatus and a non-transitory computer readable medium.

### Related Art

JP-A-2016-081185 discloses an object to facilitate creation of plural tables related to quality function deployment. The processing of the quality function deployment disclosed in JP-A-2016-081185 is performed as follows. Function items having a dependency relationship are connected according to the dependency relationship. On a system diagram in which plural function items are organized, a relationship diagram is created in which function items each belonging to any one process are each given attribute information that identifies the process to which the function item belongs. When the relationship diagram is input, each function item, attribute information of the function item, and dependency information of the function item are extracted from the relationship diagram, and stored as original information. Thereafter, axes for a deployment table or a multiple table are set, so that the original information is used to create and output a deployment table or a multiple table according to the set axes.

For example, in designing a product, a relationship diagram and a deployment table are used. Such a relationship diagram is suitable for describing results and their factors in detail without omission or redundancy. Meanwhile, such a deployment table is suitable for simply expressing relationships between plural results and plural factors. A relationship diagram is generated from a deployment table, whereas a deployment table is generated from a relationship diagram. Then, when one is corrected, it is necessary to correct the other according to the correction. To correct a relationship diagram and a deployment table, which have the properties mentioned above, it is desirable to correct the relationship diagram first and reflect the correction in the deployment table.

In some practical cases, however, a deployment table needs to be corrected first. In such cases, the correction of a deployment table is then reflected in a relationship diagram. When the correction is performed in that order, confirming the correction on the relationship diagram is an important process because of the properties mentioned above.

For example, in a relationship diagram where elements A, B, and C are a cause, a result of the element A, and a result of the element B, respectively, the elements A and B are connected by a relationship line and the elements B and C are connected by another relationship line. On the other hand, when the elements A and C are on first and second axes, respectively, in a deployment table corresponding to the relationship diagram and when the element B is not present in the deployment table, a mark indicating a causal relationship between the elements A and C is drawn on the deployment table (specifically, a circle mark is drawn in a cell at the intersection between the elements A and C in the matrix of the deployment table). In this case, the relationship diagram will have two relationship lines corresponding to the causal relationship between them (a relationship line connecting the elements A and B and another relationship line connecting the elements B and C). Thus, when the causal relationship between the elements A and C is deleted on the deployment table, it is not possible to automatically determine which relationship line should be deleted or whether both relationship lines should be deleted. This causes an obstacle in linkage between the deployment table and the relationship diagram.

### SUMMARY

Aspects of non-limiting embodiments of the present disclosure relate to providing an information processing apparatus and a non-transitory computer readable medium, which facilitate the user to understand what is corrected on a deployment table when the deployment table is corrected and the correction is then reflected in a relationship diagram.

Aspects of non-limiting embodiments of the present disclosure also relate to providing an information processing apparatus and a non-transitory computer readable medium, which allow the user to determine, on a relationship diagram corresponding to a deployment table, a relationship line indicating a causal relationship to be deleted, when an operation is performed instructing to delete the causal relationship in the deployment table.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing apparatus including: a correcting unit that corrects a relationship diagram corresponding to a deployment table when the deployment table is corrected; and a display unit that displays parts in the relationship diagram corrected by the correcting unit in such a way that a corrected part is displayed in a different mode from uncorrected parts.

### BRIEF DESCRIPTION OF THE DRAWINGS

Exemplary embodiments of the present invention will be described in detail based on the following figures, wherein:

FIG. 1 is a schematic module diagram of an example of a configuration according to a first exemplary embodiment;

FIG. 2 is an explanatory view illustrating an example of a system configuration according to the exemplary embodiment;

FIG. 3 is a flowchart illustrating an example of a processing according to the first exemplary embodiment;

FIG. 4 is an explanatory view of an example of a technique as a target of a relationship diagram and a deployment table;

FIG. 5 is an explanatory view illustrating an example of the relationship diagram;

FIG. 6 is an explanatory view illustrating an example of the relationship diagram;

FIG. 7 is an explanatory view illustrating an example of the relationship diagram;

FIG. 8 is an explanatory view illustrating an example of the deployment table;

FIG. 9 is an explanatory view illustrating an example of a data structure of a relationship diagram information table;

FIG. 10 is an explanatory view illustrating an example of a data structure of an item information table;

FIG. 11 is an explanatory view illustrating an example of a data structure of a relationship line information table;

FIG. 12 is an explanatory view illustrating an example of a data structure of a deployment table information table;

FIG. 13 is an explanatory view illustrating an example of a data structure of an axis item information table;

FIG. 14 is an explanatory view illustrating an example of a data structure of a causal relationship information table;

FIG. 15 is an explanatory view illustrating an example of a data structure of a relationship diagram ID deployment table ID relationship table;

FIG. 16 is an explanatory view illustrating an example of a data structure of an item ID axis item ID relationship table;

FIG. 17 is an explanatory view illustrating an example of a data structure of a relationship line ID causal relationship information ID relationship table;

FIG. 18 is a flowchart illustrating an example of a processing according to the first exemplary embodiment;

FIGS. 19A and 19B are explanatory views illustrating an example of a processing according to the first exemplary embodiment;

FIG. 20 is an explanatory view illustrating an example of a processing according to the first exemplary embodiment;

FIGS. 21A and 21B are explanatory views illustrating an example of a processing according to the first exemplary embodiment;

FIGS. 22A and 22B are explanatory views illustrating an example of a processing according to the first exemplary embodiment;

FIGS. 23A and 23B are explanatory views illustrating an example of a processing according to the first exemplary embodiment;

FIGS. 24A and 24B are explanatory views illustrating an example of a processing according to the first exemplary embodiment;

FIGS. 25A and 25B are explanatory views illustrating an example of a processing according to the first exemplary embodiment;

FIGS. 26A and 26B are explanatory views illustrating an example of a processing according to the first exemplary embodiment;

FIGS. 27A and 27B are explanatory views illustrating an example of a processing according to the first exemplary embodiment;

FIG. 28 is a schematic module diagram of an example of a configuration according to a second exemplary embodiment;

FIG. 29A is a flowchart illustrating an example of a processing according to the second exemplary embodiment;

FIG. 29B is a flowchart illustrating an example of the processing according to the second exemplary embodiment;

FIG. 30 is a flowchart illustrating an example of a processing according to the second exemplary embodiment;

FIG. 31A is a flowchart illustrating an example of a processing according to the second exemplary embodiment;

FIG. 31B is a flowchart illustrating an example of the processing according to the second exemplary embodiment;

FIG. 32 is an explanatory view illustrating an example of the relationship diagram;

FIG. 33 is an explanatory view illustrating an example of the deployment table;

FIG. 34 is an explanatory view illustrating an example of the deployment table;

FIG. 35 is an explanatory view illustrating an example of the relationship diagram;

FIG. 36 is an explanatory view illustrating an example of the relationship diagram;

FIG. 37 is a flowchart illustrating an example of a processing according to the second exemplary embodiment;

FIG. 38 is an explanatory view illustrating an example of the deployment table;

FIG. 39 is an explanatory view illustrating an example of a relationship diagram created from a deployment table;

FIG. 40 is an explanatory view illustrating an example of the relationship diagram;

FIG. 41 is an explanatory view illustrating an example of the relationship diagram;

FIG. 42 is a schematic module diagram of an example of a configuration according to a third exemplary embodiment;

FIG. 43 is a flowchart illustrating an example of a processing according to the third exemplary embodiment;

FIG. 44 is a flowchart illustrating an example of a processing according to the third exemplary embodiment;

FIG. 45 is a flowchart illustrating an example of a processing according to the third exemplary embodiment;

FIG. 46 is a flowchart illustrating an example of a processing according to the third exemplary embodiment;

FIG. 47 is a flowchart illustrating an example of a processing according to the third exemplary embodiment;

FIG. 48 is a flowchart illustrating an example of a processing according to the third exemplary embodiment;

FIG. 49 is an explanatory view illustrating an example of the relationship diagram;

FIG. 50 is an explanatory view illustrating an example of the deployment table;

FIG. 51 is an explanatory view illustrating an example of a deleting operation on a deployment table;

FIG. 52 is an explanatory view illustrating an example of the relationship diagram;

FIG. 53 is an explanatory view illustrating an example of the deployment table;

FIG. 54 is an explanatory view illustrating an example of the relationship diagram;

FIG. 55 is an explanatory view illustrating an example of the deployment table;

FIG. 56 is an explanatory view illustrating an example of the relationship diagram;

FIG. 57 is an explanatory view illustrating an example of a data structure of a relationship diagram term deployment table term correspondence table;

FIG. 58 is an explanatory view illustrating an example of a data structure of the relationship diagram term deployment table term correspondence table; and

FIG. 59 is a block diagram illustrating an example of a hardware configuration of a computer that realizes the exemplary embodiment.

### DETAILED DESCRIPTION

Hereinafter, descriptions will be made on examples of various exemplary embodiments suitable for implementing the disclosure with reference to the accompanying drawings.

### First Exemplary Embodiment

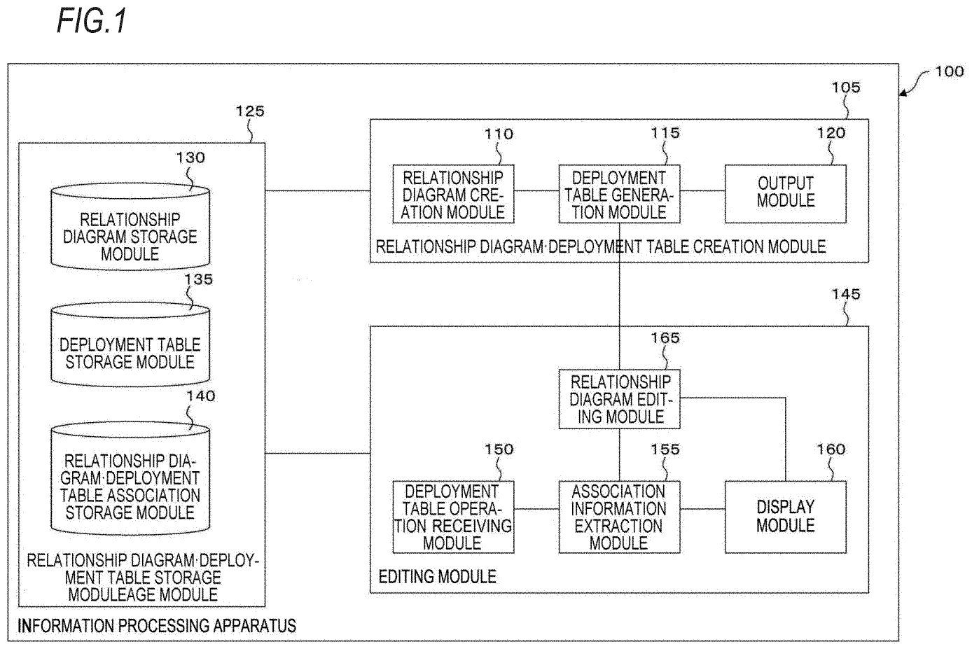

FIG. 1 illustrates a schematic module diagram of an example of a configuration in a first exemplary embodiment.

A module generally refers to a logically separable component such as software (a computer program) or hardware. Accordingly, a module in the present exemplary embodiment refers to not only a module in a computer program, but also a module in a hardware configuration. Thus, the present exemplary embodiment also describes a computer program (a program causing a computer to execute each procedure, a program causing a computer to function as each unit, and a program causing a computer to implement each function), a system and a method, which are allowed to serve as these modules. Meanwhile, for the convenience of descriptions, the expressions “store” “caused to be stored,” and equivalent expressions will be used. When the exemplary embodiment relates to a computer program, the expressions indicate that the computer program is stored or controlled to be stored in a storage device. In addition, one module may correspond to one function. In implementation, however, one module may be constituted by one program, plural modules may be constituted by one program, and conversely, one module may be constituted by plural programs. Further, plural modules may be executed by one computer, or one module may be executed by plural computers in a distributed or parallel environment. In addition, one module may include another module. In addition, hereinafter, the term “connection” is used for a case of not only a physical connection, but also a logical connection (e.g., a data exchange, an instruction, a reference relationship between data, and a login). The term “predetermined” refers to being determined prior to a target processing, and includes the meaning of being determined according to a circumstance/state at or until a specific time point as long as the target processing is not yet performed before a processing according to the present exemplary embodiment is started, or even after the processing according to the present exemplary embodiment is started. When plural “predetermined values” exist, the values may be different from each other, or two or more of the values (including any values) may be identical to each other. In addition, the description “when it is A, B is performed” indicates that “it is determined whether it is A or not, and when it is determined that it is A, B is performed,” except for a case where the determination of whether it is A or not is unnecessary. In addition, when items are enumerated like “A, B, and C,” the enumeration is merely exemplary unless otherwise specified, and includes a case where only one (e.g., only A) is selected.

In addition, a configuration of a system or an apparatus includes not only a configuration in which, for example, plural computers, hardware components, and apparatuses are connected to each other via a communication unit such as a network (including a one-to-one corresponding communication connection), but also a configuration implemented with, for example, one computer, hardware component, or apparatus. The terms “apparatus” and “system” are used to have the same meaning. The “system” does not include a system that is merely a social “structure” (social system) which is an artificial engagement.

In each processing by each module or in each of plural processes in a case where the plural processes are performed in the module, target information is read from a storage device, and a processing result is written in the storage device after the processing is performed. Accordingly, descriptions regarding the reading from the storage device prior the processing, and the writing in the storage device after the processing may be omitted. In addition, examples of the storage device may include a hard disk, a random access memory (RAM), an external storage medium, a storage device via a communication line, and a register in a central processing unit (CPU).

An information processing apparatus 100 according to the first exemplary embodiment edits a relationship diagram and a deployment table, and includes a relationship diagram deployment table creation module 105, a relationship diagram deployment table storage module 125, and an editing module 145 as illustrated in the example of FIG. 1.

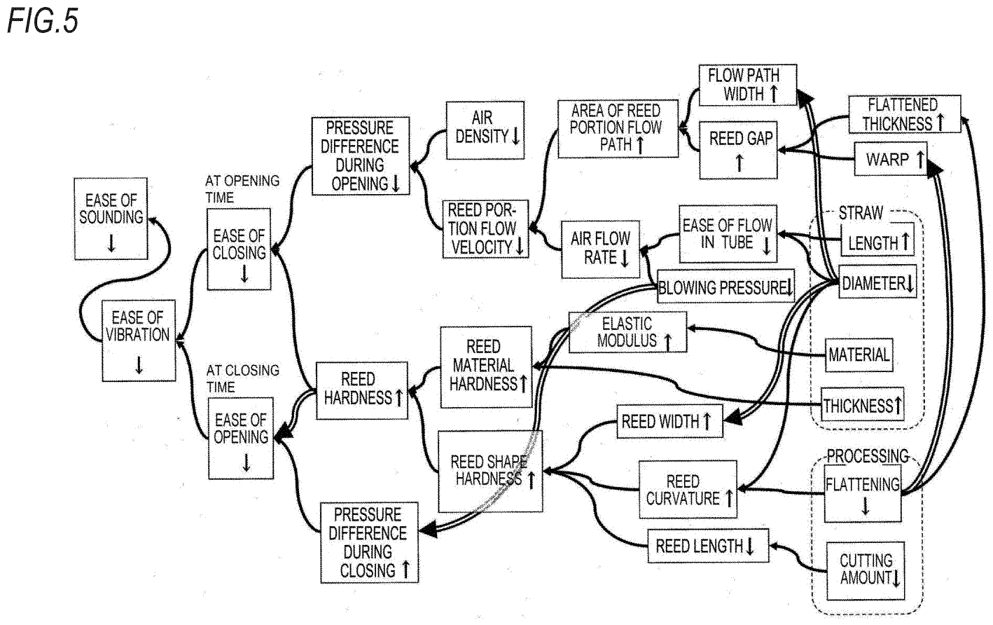

Here, the use of the “relationship diagram” is a method used to clarify a causal relationship between elements in a circumstance where a problem to be solved is clear but various elements as causes of the problem are intertwined with each other. The relationship diagram is made up of items and relationship lines as illustrated in the example of FIG. 5. Here, the “item” corresponds to a node (node, vertex) in a graph theory. The “relationship line” corresponds to an edge (branch) in the graph theory. That is, the “relationship diagram” expresses relationships through connections between the items (also called elements) via the relationship lines (also called connection lines). For example, a tree diagram (also called, for example, a tree graph) is a typical example.

The “deployment table (also called a quality function deployment table)” indicates relationships between items listed on plural axes orthogonal to each other, through symbols or numerical values arranged in a matrix form.

The relationship diagram deployment table creation module 105 includes a relationship diagram creation module 110, a deployment table generation module 115, and an output module 120, and is connected to the relationship diagram deployment table storage module 125. The relationship diagram deployment table creation module 105 creates a relationship diagram, generates a deployment table from the relationship diagram, and outputs the relationship diagram and the deployment table. For example, the technique described in JP-A-2016-081185 may be used.

The relationship diagram creation module 110 is connected to the deployment table generation module 115. The relationship diagram creation module 110 receives information required for creating a relationship diagram. For example, the relationship diagram creation module 110 receives information, such as the name of a relationship diagram, items, item contents, and relationship lines indicating relationships between items, which are created through, for example, an operation of keyboard keys and a mouse by a user on a user interface displayed on a display device such as a liquid crystal display. In addition to receiving the information through, for example, the operation of keyboard keys by the user, information stored in, for example, a hard disk (including one connected via, for example, a network, in addition to one mounted in a computer) may be read.

For example, the relationship diagram creation module 110 receives plural elements, attribute information on each element, which includes a process to which the element belongs, and instructions to create or edit a causal relationship between the plural elements, and creates or edits the relationship diagram.

The deployment table generation module 115 is connected to the relationship diagram creation module 110, the output module 120, and a relationship diagram editing module 165 of the editing module 145. The deployment table generation module 115 generates a deployment table with respect to a relationship diagram created by the relationship diagram creation module 110.

When a relationship diagram displayed by a display module 160 is corrected, the deployment table generation module 115 may generate a deployment table from the corrected relationship diagram. That is, the deployment table generation module 115 may generate a deployment table with respect to not only a relationship diagram created by the relationship diagram creation module 110, but also a relationship diagram edited by the relationship diagram editing module 165. In this generation processing, a relationship diagram ID deployment table ID relationship table 1500, an item ID axis item ID relationship table 1600, and a relationship line ID causal relationship information ID relationship table 1700 in a relationship diagram deployment table association storage module 140 are generated.

The output module 120 is connected to the deployment table generation module 115. The output module 120 outputs a relationship diagram created by the relationship diagram creation module 110 (that may include a relationship diagram edited by the relationship diagram editing module 165), and a deployment table generated by the deployment table generation module 115 (that may include a deployment table generated based on the relationship diagram created by the relationship diagram creation module 110, and a deployment table generated based on the relationship diagram edited by the relationship diagram editing module 165). Here, examples of outputting the relationship diagram and the deployment table may include displaying on a display device such as a display, printing with a printing device such as a printer, transmitting an image through an image transmission device such as a facsimile, writing on a storage device such as a database, storing in a storage medium such as a memory card, and transferring to another information processing apparatus.

The relationship diagram deployment table storage module 125 includes a relationship diagram storage module 130, a deployment table storage module 135, and the relationship diagram deployment table association storage module 140, and is connected to the relationship diagram deployment table creation module 105, and the editing module 145. The relationship diagram deployment table storage module 125 stores information on a relationship diagram and a deployment table.

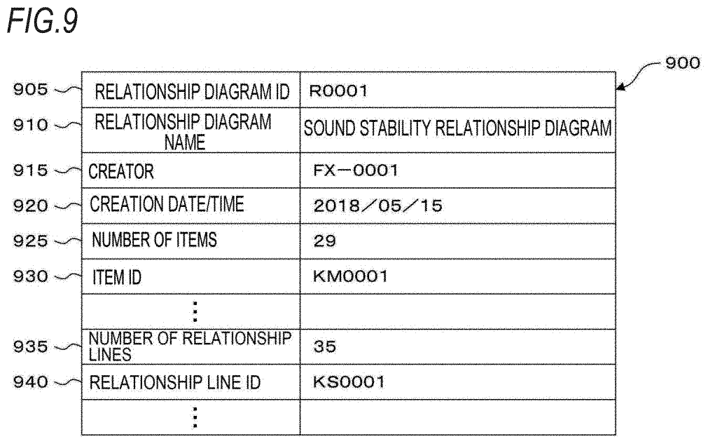

The relationship diagram storage module 130 stores information of a relationship diagram. As a specific example, the relationship diagram storage module 130 stores a relationship diagram information table 900, an item information table 1000, and a relationship line information table 1100. FIG. 9 is an explanatory view illustrating an example of a data structure of the relationship diagram information table 900. The relationship diagram information table 900 includes a relationship diagram ID field 905, a relationship diagram name field 910, a creator field 915, a creation date/time field 920, a number of items field 925, an item ID field 930, a number of relationship lines field 935, and a relationship line ID field 940. The relationship diagram ID field 905 stores information for uniquely identifying a relationship diagram (relationship diagram identification (ID), in the first exemplary embodiment. The relationship diagram name field 910 stores a name of the relationship diagram of the relationship diagram ID. The creator field 915 stores a creator of the relationship diagram. The creation date/time field 920 stores date/time when the relationship diagram is created or edited (year, month, day, hour, minute, second, sub-second, or a combination thereof). The number of items field 925 stores the number of items in the relationship diagram. The item ID field 930 is subsequently continued in accordance with the number of items in the number of items field 925. The item ID field 930 stores information for uniquely identifying an item (item ID), in the first exemplary embodiment. The information indicated by the item ID is stored in the item information table 1000. The number of relationship lines field 935 stores the number of relationship lines in the relationship diagram. The relationship line ID field 940 is subsequently continued in accordance with the number of relationship lines in the number of relationship lines field 935. The relationship line ID field 940 stores information for uniquely identifying a relationship line (relationship line ID), in the first exemplary embodiment. The information indicated by the relationship line ID is stored in the relationship line information table 1100.

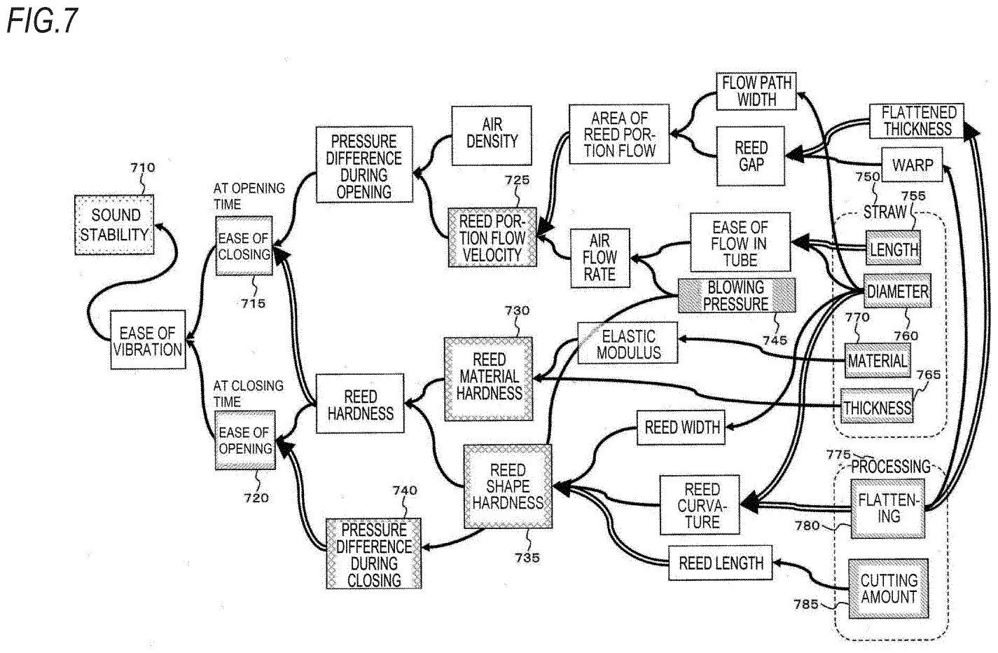

For example, regarding the “sound stability relationship diagram” illustrated in FIG. 7, as illustrated in FIG. 9, the relationship diagram information table 900 stores “R0001” in the relationship diagram ID field 905, “sound stability relationship diagram” in the relationship diagram name field 910, “FX-0001” in the creator field 915, “2018/05/15” in the creation date/time field 920, “29” in the number of items field 925, “KM0001” in the item ID field 930, “35” in the number of relationship lines field 935, and “KS0001” in the relationship line ID field 940, respectively.

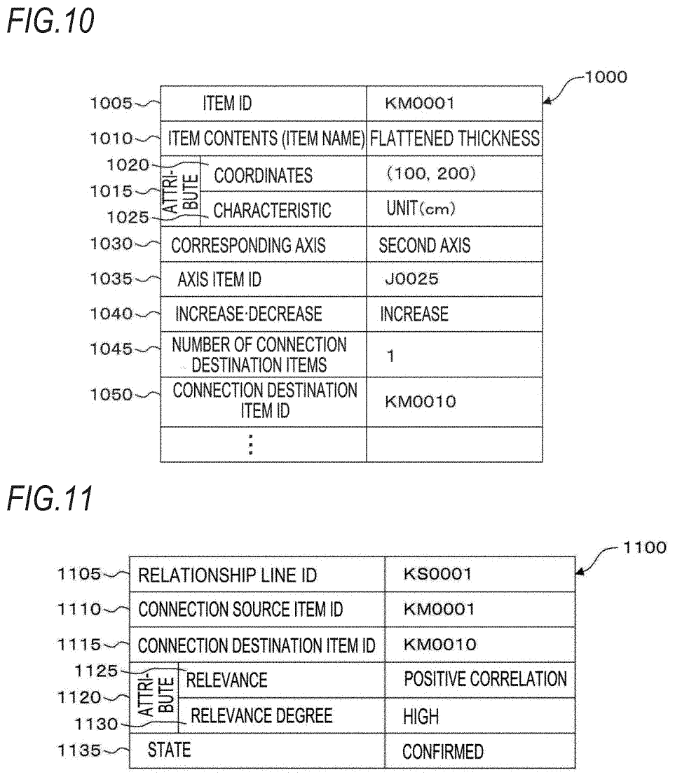

FIG. 10 is an explanatory view illustrating an example of a data structure of the item information table 1000. The item information table 1000 includes an item ID field 1005, an item contents field 1010, an attribute field 1015, a corresponding axis field 1030, an axis item ID field 1035, an increase decrease field 1040, a number of connection destination items field 1045, and a connection destination item ID field 1050. Here, the attribute field 1015 includes a coordinate field 1020, and a characteristic field 1025. The item ID field 1005 stores an item ID for identifying an item. The item contents field 1010 stores item contents of the item ID (e.g., an item name). The attribute field 1015 stores various attributes. The coordinate field 1020 stores coordinates indicating a position of a display on a relationship diagram. These coordinates may be coordinates indicating an absolute position with the origin at the upper left, or may be coordinates indicating a relative position. The characteristic field 1025 stores the characteristic of contents expressed by this item. The corresponding axis field 1030 stores a corresponding axis on a deployment table. The axis item ID field 1035 stores an axis item ID for identifying each of items defined on plural axes expressed on the deployment table. The increase decrease field 1040 stores information as to whether a value expressing a characteristic is increasing or decreasing. The number of connection destination items field 1045 stores the number of items as destinations to which the item is connected. The connection destination item ID field 1050 is subsequently continued in accordance with the number of items in the number of connection destination items field 1045. The connection destination item ID field 1050 stores a connection destination item ID.

For example, regarding the “sound stability relationship diagram” illustrated in FIG. 7, as illustrated in FIG. 10, the item information table 1000 stores “KM0001” in the item ID field 1005, “flattened thickness” in the item contents (item name) field 1010, “(100, 200)” in the coordinate field 1020 of the attribute field 1015, “unit (cm)” in the characteristic field 1025 of the attribute field 1015, “second axis” in the corresponding axis field 1030, “J0025” in the axis item ID field 1035, “increase (positive)” in the increase decrease field 1040, “1” in the number of connection destination items field 1045, and “KM0010” in the connection destination item ID field 1050, respectively. In addition, for example, “parameter value” and “target value” may be included in the coordinate field 1020 of the attribute field 1015. In addition, for example, “decrease (negative)” and “unknown” may be included in the increase decrease field 1040.

FIG. 11 is an explanatory view illustrating an example of a data structure of the relationship line information table 1100. The relationship line information table 1100 includes a relationship line ID field 1105, a connection source item ID field 1110, a connection destination item ID field 1115, an attribute field 1120, and a state field 1135. The attribute field 1120 includes a relevance field 1125, and a relevance degree field 1130. The relationship line ID field 1105 stores a relationship line ID. The connection source item ID field 1110 stores an item ID of an item as a connection source on the relationship line. The connection destination item ID field 1115 stores an item ID of an item as a connection destination on the relationship line. The attribute field 1120 stores attributes of the relationship line. As the attributes, for example, there is a relationship between items connected by the relationship line (e.g., a relationship in which as a numerical value of an item as a connection source increases, a numerical value of an item as a connection destination increases (e.g., direct proportion), or a relationship in which as a numerical value of an item as a connection source increases, a numerical value of an item as a connection destination decreases (e.g., inverse proportion)). The relevance field 1125 stores a relevance. The relevance degree field 1130 stores a relevance degree.

For example, regarding the “sound stability relationship diagram” illustrated in FIG. 7, as illustrated in FIG. 11, the relationship line information table 1100 stores “KS0001” in the relationship line ID field 1105, “KM0001” in the connection source item ID field 1110, “KM0010” in the connection destination item ID field 1115, “positive correlation” in the relevance field 1125 of the attribute field 1120, “high” in the relevance degree field 1130 of the attribute field 1120, and “confirmed” in the state field 1135, respectively. In addition, there may be, for example, “inverse correlation” or “unknown” in the relevance field 1125 of the attribute field 1120. In addition, there may be, for example, “medium,” “small,” or “unknown” in the relevance degree field 1130 of the attribute field 1120. In addition, there may be, for example, “unconfirmed” or “rejected” in the state field 1135.

FIGS. 9 to 11 are merely exemplary, and other data structures may be employed. For example, a data structure indicating a graph structure may be used.

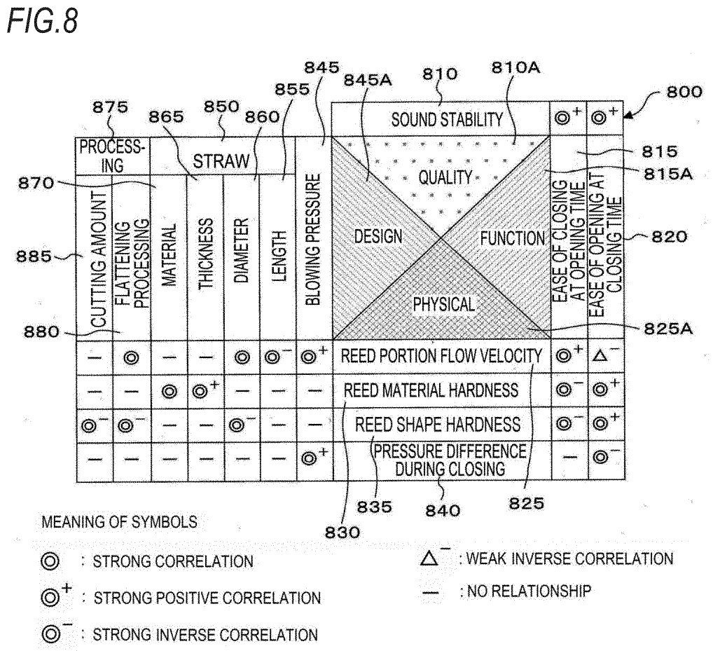

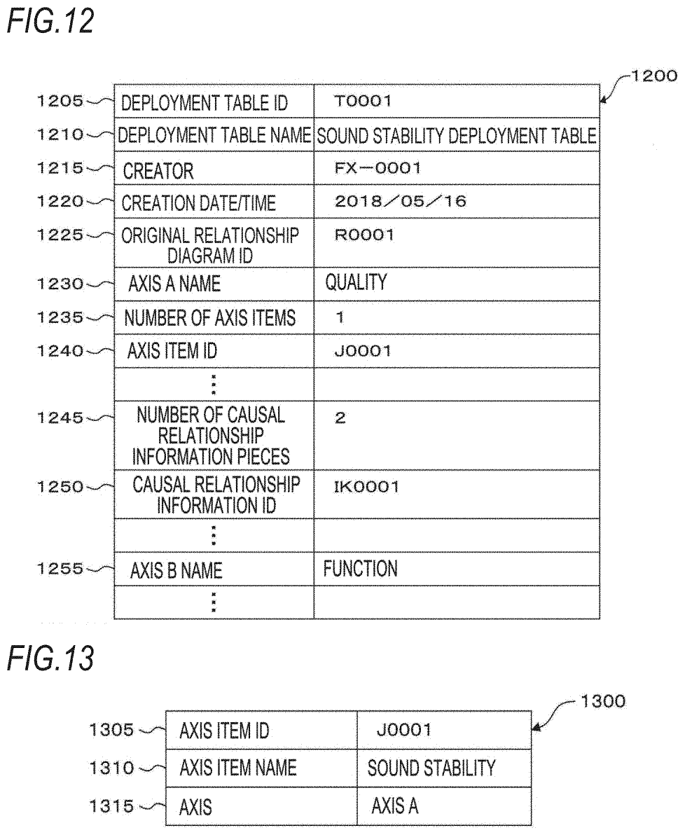

The deployment table storage module 135 stores information of a deployment table. As a specific example, the deployment table storage module 135 stores a deployment table information table 1200, an axis item information table 1300, and a causal relationship information table 1400. FIG. 12 is an explanatory view illustrating an example of a data structure of the deployment table information table 1200. The deployment table information table 1200 includes, for example, a deployment table ID field 1205, a deployment table name field 1210, a creator field 1215, a creation date/time field 1220, an original relationship diagram ID field 1225, an axis A name field 1230, a number of axis items field 1235, an axis item ID field 1240, a number of causal relationship information pieces field 1245, and a causal relationship information ID field 1250. The deployment table ID field 1205 stores information for uniquely identifying a deployment table (deployment table ID), in the first exemplary embodiment. The deployment table name field 1210 stores a name of the deployment table with the deployment table ID. The creator field 1215 stores a creator of the deployment table. The creation date/time field 1220 stores the date/time when the deployment table is created. The original relationship diagram ID field 1225 stores a relationship diagram ID as a source from which the deployment table is made. That is, the deployment table generation module 115 refers to the corresponding relationship diagram when generating the deployment table. The axis A name field 1230 stores a name of an axis A (first axis). For example, this corresponds to a name (quality) of a first axis (quality) 810A illustrated in FIG. 8. Regarding the axis A, there are the number of axis items field 1235 to the causal relationship information ID field 1250. Then, in a case of four axes, the same data as the number of axis items field 1235 to the causal relationship information ID field 1250 is present for an axis B, an axis C, and an axis D as well. The number of axis items field 1235 stores the number of items in the axis (axis A). The axis item ID field 1240 is subsequently continued as many times as the number of items in the number of axis items field 1235. The axis item ID field 1240 stores information (axis item ID) that uniquely identifies an axis item in the first exemplary embodiment. The information indicated by the axis item ID is stored in the axis item information table 1300. The number of causal relationship information pieces field 1245 stores the number of causal relationship information pieces. The causal relationship information indicates a field (cell) in which, for example, “⊚,” “Δ,” or “□” is described in the example of FIG. 8. The causal relationship information ID field 1250 is subsequently continued in accordance with the number of causal relationship information pieces in the number of causal relationship information pieces field 1245. The causal relationship information ID field 1250 stores information for uniquely identifying causal relationship information (causal relationship information ID), in the first exemplary embodiment. Similar fields are repeatedly continued for an axis B, an axis C, and an axis D (second axis to fourth axis) (such as the axis B name field 1255 storing a name of an axis B) as well. The information indicated by the causal relationship information ID is stored in the causal relationship information table 1400.

For example, regarding a “sound stability deployment table” illustrated in FIG. 8, as illustrated in FIG. 12, the deployment table information table 1200 stores “T0001” in the deployment table ID field 1205, “sound stability deployment table” in the deployment table name field 1210, “FX-0001” in the creator field 1215, “2018/05/16” in the creation date/time field 1220, “R0001” in the original relationship diagram ID field 1225, “quality” in the axis A name field 1230, “1” in the number of axis items field 1235, “J0001” in the axis item ID field 1240, “2” in the number of causal relationship information pieces field 1245, and “IK0001” in the causal relationship information ID field 1250, respectively.

FIG. 13 is an explanatory view illustrating an example of a data structure of the axis item information table 1300. The axis item information table 1300 includes an axis item ID field 1305, an axis item name field 1310, and an axis field 1315. The axis item ID field 1305 stores an axis item ID. The axis item name field 1310 stores a name of an axis item with the axis item ID. For example, this corresponds to a name (sound stability) of an axis item (sound stability) 810 illustrated in FIG. 8. The axis field 1315 stores an axis to which the axis item belongs.

For example, regarding the “sound stability deployment table” illustrated in FIG. 8, as illustrated in FIG. 13, the axis item information table 1300 stores “J0001” in the axis item ID field 1305, “sound stability” in the axis item name field 1310, and “axis A” in the axis field 1315, respectively.

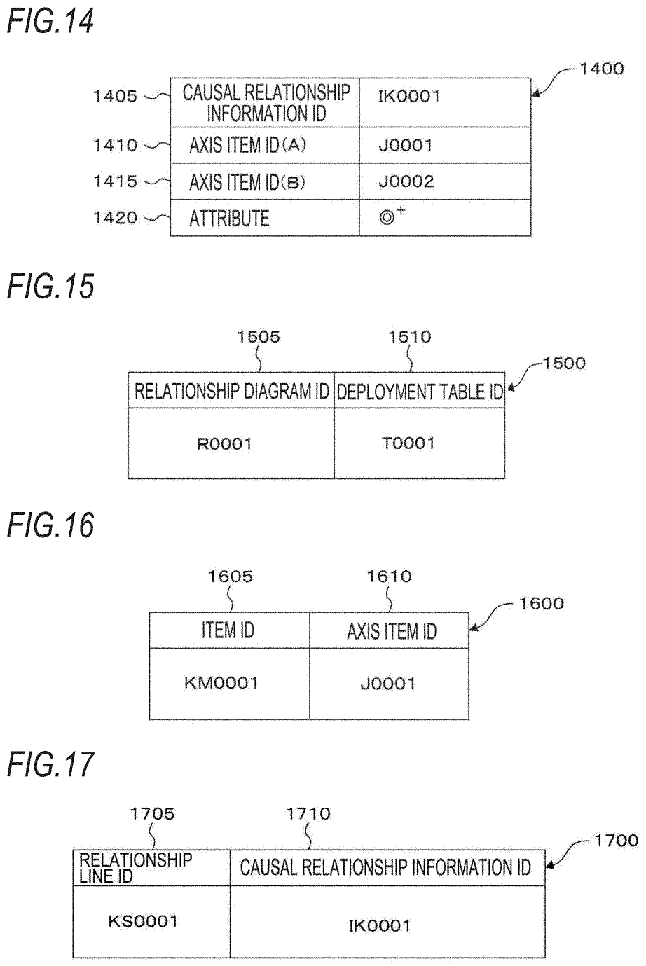

FIG. 14 is an explanatory view illustrating an example of a data structure of the causal relationship information table 1400. The causal relationship information table 1400 includes a causal relationship information ID field 1405, an axis item ID (A) field 1410, an axis item ID (B) field 1415, and an attribute field 1420. The causal relationship information ID field 1405 stores a causal relationship information ID. The axis item ID (A) field 1410 stores an axis item ID (A). The axis item ID (B) field 1415 stores an axis item ID (B). That is, a position where the axis item ID (A) field 1410 and the axis item ID (B) field 1415 cross each other indicates a position of the causal relationship information on a deployment table. The attribute field 1420 stores attributes. For example, information such as “⊚+,” “⊚−,” “Δ+,” “Δ−,” and “□” corresponds to the attributes.

For example, regarding the “sound stability deployment table” illustrated in FIG. 8, as illustrated in FIG. 14, the causal relationship information table 1400 stores “IK0001” in the causal relationship information ID field 1405, “J0001” in the axis item ID (A) field 1410, “J0002” in the axis item ID (B) field 1415, and “⊚−” in the attribute field 1420, respectively.

The relationship diagram deployment table association storage module 140 associates a deployment table with a relationship diagram. The relationship diagram deployment table association storage module 140 stores, for example, information that associates a deployment table with a relationship diagram. As a specific example, FIG. 15 is an explanatory view illustrating an example of a data structure of the relationship diagram ID deployment table ID relationship table 1500. The relationship diagram ID deployment table ID relationship table 1500 includes a relationship diagram ID field 1505, and a deployment table ID field 1510. The relationship diagram ID field 1505 stores a relationship diagram ID. The deployment table ID field 1510 stores a deployment table ID corresponding to the relationship diagram ID. Specifically, when the deployment table generation module 115 generates a deployment table from a relationship diagram, the relationship diagram ID deployment table ID relationship table 1500 is generated. The value of the relationship diagram ID field 1505 is a relationship diagram ID indicating the relationship diagram as a generation source, and the value of the deployment table ID field 1510 is a deployment table ID indicating the generated deployment table. Plural deployment tables may correspond to one relationship diagram. This is because it is possible to generate plural deployment tables depending on which item in a relationship diagram is selected as an axis item of a deployment table.

For example, regarding the correspondence between the “sound stability relationship diagram” illustrated in FIG. 7 and the “sound stability deployment table” illustrated in FIG. 8, as illustrated in FIG. 15, the relationship diagram ID deployment table ID relationship table 1500 stores “R0001” in the relationship diagram ID field 1505, and “T0001” in the deployment table ID field 1510, respectively.

Then, the relationship diagram deployment table association storage module 140 associates an axis item, that is an item included in an axis of a deployment table, with an item in a relationship diagram. The relationship diagram deployment table association storage module 140 stores, for example, information that associates an axis item, that is an item included in an axis of a deployment table, with an item in a relationship diagram. As a specific example, FIG. 16 is an explanatory view illustrating an example of a data structure of the item ID axis item ID relationship table 1600. The item ID axis item ID relationship table 1600 includes an item ID field 1605, and an axis item ID field 1610. The item ID field 1605 stores an item ID. The axis item ID field 1610 stores an axis item ID. Specifically, when the deployment table generation module 115 generates a deployment table from a relationship diagram, the item ID axis item ID relationship table 1600 is generated. The value of the item ID field 1605 is an item ID indicating an item of the relationship diagram as a generation source, and the value of the axis item ID field 1610 is an axis item ID indicating an axis item of the generated deployment table.

For example, regarding the correspondence between the “sound stability relationship diagram” illustrated in FIG. 7 and the “sound stability deployment table” illustrated in FIG. 8, as illustrated in FIG. 16, the item ID axis item ID relationship table 1600 stores “KM0001” in the item ID field 1605, and “J0001” in the axis item ID field 1610, respectively.

Then, the relationship diagram deployment table association storage module 140 associates causal relationship information that indicates a causal relationship between two axis items on adjacent axes in a deployment table, with a relationship line connecting items to each other on a relationship diagram. Here, “two axis items on adjacent axes” refers to axis items A1 and B1 on axes A and B adjacent to each other. The relationship diagram deployment table association storage module 140 stores, for example, information that associates causal relationship information that indicates a causal relationship between two axis items on adjacent axes in a deployment table, with a relationship line connecting items to each other on a relationship diagram. As a specific example, FIG. 17 is an explanatory view illustrating an example of a data structure of the relationship line ID causal relationship information ID relationship table 1700. The relationship line ID causal relationship information ID relationship table 1700 includes a relationship line ID field 1705, and a causal relationship information ID field 1710. The relationship line ID field 1705 stores a relationship line ID. The causal relationship information ID field 1710 stores a causal relationship information ID. Specifically, when the deployment table generation module 115 generates a deployment table from a relationship diagram, the relationship line ID causal relationship information ID relationship table 1700 is generated. The value of the relationship line ID field 1705 is a relationship line ID indicating a relationship line on the relationship diagram as a generation source, and the value of the causal relationship information ID field 1710 is a causal relationship information ID indicating causal relationship information of the generated deployment table. Plural relationship line IDs may correspond to one causal relationship information ID. This is because depending on selection of items as axis items, one or more items (items not selected as the axis items) may be sandwiched between the items. Specifically, this is because in a case where an item A and an item C are selected as axis items, but an item B is present between the item A and the item C (more specifically, in a case where there is no relationship line directly connected from the item A to the item C, and there are a relationship line connecting the item A to the item B, and a relationship line connecting the item B to the item C), one causal relationship information piece present between the axis item A and the axis item C on a deployment table may correspond to two relationship lines (the relationship line connecting the item A to the item B, and the relationship line connecting the item B to the item C) on a corresponding relationship diagram.

For example, regarding the correspondence between the “sound stability relationship diagram” illustrated in FIG. 7 and the “sound stability deployment table” illustrated in FIG. 8, as illustrated in FIG. 17, the relationship line ID causal relationship information ID relationship table 1700 stores “KS0001” in the relationship line ID field 1705, and “IK0001” in the causal relationship information ID field 1710, respectively.

The editing module 145 includes a deployment table operation receiving module 150, an association information extraction module 155, the display module 160, and the relationship diagram editing module 165, and is connected to the relationship diagram deployment table storage module 125. The editing module 145 performs, for example, editing of a deployment table and editing of a relationship diagram generated by the editing of the deployment table. For example, when an editing request is issued with respect to a deployment table generated by the deployment table generation module 115, a relationship diagram corresponding to the deployment table is extracted, and a demand for editing is made. Based on the editing result, the deployment table generation module 115 is instructed to generate a deployment table again. Accordingly, the editing result may be reflected in the deployment table, and thus the identity of information may be maintained between the relationship diagram and the deployment table.

The deployment table operation receiving module 150 is connected to the association information extraction module 155. The deployment table operation receiving module 150 receives editing information on a deployment table through, for example, an operation of keyboard keys and a mouse by a user. In addition to receiving the editing information through, for example, the operation of keyboard keys by the user, previously created editing information stored in, for example, a hard disk may be read. For example, a correction operation of integrating plural axis items present on one axis in a deployment table may be performed.

The association information extraction module 155 is connected to the deployment table operation receiving module 150, the display module 160, and the relationship diagram editing module 165. The association information extraction module 155 extracts a relationship diagram from a deployment table, extracts an item of the relationship diagram from an axis item of the deployment table, and extracts a relationship line of the relationship diagram from causal relationship information of the deployment table by using the relationship diagram ID deployment table ID relationship table 1500, the item ID axis item ID relationship table 1600, and the relationship line ID causal relationship information ID relationship table 1700 in the relationship diagram deployment table association storage module 140. That is, in the deployment table operation receiving module 150, a relationship diagram, an item of the relationship diagram, and a relationship line of the relationship diagram are extracted from a deployment table as an editing target, an axis item of the deployment table, and causal relationship information of the deployment table, respectively.

The display module 160 is connected to the association information extraction module 155 and the relationship diagram editing module 165. The display module 160 displays a relationship diagram associated with a deployment table to be corrected, by using one or more of the relationship diagram ID deployment table ID relationship table 1500, the item ID axis item ID relationship table 1600, and the relationship line ID causal relationship information ID relationship table 1700. For example, the relationship diagram ID deployment table ID relationship table 1500 is used to extract a relationship diagram from a deployment table, the relationship diagram ID deployment table ID relationship table 1500 and the item ID axis item ID relationship table 1600 are used to extract an item of the relationship diagram from an axis item of the deployment table, the relationship diagram ID deployment table ID relationship table 1500 and the relationship line ID causal relationship information ID relationship table 1700 are used to extract a relationship line of the relationship diagram from causal relationship information of the deployment table, the relationship diagram ID deployment table ID relationship table 1500, the item ID axis item ID relationship table 1600, and the relationship line ID causal relationship information ID relationship table 1700 are used to extract an item and a relationship line of the relationship diagram from an axis item, and causal relationship information of the deployment table, respectively. Here, “to be corrected” may correspond to a state as a result of correction, or a state as a correction target for which correction has not been completed yet. Therefore, the timing for displaying may be triggered by completion of correction or may be triggered by selection as a correction target.

The display module 160 may display a relationship diagram associated with a deployment table to be corrected, by using the relationship diagram ID deployment table ID relationship table 1500, and may display an item associated with an axis item to be corrected, in a form different from other items, by using the item ID axis item ID relationship table 1600. For example, it is possible to extract a relationship diagram ID of a relationship diagram from a deployment table ID of a deployment table by using the relationship diagram ID deployment table ID relationship table 1500. Then, it is possible to extract an item ID of a relationship diagram from an axis item ID of an axis item of a deployment table by using the item ID axis item ID relationship table 1600. Here, the “form” includes a shape (e.g., an oval shape or a square shape of a frame surrounding an item), a pattern (e.g., a pattern such as oblique lines in the background), a color (e.g., a color of a frame surrounding an item, a color of the background, or a color of a character indicating an item) or a combination thereof, or a dynamic change thereof (e.g., flash or animation). “Other items” refer to items associated with an axis item that is not a correction target. The “different form” only has to be different from the form of other items.

Then, when a correction is performed to integrate plural axis items present on one axis in a deployment table, the display module 160 may display items of a relationship diagram associated with the axis items in an integrated manner.

When causal relationship information about plural axis items to be integrated is different from that about axis items on adjacent axes, the display module 160 may display a message indicating that there is inconsistency.

The display module 160 may display a relationship diagram associated with a deployment table to be corrected, by using the relationship diagram ID deployment table ID relationship table 1500, and may display a relationship line associated with causal relationship information to be corrected, in a form different from other relationship lines, by using the relationship line ID causal relationship information ID relationship table 1700.

Then, when a correction is performed to integrate plural axis items on one axis in a deployment table, the display module 160 may display relationship lines of a relationship diagram associated with causal relationship information of the axis items in an integrated manner.

When plural relationship lines to be integrated in a relationship diagram are different in attribute information, the display module 160 may display a message that there is inconsistency.

The display module 160 may display a message of an urge to set an item or a relationship line displayed in a different form, as a correction target.

Then, when items other than an item displayed in a different form, or relationship lines other than a relationship line displayed in a different form are set as correction targets, the display module 160 may display a message that the items or the relationship lines not set as correction targets in a deployment table may be corrected.

The relationship diagram editing module 165 is connected to the association information extraction module 155, the display module 160, and the deployment table generation module 115 of the relationship diagram deployment table creation module 105. The relationship diagram editing module 165 edits a relationship diagram according to the editing operation of a user on the relationship diagram displayed by the display module 160. For example, the relationship diagram editing module 165 edits, for example, attribute information of relationship lines for which a message that there is inconsistency is displayed by the display module 160, according to the editing operation of a user. In addition, according to the editing operation of a user, editing of items (including, for example, addition and deletion), editing of attributes of an item, reassignment of a relationship line (including, for example, addition and deletion), and editing of attributes of a relationship line may be performed.

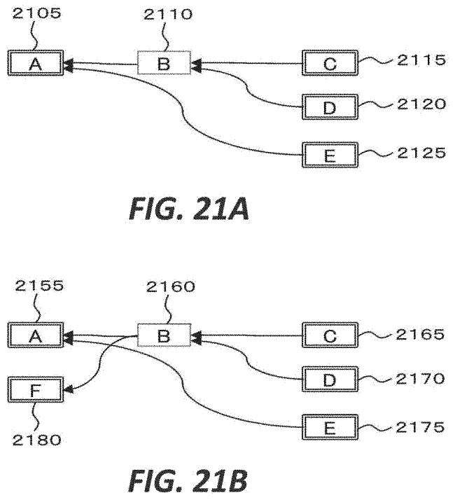

The relationship diagram editing module 165 may correct a relationship diagram corresponding to a deployment table according to correction of the deployment table by the deployment table operation receiving module 150. For example, when editing is performed on a displayed deployment table by user's operation, the deployment table is edited based on the editing, and in parallel with this, the editing result is reflected in a relationship diagram associated with the deployment table. Accordingly, it becomes possible even for a user who does not use a relationship diagram, to maintain the identity of information between the relationship diagram and a deployment table. Details of this processing will be described below by using the example in FIGS. 21A and 21B to FIGS. 27A and 27B.

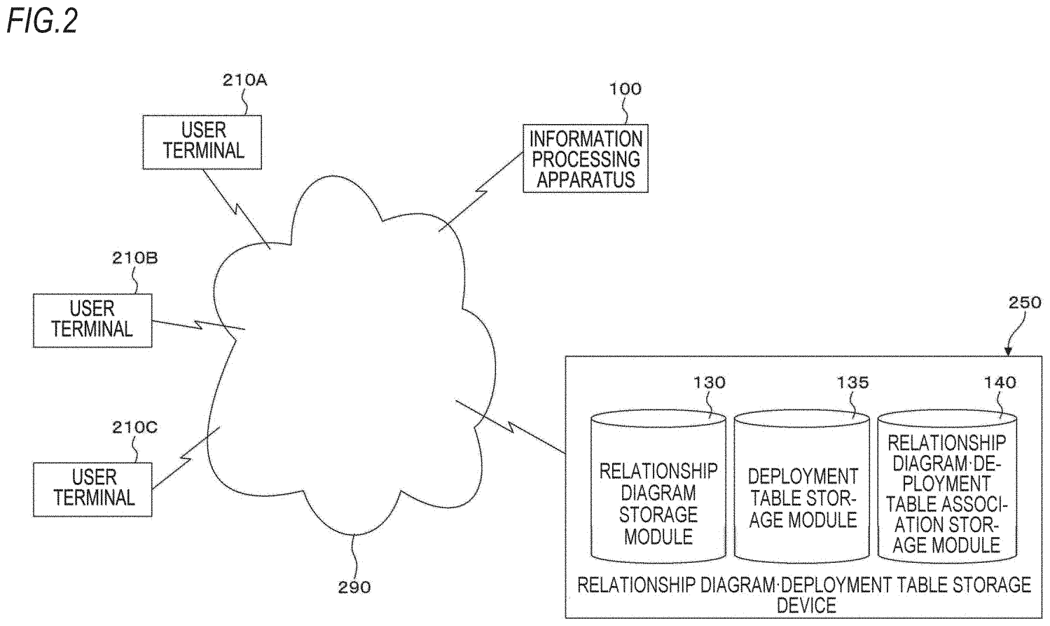

FIG. 2 is an explanatory view illustrating an example of a system configuration according to the exemplary embodiment.

The information processing apparatus 100, a user terminal 210A, a user terminal 210B, a user terminal 210C, and a relationship diagram deployment table storage device 250 are connected to each other via a communication line 290. The communication line 290 may be wireless, wired or a combination of wireless and wired communication lines, and may be, for example, the Internet or an intranet as a communication infrastructure. Functions by the information processing apparatus 100, and the relationship diagram deployment table storage device 250 may be implemented as a cloud service. The relationship diagram deployment table storage device 250 includes the relationship diagram storage module 130, the deployment table storage module 135, and the relationship diagram deployment table association storage module 140, and the information processing apparatus 100 may use the relationship diagram storage module 130, the deployment table storage module 135, and the relationship diagram deployment table association storage module 140 in the relationship diagram deployment table storage device 250 via the communication line 290, as the above-described relationship diagram storage module 130, deployment table storage module 135, and relationship diagram deployment table association storage module 140.

For example, in the information processing apparatus 100, according to user's operation in the user terminal 210A, a relationship diagram is created, and a deployment table is generated based on the relationship diagram. For example, the technique described in JP-A-2016-081185 may be used. Information on the relationship diagram is stored in the relationship diagram storage module 130 in the relationship diagram deployment table storage device 250 via the communication line 290, and information on the deployment table is stored in the deployment table storage module 135 in the relationship diagram deployment table storage device 250 via the communication line 290.

For example, a user of the user terminal 210B mainly uses a deployment table, and performs editing of the deployment table. When the editing of the deployment table is performed, the information processing apparatus 100 displays a relationship diagram associated with the deployment table, and highlights an item or a relationship line in the relationship diagram associated with an axis item or causal relationship information to be edited. Then, these are confirmed by a user, and edited in some cases. The user who performs confirmation or editing of the item or the relationship line of the relationship diagram may be a user who mainly creates and uses a relationship diagram.

The information processing apparatus 100 may be built in the user terminal 210. In this case, a stand-alone type system is configured.

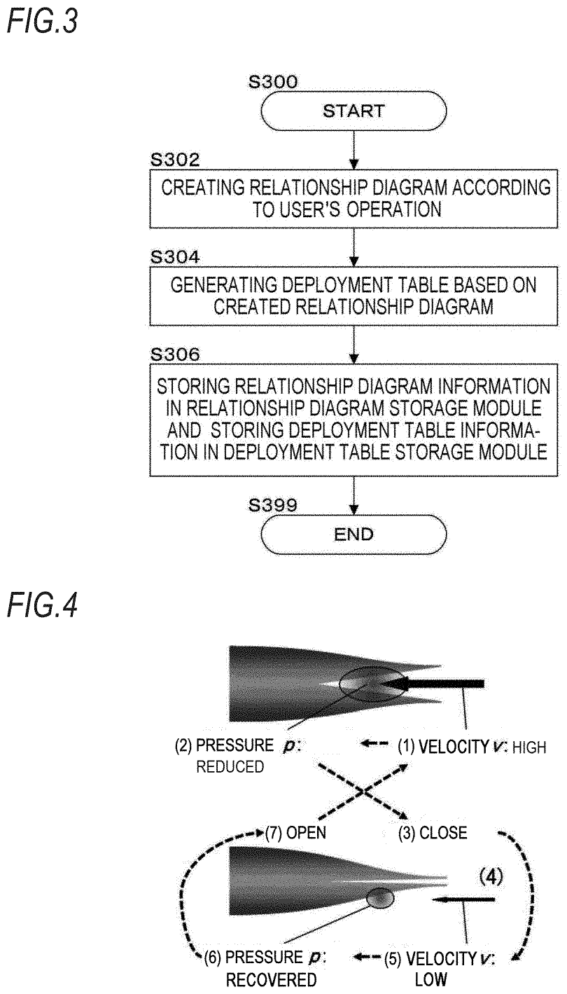

FIG. 3 is a flowchart illustrating an example of a processing according to a first exemplary embodiment (the relationship diagram deployment table creation module 105).

In step S302, the relationship diagram creation module 110 creates a relationship diagram according to user's operation.

In step S304, the deployment table generation module 115 generates a deployment table based on the created relationship diagram.

In step S306, the output module 120 stores information on the relationship diagram in the relationship diagram storage module 130, and stores information on the deployment table in the deployment table storage module 135.

Hereinafter, descriptions will be made on an example where with regard to the straw oboe mechanism, a relationship diagram is created, and a deployment table is generated, using FIGS. 4 to 8.

FIG. 4 is an explanatory view of an example of a technique which is a target of the relationship diagram and the deployment table (the straw oboe mechanism).

This technique uses the rule of hydraulic engineering which refers to the Bernoulli's theorem (see Equation 1) providing that “when a flow velocity increases, a pressure decreases.”

[Expression 1]

p+½ρv²=CONSTANT(p:PRESSURE r:DENSITY,v:VELOCITY) EQUATION (1)

The matter of “why does the vibration occur?” may be explained as follows. The numbers in parenthesis correspond to the numbers in parenthesis of FIG. 4.

(1) When blowing through the straw, the flow velocity inside the straw increases.

(2) When the flow velocity becomes fast, the pressure decreases.

(3) When the pressure decreases, the reed is drawn inward.

(4) When the reed is drawn inward, the flow path becomes narrow.

(5) When the flow path becomes narrow, the flow velocity becomes slow.

(6) When the flow velocity becomes slow, the pressure is recovered.

(7) When the pressure is recovered, the reed is opened.

This flow is returned to (1).

FIG. 5 is an explanatory view illustrating an example of a relationship diagram. This illustrates an example of a relationship diagram of the mechanism where the straw oboe does not sound. This is created by the relationship diagram creation module 110, according to user's operation.

As a premise, it is assumed that “the density of air is unchanged,” and “a flattening processing method is undetermined.”

In the example of FIG. 5, the respective items surrounded by rectangles are connected to each other by relationship lines. In each item, the upward arrow indicates an increase of the item, and the downward arrow indicates a decrease of the item.

The color of the relationship line between the items indicates the polarity of a causal relationship. The relationship line as a thick black line connecting the items to each other indicates that there is a positive correlation, and the relationship line as a double line (white line)connecting the items to each other indicates that there is an inverse correlation (also called a negative correlation). For example, it is described that when the item “ease of vibration” decreases, the item “ease of sounding” also decreases. The strength of an influence degree of a causal relationship may be indicated by, for example, a solid line or a broken line. These information pieces are stored in the attribute field 1120 of the relationship line information table 1100.

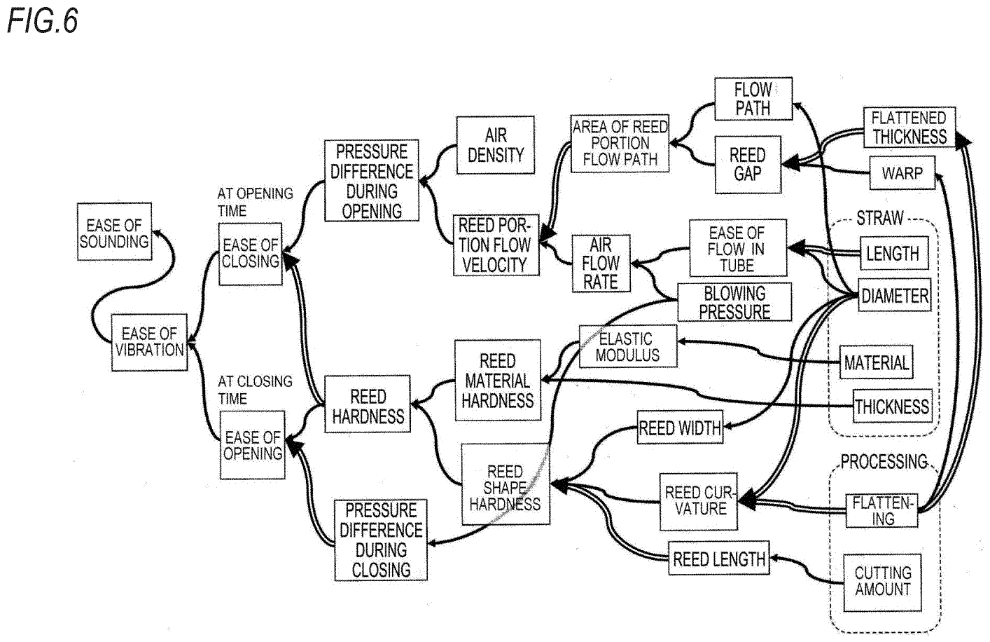

FIG. 6 is an explanatory view illustrating an example of a relationship diagram. The respective items in the relationship diagram illustrated in the example of FIG. 5 are unified into factors for an increase. That is, an example of a relationship diagram of a sound stability is illustrated. Accordingly, there are a relationship line between items of which the positive correlation becomes the inverse correlation, and inversely, a relationship line between items of which the inverse correlation becomes the positive correlation.

FIG. 7 is an explanatory view illustrating an example of a relationship diagram.

An example is illustrated in which an item to be adopted as an axis (axis item) of a deployment table is selected by user's operation. Here, “quality,” “function,” “physical,” and “design” are illustrated as a first axis, a second axis, a third axis, and a fourth axis, respectively.

An item (sound stability) 710 has been selected for the first axis.

An item (ease of closing at the opening time) 715 and an item (ease of opening at the closing time) 720 have been selected for the second axis.

An item (reed portion flow velocity) 725, an item (reed material hardness) 730, an item (reed shape hardness) 735, and an item (pressure difference during closing) 740 have been selected for the third axis.

An item (blowing pressure) 745, an item (length) 755, an item (diameter) 760, an item (thickness) 765, an item (material) 770, an item (flattening processing) 780, and an item (cutting amount) 785 have been selected for the fourth axis.

FIG. 8 is an explanatory view illustrating an example of a deployment table. This illustrates a deployment table generated from the relationship diagram illustrated in the example of FIG. 7. That is, FIG. 8 illustrates an example of a deployment table on the sound stability of a straw oboe.

The target of the deployment table is the whole or a part of a system to be developed and designed.

The first axis (quality) 810A corresponds to a quality, that is, an index of the value guaranteed to a customer. Further, the first axis (quality) 810A is an index of the value obtained as a result when the system (component) which is the target of the deployment table exhibits its function, and is an index of the value guaranteed to a customer by the system or its host system. The first axis (quality) 810A includes the axis item (sound stability) 810.

A second axis (function) 815A corresponds to a role performed by a component or a partial system in order for the system to achieve the quality. The second axis (function) 815A includes an axis item (ease of closing at the opening time) 815, and an axis item (ease of opening at the closing time) 820.

A third axis (physical) 825A corresponds to a physical quantity that determines the function exhibited by the component or the partial system. The third axis (physical) 825A includes an axis item (reed portion flow velocity) 825, an axis item (reed material hardness) 830, an axis item (reed shape hardness) 835, and an axis item (pressure difference during closing) 840.

A fourth axis (design) 845A corresponds to a setting condition for controlling a physical quantity of the component or the partial system as a target, that is, an amount and a condition that may be determined (or has to be determined) by a designer or a developer. The fourth axis (design) 845A includes an axis item (blowing pressure) 845, an axis item (straw) 850, and an axis item (processing) 875. In the axis item (straw) 850, there are an axis item (length) 855, an axis item (diameter) 860, an axis item (thickness) 865, and an axis item (material) 870. In the axis item (processing) 875, there are an axis item (flattening processing) 880, and an axis item (cutting amount) 885.

There is causal relationship information in a cell whose position is determined by adjacent axis items in the deployment table (in the example of FIG. 8, a rectangle in which, for example, the symbol ⊚, which means strong correlation, is drawn). This causal relationship information indicates a causal relationship between two axis items. The symbols “⊚” and “Δ” indicate the strength of a causal relationship, and mean “strong correlation” and “weak correlation,” respectively. The symbols “+” and “−” annexed thereto indicate the polarity of the causal relationship. That is, a positive correlation is indicated by “+,” an inverse correlation is indicated by “−,” a strong positive correlation is indicated by “⊚+,” a weak positive correlation is indicated by “Δ+,” a strong inverse correlation is indicated by “⊚−,” a weak inverse correlation is indicated by “Δ−,” and no relation is indicated by “−.” For example, a relationship between the axis item (sound stability) 810 and the axis item (ease of closing at the opening time) 815 is “⊚+” (strong positive correlation). Note that the meaning of these symbols applies to FIGS. 8, 19A, 20, 22A, 23A, 24A, 25A, 26A, and 27A. These information pieces are stored in the attribute field 1420 of the causal relationship information table 1400. Therefore, since the relationship line information table 1100 in the relationship diagram corresponds to the causal relationship information table 1400 in the deployment table by the relationship line ID causal relationship information ID relationship table 1700, these information pieces correspond to each other.

Since the item information table 1000 in the relationship diagram corresponds to the axis item information table 1300 in the deployment table by the item ID axis item ID relationship table 1600, these information pieces correspond to each other.

As described in the case of the above described straw oboe, in generation of a deployment table from a relationship diagram, the relationship diagram is used to clarify relationships between complicated elements by illustrating mutual relationships such as cause/result, and purpose/unit, and also includes descriptive items to encourage thinking. Meanwhile, the deployment table is used to briefly express causal relationships between respective items defined by functions of respective processes, and does not include descriptive items. Therefore, when a deployment table is generated from a relationship diagram, only required items are extracted, and the extracted items are allocated to proper axis items and reflected in the deployment table.

Here, the relationship diagram as a source that is to be converted into the deployment table is not necessarily limited to one, and a deployment table in which plural causal relationships are aggregated is also present. In such a case, plural relationship diagrams attached to the deployment table are present.

In conversion from a relationship diagram into a deployment table, a part of data pieces of the relationship diagram is used to generate the deployment table. Thus, even when the deployment table consisting of one relationship diagram is generated, irreversible conversion is performed. Thus, for the same technique as a target, there are two types of data, that is, a relationship diagram and a deployment table, and in consideration of accumulation as a technical asset, it is required to continuously maintain the consistency between the two types of data.

Thus, in the first exemplary embodiment, consistency is maintained by data association between a relationship diagram and a deployment table.

In the first exemplary embodiment, the following processes are performed. (1) In a deployment table converted from a relationship diagram, addition/deletion/correction of an item and addition/deletion/correction of a causal relationship are performed.

When editing is performed on an item or a causal relationship between items in the deployment table, based on relationship diagram information stored as attribute information attached to the item or the causal relationship between items, the relationship diagram as a source is read and displayed. Then, a control is performed to demand confirmation or editing on the relationship diagram. The editing result in the relationship diagram is reflected in the deployment table in order to match the relationship diagram with the deployment table, and the result is displayed. Since the original data is only the relationship diagram, the consistency between the deployment table and the relationship diagram may be maintained.

In a case of a deployment table with no relationship diagram, it is possible to select whether to directly edit the deployment table or to edit a simply generated relationship diagram. In both cases, the consistency is maintained.

(2) The relationship diagram including the portion (item) or the causal relationship between items, as an editing target, is displayed, and the corresponding portion is highlighted (highlight etc.).

(3) When there are plural corresponding relationship diagrams, all the relationship diagrams are displayed. This is because there are cases where the same items and the same related causal relationships are present commonly in the plural relationship diagrams.

(4) In order to import the corresponding relationship diagram, the item and the causal relationship between items are given information on affiliation relationship diagrams. Meanwhile, as described above, the relationship diagram to be read is not limited to one.

When plural axis items are selected, editing as the same one may be performed. For example, this is performed for the purpose of merging the items.

Otherwise, items and causal relationships related to the items may be merged.

When inconsistency occurs due to merging, a presence of the inconsistency may be indicated, and editing (correction) may be demanded.

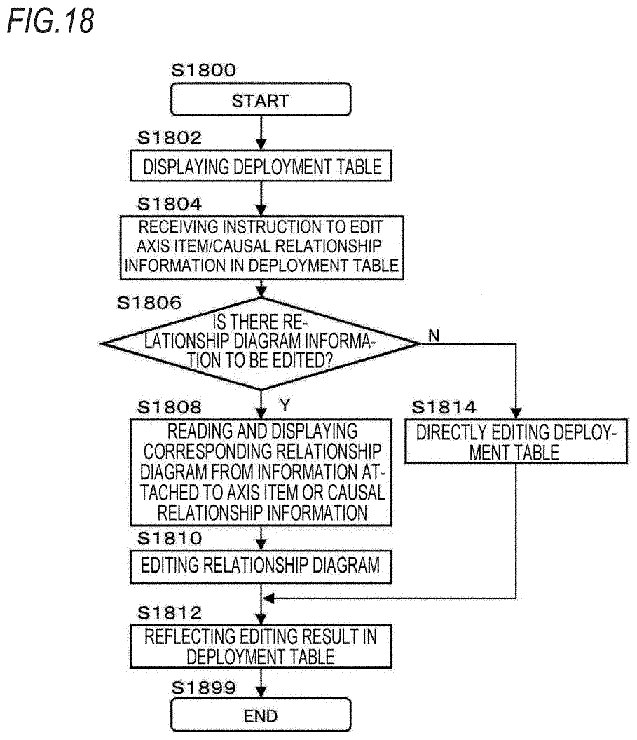

FIG. 18 is a flowchart illustrating an example of a processing according to the first exemplary embodiment.

In step S1802, the display module 160 displays a deployment table according to a display operation of a user.

In step S1804, the deployment table operation receiving module 150 receives an editing instruction of the user on an axis item/causal relationship information of the deployment table.

In step S1806, the association information extraction module 155 determines whether there is relationship diagram information to be edited. When it is determined that there is the relationship diagram information, the process proceeds to step S1808. Otherwise, the process proceeds to step S1814. That is, it is determined whether there is a relationship diagram corresponding to the deployment table (a relationship diagram as a source from which the deployment table is generated).

In step S1808, the display module 160 reads the corresponding relationship diagram from information attached to the axis item or the causal relationship information, and displays the relationship diagram.

In step S1810, the relationship diagram editing module 165 edits the relationship diagram according to user's operation.

In step S1812, the deployment table generation module 115 reflects the editing result in the deployment table.

In step S1814, the deployment table operation receiving module 150 directly edits the deployment table according to user's operation.

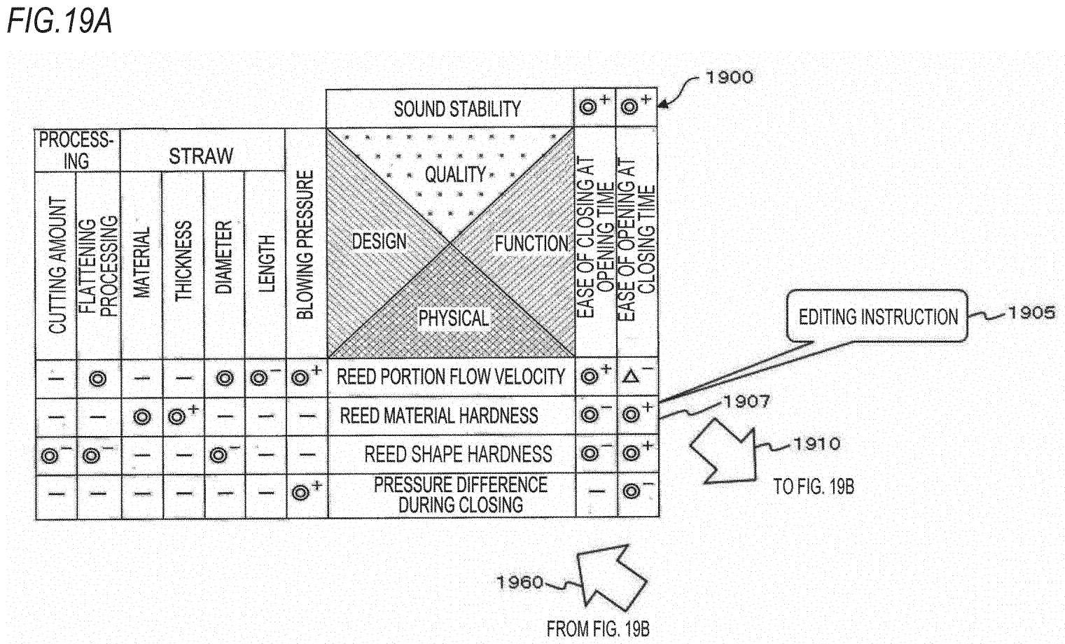

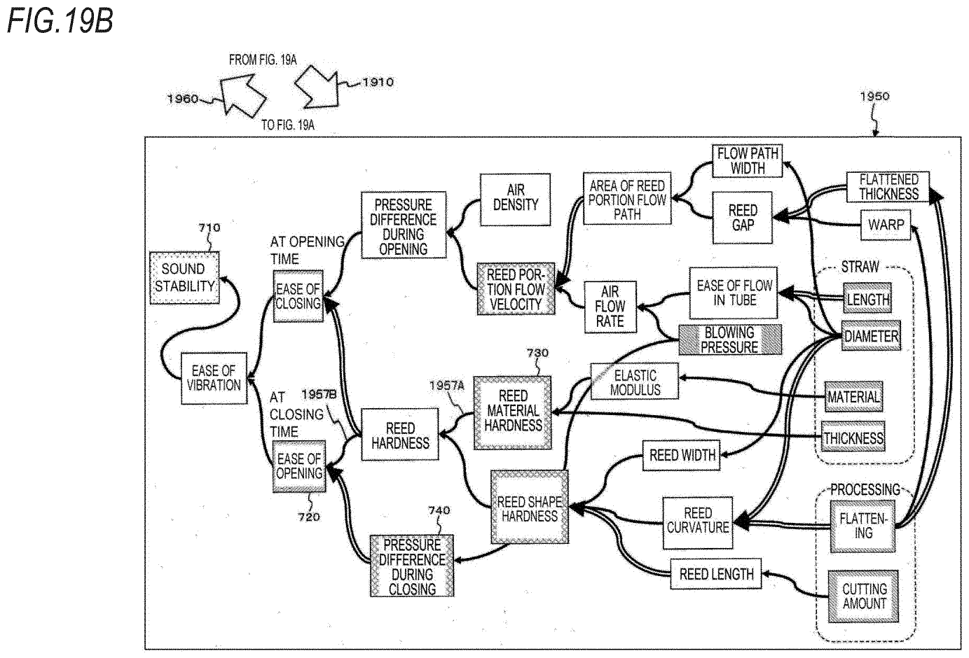

FIGS. 19A and 19B are explanatory views illustrating an example of a processing according to the first exemplary embodiment.

On a deployment table 1900, an editing instruction 1905 is performed by user's operation. The editing instruction 1905 may not indicate actual editing, but may indicate an intention of editing. By using the relationship diagram ID deployment table ID relationship table 1500, a relationship diagram 1950 corresponding to the deployment table 1900 is displayed.

Then, on the relationship diagram 1950, editing is performed by user's operation, and the editing result is reflected in the deployment table 1900.

Causal relationship information 1907 is located at the intersection between the axis item (ease of opening at the closing time) 820 and the axis item (reed material hardness) 830. The axis item (ease of opening at the closing time) 820 corresponds to the item (ease of opening at the closing time) 720, and the axis item (reed material hardness) 830 corresponds to the item (reed material hardness) 730. This correspondence relationship is managed by the item ID axis item ID relationship table 1600. Then, the causal relationship information 1907 corresponds to a relationship line 1957A and a relationship line 1957B. This correspondence relationship is managed by the relationship line ID causal relationship information ID relationship table 1700.

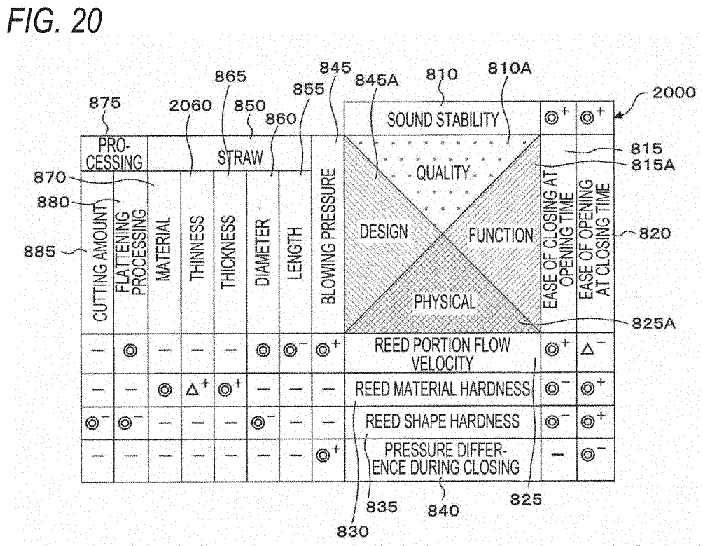

FIG. 20 is an explanatory view illustrating an example of a processing according to the first exemplary embodiment.

On a deployment table 2000, when plural axis items (e.g., the axis item (ease of closing at the opening time) 815 and the axis item (ease of opening at the closing time) 820) are selected by user's operation, editing as the same axis item is performed (items are merged). Alternatively, items and causal relationship information pieces related to the items may be merged.

Specifically, in the deployment table 2000, there is “thinness” indicating the same concept as “thickness” (the axis item (thickness) 865, and an axis item (thinness) 2060). When the axis item (thickness) 865 and the axis item (thinness) 2060 are selected, relationship diagrams corresponding to the items, respectively, are read, and any one of the following processes is performed by selection. (1) One side (e.g., the relationship diagram) is edited, and thus the editing result is reflected in the other side (e.g., the deployment table). (2) With the same concept, items (or axis items) are integrated and associated with each other.

Meanwhile, in the case of merging (that is, items are treated as the same), when inconsistency occurs in a causal relationship, it is described that it is impossible to consider the items as the same due to the presence of inconsistency, and correction editing is demanded. For example, in the relationship diagram of the deployment table 2000, there is a positive causal relationship between the axis item (thickness) 865 and the axis item (reed material hardness) 830, whereas there is an inverse causal relationship between the axis item (thinness) 2060 and the axis item (reed material hardness) 830. Thus, it is determined that there is inconsistency. The inconsistency may be determined for one deployment table, or the inconsistency occurring between plural deployment tables may be determined. For example, this corresponds to a case where when an axis item (thickness) is merged with an axis item (thinness), in one deployment table, there is a positive causal relationship between the axis item (thickness) and an axis item (reed material hardness), whereas in the other deployment table, there is an inverse causal relationship between the axis item (thinness) and the axis item (reed material hardness). As the corresponding example, there may also be a case where one causal relationship is a positive (strong) causal relationship, and the other causal relationship is a positive (weak) causal relationship. These two deployment tables correspond to one relationship diagram (that is, from the one relationship diagram, two deployment tables have been created).

When there is a correction instruction for a deployment table (for the instruction, actual correction does not need to be performed), a relationship diagram corresponding to the deployment table is displayed, and editing is demanded.

However, there is also a user who does not use a relationship diagram, but handles only a deployment table. For such a user, editing of the relationship diagram is a demand for originally unnecessary editing (that is, a load for the user). In the first exemplary embodiment, editing may also be included in the use by a user who creates a deployment table based on a relationship diagram, and a user who uses only a deployment table.

That is, for example, in a case where a user mainly using a deployment table and a user mainly using a relationship diagram are mixed, and edit a deployment table for the same technique, since for the user mainly using the deployment table, it is not necessary to edit the relationship diagram, and the relationship diagram is used to maintain the consistency.

Descriptions will be made on a case where a deployment table is actually corrected and the correction result is reflected in a relationship diagram, with reference to the example illustrated in FIGS. 21A and 21B to FIGS. 27A and 27B.

FIGS. 21A and 21B are explanatory views illustrating an example of a processing according to the first exemplary embodiment.

A method of reflecting a correction result of a deployment table in a relationship diagram is as follows. On an edited portion, the fact that the editing has been made may be stated and the history may be left.

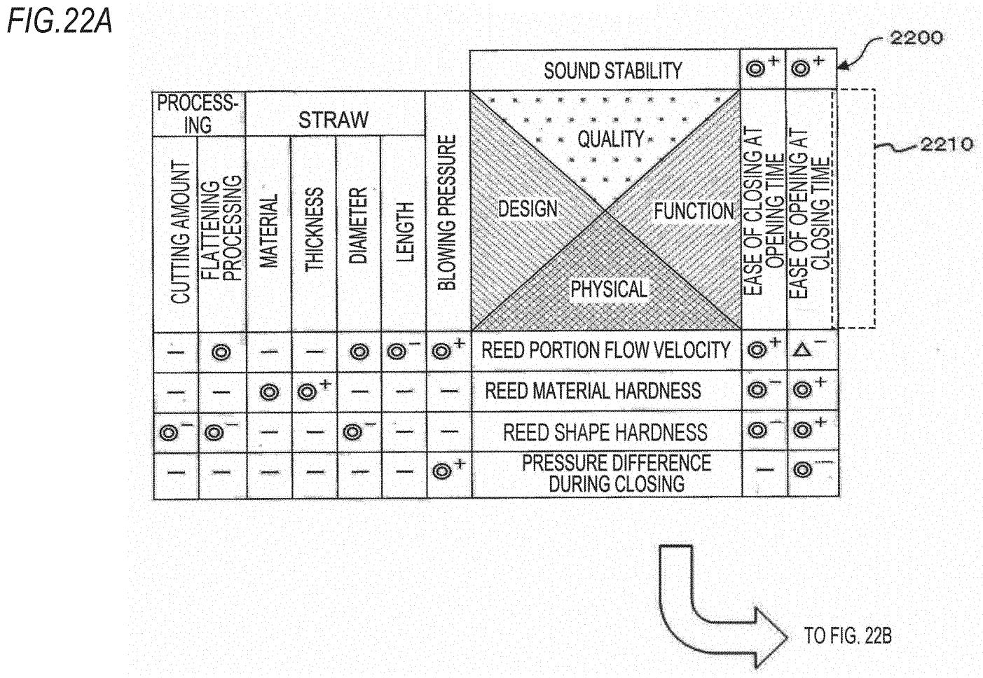

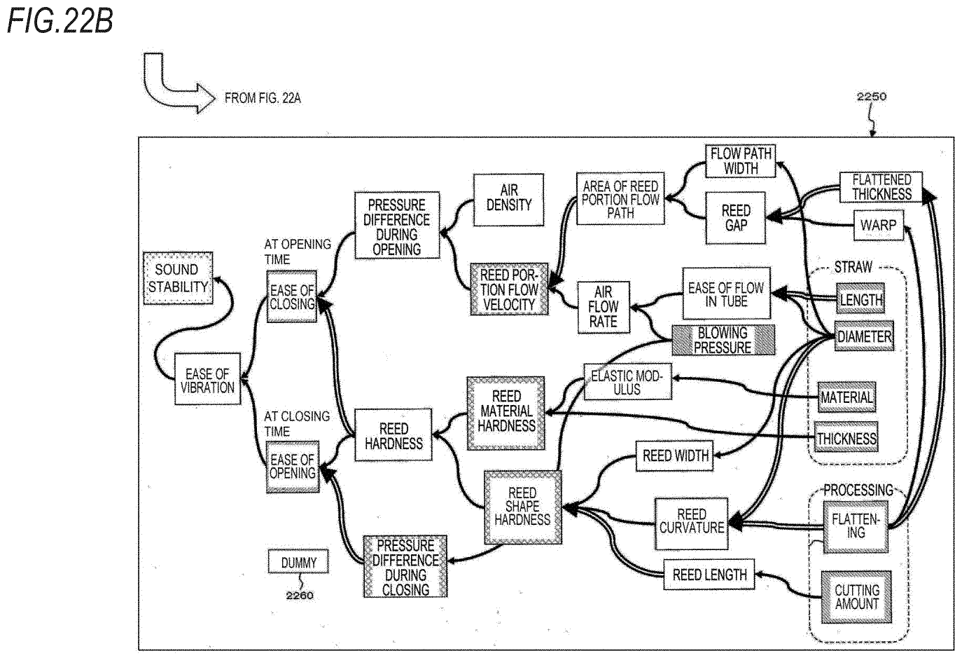

### (A1) Addition of an Axis Item (Element) in a Deployment Table (See the Example of FIGS. 22A and 22B)

A dummy item (element) is added to a corresponding portion of a relationship diagram to which the axis item (element) is to be added.

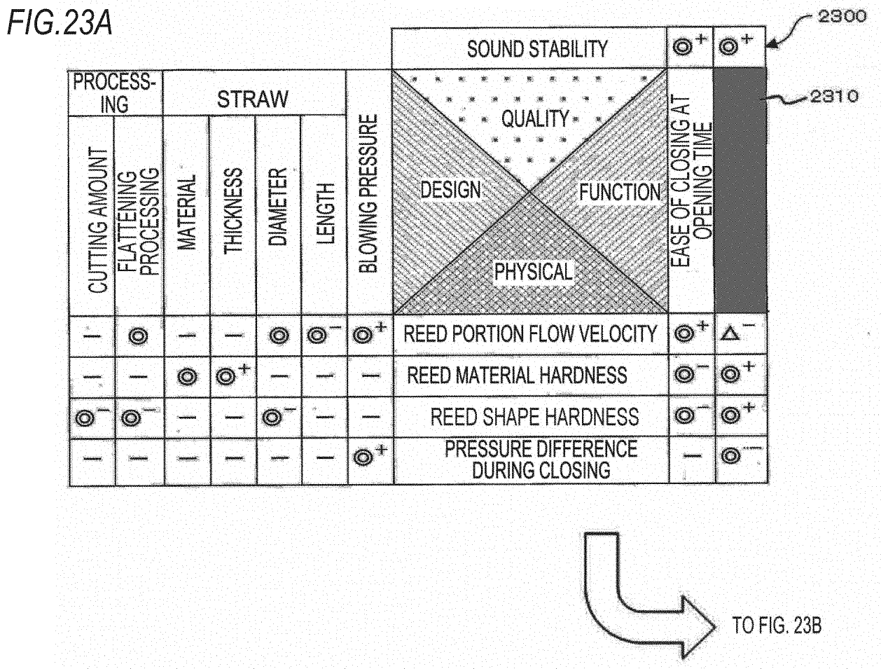

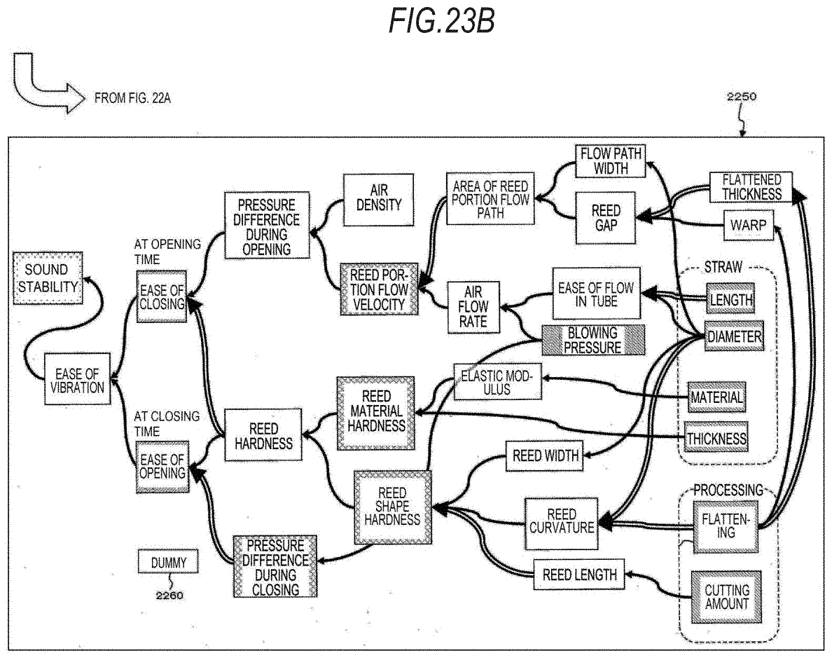

### (A2) Deletion of an Axis Item (Element) in a Deployment Table (See the Example of FIGS. 23A and 23B)

A dummy item (element) is left at a portion of a relationship diagram corresponding to the deleted axis item (element).

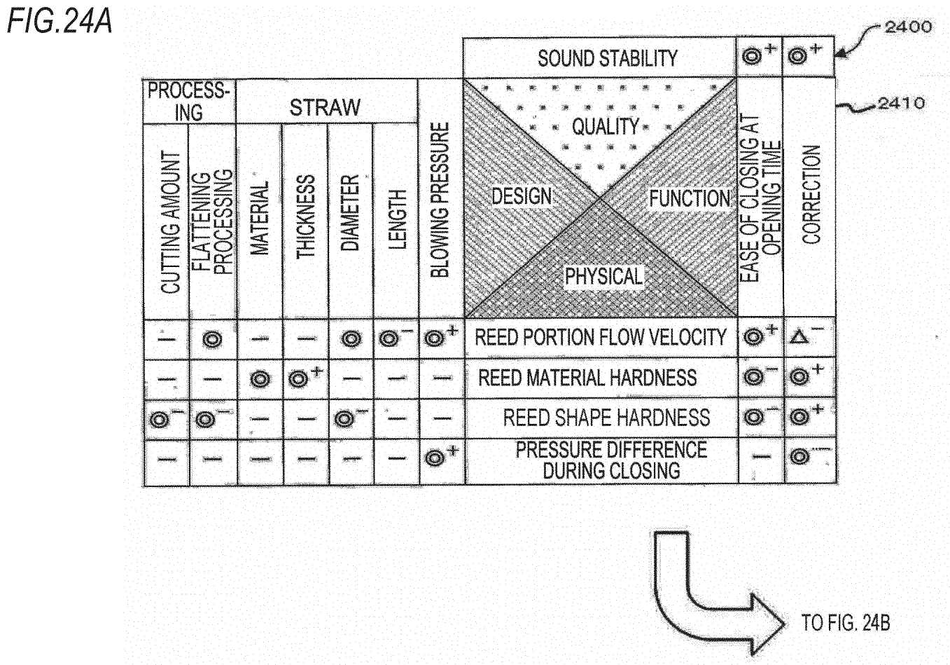

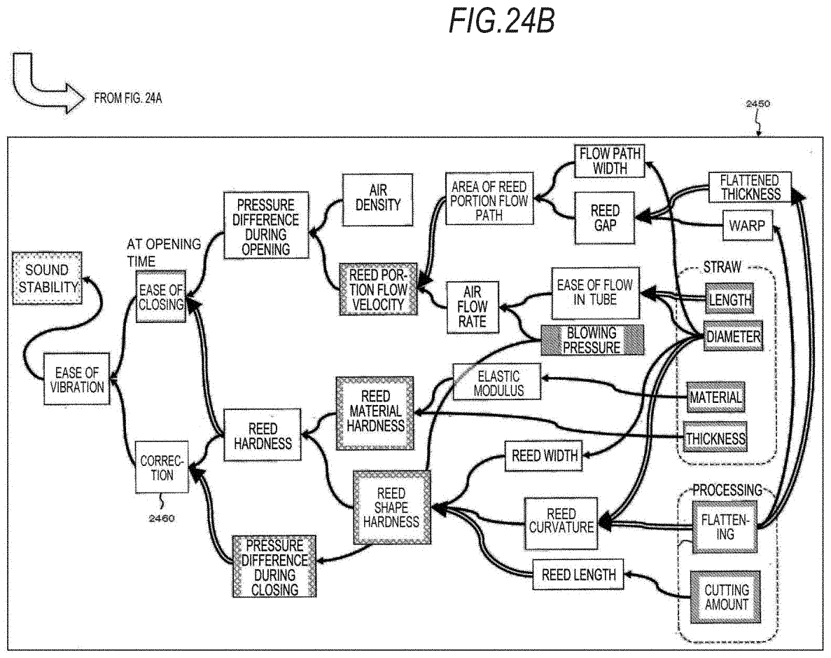

### (A3) Correction of an Axis Item (Element) in a Deployment Table (See the Example of FIGS. 24A and 24B)

The correction is reflected in a portion of a relationship diagram corresponding to the corrected axis item (element).

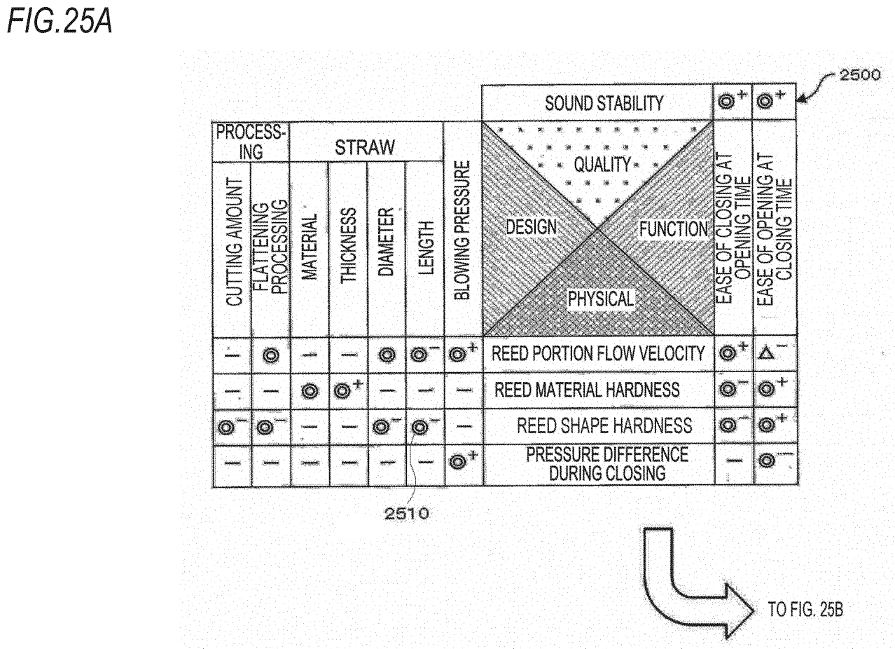

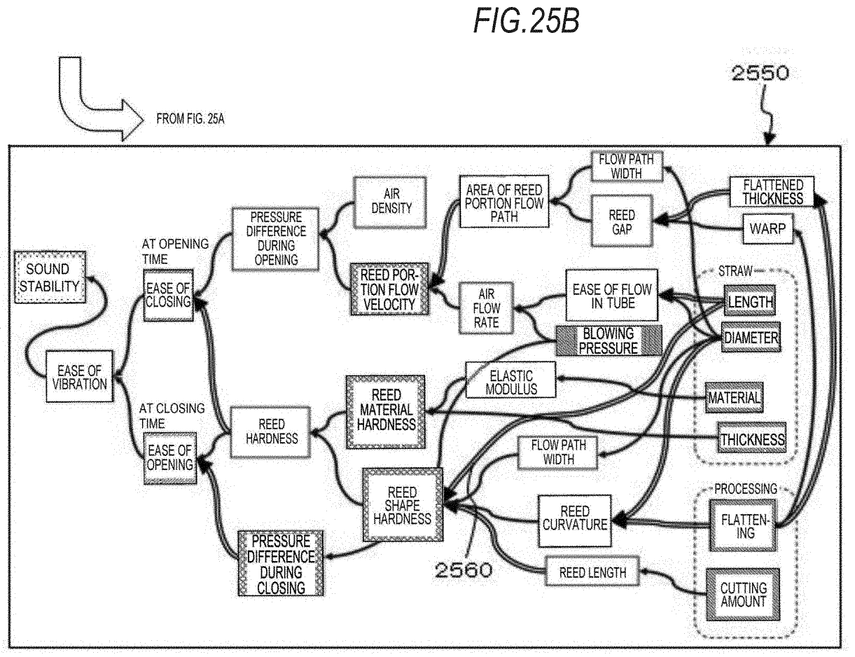

### (B1) Addition of Causal Relationship Information in a Deployment Table (See the Example of FIGS. 25A and 25B)

A portion of a relationship diagram corresponding to the causal relationship information between axis items is added.

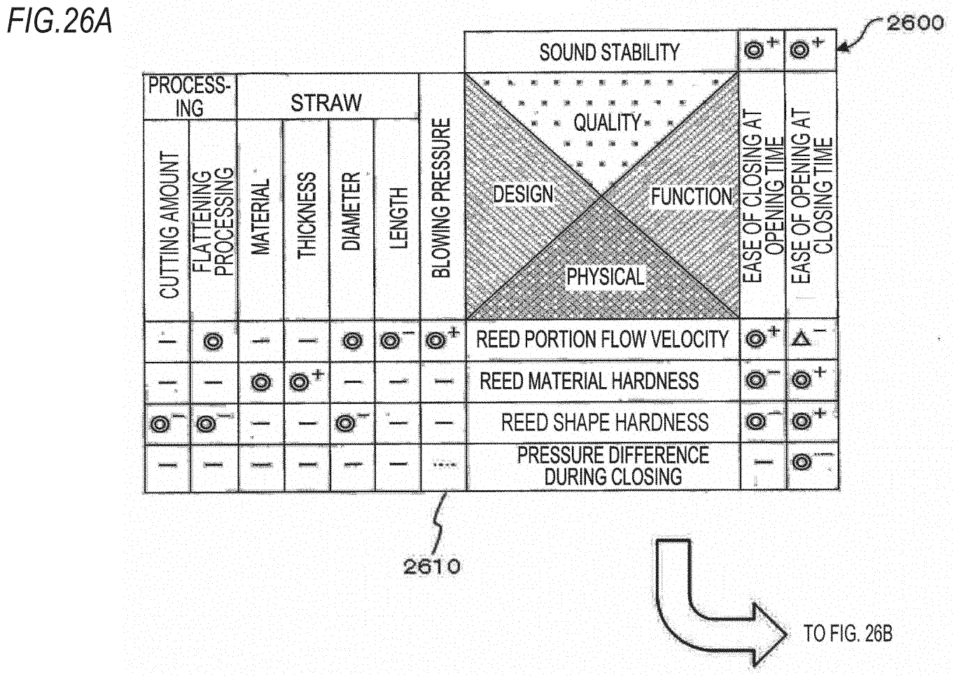

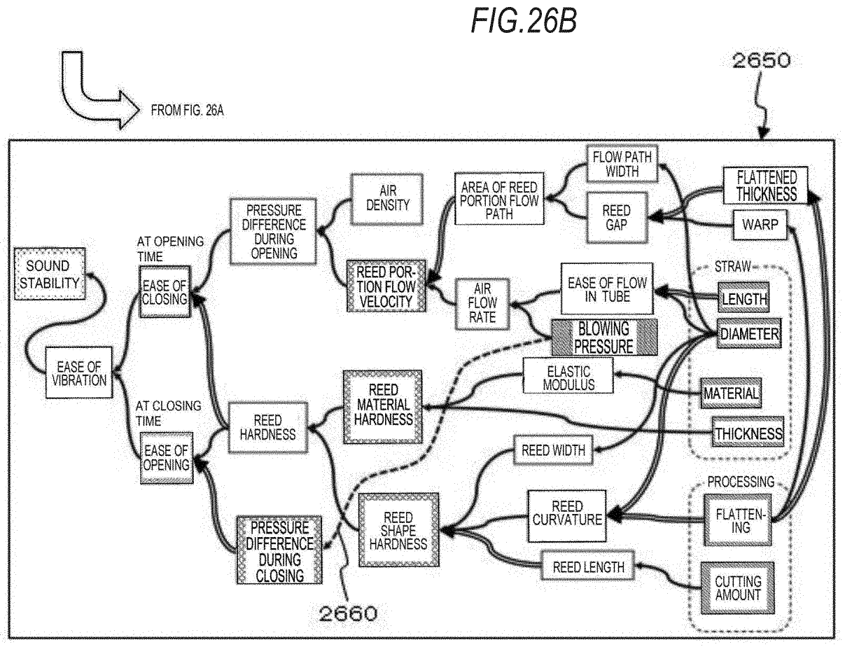

### (B2) Deletion of Causal Relationship Information in a Deployment Table (See the Example of FIGS. 26A and 26B)

A portion of a relationship diagram corresponding to the causal relationship information between axis items is deleted.

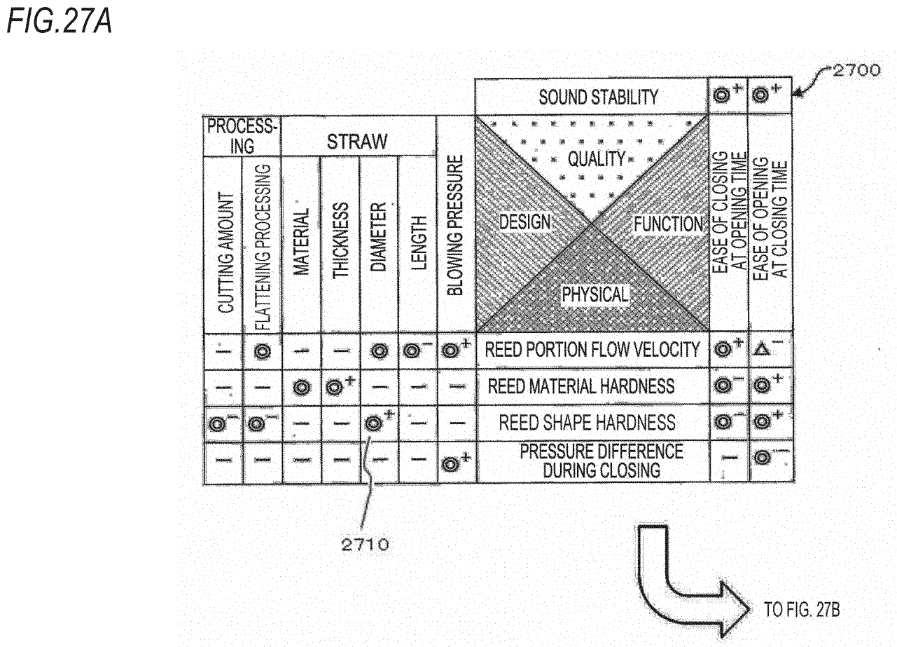

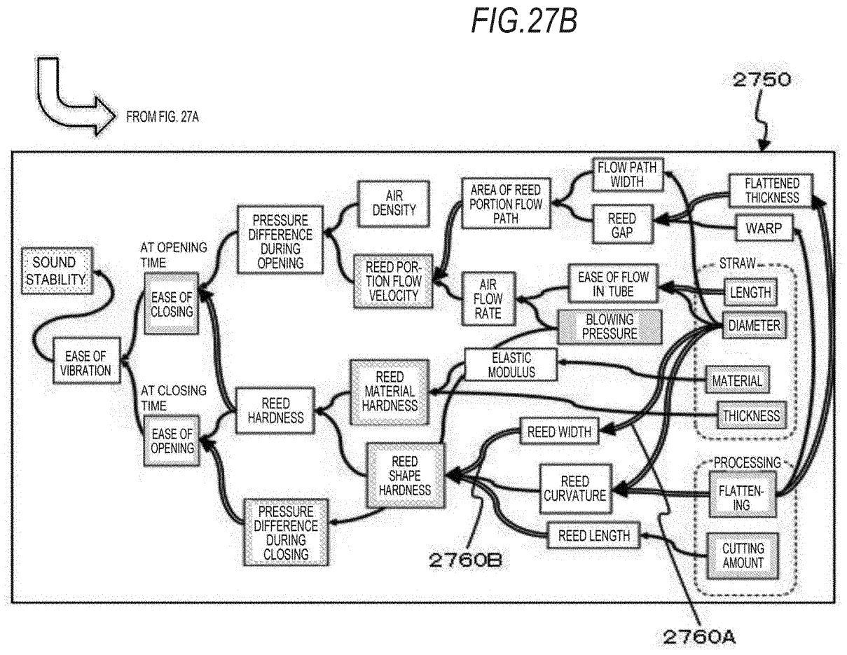

### (B3) Correction of Causal Relationship Information in a Deployment Table (See the Example of FIGS. 27A and 27B)

A portion of a relationship diagram corresponding to the causal relationship information between axis items is corrected.

Editing is performed within a range that does not affect an already set causal relationship. However, in a case of deletion/correction, other causal relationships are affected. Thus, in a case where inconsistency occurs, a message on occurrence of the inconsistency is displayed, and editing is not performed. Here, the case where the inconsistency occurs corresponds to a case where an element is present between axis item elements, and the element has a direct or indirect causal relationship with another axis item element. As to whether inconsistency occurs, an edited deployment table A is compared to a deployment table B generated from a relationship diagram created from the deployment table A. Then, when there is a difference, it may be determined that the inconsistency has occurred.

In the example of a relationship diagram in FIG. 21A, a connection is made from an item C 2115 toward an item B 2110, a connection is made from toward an item D 2120 toward the item B 2110, a connection is made from the item B 2110 toward an item A 2105, and a connection is made from an item E 2125 toward the item A 2105.

In the example of a relationship diagram in FIG. 21B, a connection is made from an item C 2165 toward an item B 2160, a connection is made from an item D 2170 toward the item B 2160, a connection is made from the item B 2160 toward an item A 2155, a connection is made from the item B 2160 toward an item F 2180, and a connection is made from an item E 2175 toward the item A 2155.

For example, in FIG. 21A, it is assumed that the item A 2105, the item C 2115, the item D 2120, and the item E 2125 are set as axis items. Even when a causal relationship between the item A 2105 and the item E 2125 is deleted/corrected, others are not affected. However, in a case where a causal relationship between the item A 2105 and the item D 2120 is deleted/corrected, when a causal relationship between the item A 2105 and the item B 2110 is deleted/corrected, a causal relationship between the item A 2105 and the item C 2115 is affected. In such a case, a causal relationship between the item B 2110 and the item D 2120 is deleted/corrected.

Meanwhile, in the case of FIG. 21B, in a case where a causal relationship between the item A 2155 and the item D 2170 is deleted, even when any causal relationship is deleted/corrected, another causal relationship is affected. Thus, a message that it is not possible to perform deletion/correction is displayed. Alternatively, a relationship diagram may be displayed, and editing may be demanded.

FIGS. 22A and 22B are explanatory views illustrating an example of a processing (an additional example of an axis item (element) in a deployment table) according to the first exemplary embodiment.

In a deployment table 2200, a new axis item 2210 is added to a function axis of the deployment table 1900.

In this case, as illustrated in the example of a relationship diagram 2250, a new dummy item 2260 is added. The placement position of the dummy item 2260 is set to the vicinity of items in the relationship diagram 2250, which correspond to other axis items (ease of closing at the opening time, ease of opening at the closing time) on the function axis.

For a user using only the deployment table 2200, the relationship diagram 2250 may not be displayed. The determination as to whether a user uses only the deployment table 2200 may be made based on the past history (whether a relationship diagram was displayed), or may be made based on attributes of the user (e.g., attributes indicating whether the user uses a relationship diagram, or a job type of the user).

FIGS. 23A and 23B are explanatory views illustrating an example of a processing (an example of a deletion of an axis item (element) in a deployment table) according to the first exemplary embodiment.

A deployment table 2300 is obtained by deleting a symmetry axis item 2310 from a function axis in the deployment table 1900 exemplified in FIGS. 19A and 19B.

In this case, as illustrated in the example of a relationship diagram 2350, the deleted axis item (element) is left as a target item (dummy) 2360.

FIGS. 24A and 24B are explanatory views illustrating an example of a processing (an example of correction of an axis item (element) in a deployment table) according to the first exemplary embodiment.

A deployment table 2400 is obtained by performing correction according to an axis item “correction” 2410, which is an axis item (element) on a function axis in the deployment table 1900.

In this case, as illustrated in the example of a relationship diagram 2450, correction may be performed according to an item “correction” 2460 corresponding to the axis item “correction” 2410.

FIGS. 25A and 25B are explanatory views illustrating an example of a processing (an example of an addition of causal relationship information in a deployment table) according to the first exemplary embodiment.

In a deployment table 2500, causal relationship information present at the intersection between “length” and “reed shape hardness” of the deployment table 1900 is changed from “−” to “⊚−” (new causal relationship information 2510) (this corresponds to addition of causal relationship information).

In this case, as illustrated in the example of a relationship diagram 2550, a relationship line 2560 is added. The relationship line 2560 is a relationship line that connects an item “length” to an item “reed shape hardness.”

FIGS. 26A and 26B are explanatory views illustrating an example of a processing (an example of a deletion of causal relationship information in a deployment table) according to the first exemplary embodiment.

In a deployment table 2600, causal relationship information present at the intersection between “blowing pressure” and “pressure difference during closing” of the deployment table 1900 is changed from “⊚+” to “−” (target causal relationship information 2610) (this corresponds to deletion of causal relationship information).

In this case, as illustrated in the example of a relationship diagram 2650, a target relationship line 2660 is deleted. When another causal relationship is affected, a corresponding message may be displayed so that deletion may not be allowed.

FIGS. 27A and 27B are explanatory views illustrating an example of a processing (an example of a correction of causal relationship information in a deployment table) according to the first exemplary embodiment.

In a deployment table 2700, causal relationship information present at the intersection between “diameter” and “reed shape hardness” of the deployment table 1900 is changed from “⊚−” to “⊚−” (target causal relationship information 2710) (this corresponds to correction of causal relationship information).

In this case, as illustrated in the example of a relationship diagram 2750, a target relationship line 2760A and a target relationship line 2760B corresponding to the target causal relationship information 2710 are corrected. When another causal relationship is affected, a corresponding message may be displayed so that correction may not be allowed.

### Second Exemplary Embodiment

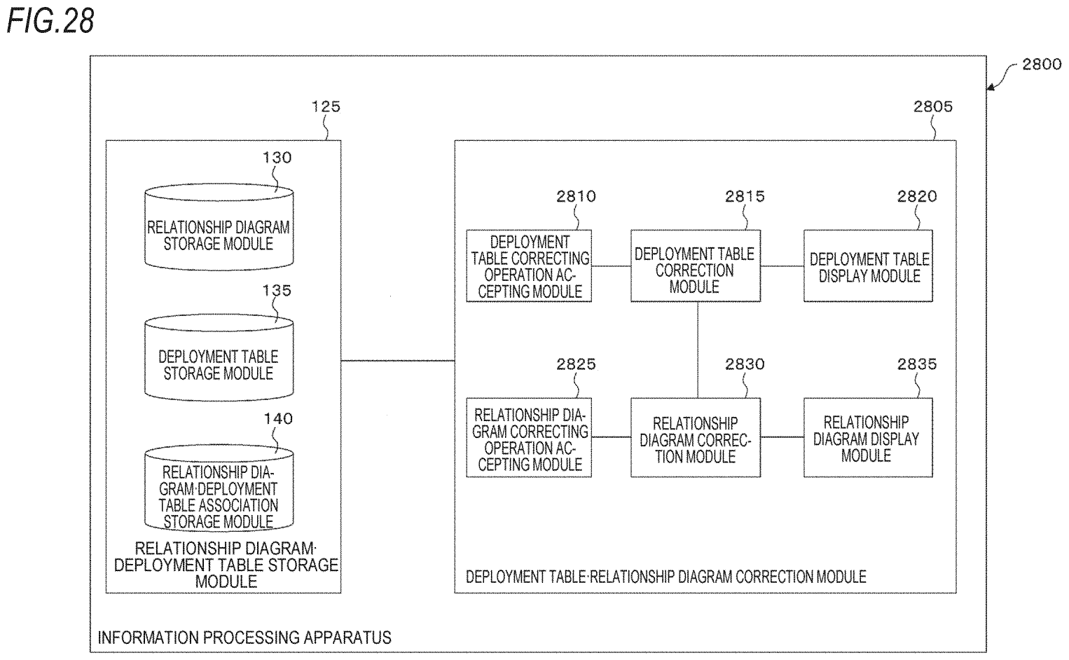

Prior to explanation of the second exemplary embodiment, descriptions will be made on a background of a deployment table and a relationship diagram. In particular, this explanation (from this paragraph to explanation using FIG. 28) is intended to facilitate the understanding of the second exemplary embodiment, and it is not intended to limit interpretation by using this explanation. Then, it is natural that using only this explanation part, it should not be determined that the invention to be patented is described in the detailed description of the invention.

In particular, in complicated causal relationships such as a relationship between a design and a quality in a system using complex physical phenomena, in general, many elements are linked to each other in a chain-like manner, in which, for example, for the result such as a final quality of a product, there are plural elements that become factors of the result, there are plural elements that become factors from which these elements are generated as a result, there are plural elements that become factors from which the elements are generated as a result, and . . . . In such a complicated system, since there are many qualities that have to be satisfied, causal relationships between a design group and a quality group become highly complicated. This tends to cause a problem that it is difficult to find a design item to satisfy a desired quality, or it is difficult to find that a change in a design value to satisfy a certain quality adversely affects another quality. Here, the factor refers to an element that may become a cause of a certain element.

There are several ways to visualize and organize such complicated causal relationships. Representative examples include (1) a relationship diagram (a logic tree is typical) in which relationship lines connect results to their factors so as to express causal relationships, and (2) a deployment table in which relationships between elements listed on plural axes orthogonal to each other are indicated by symbols or numerical values arranged in a matrix form. The deployment table is not necessarily limited to a table in which relationships between qualities and functions are developed. The relationship diagram is suitable for describing results and factors thereof in detail without omission/redundancy. Meanwhile, when the number of elements as targets excessively increases, the diagram becomes excessively complicated, and becomes hypertrophic. This causes difficulty in a practical use. Meanwhile, in the deployment table, among many elements, important things are extracted and arranged on axes, and then causal relationships are expressed in a matrix. Thus, relationships between many results and many factors may be simply expressed. However, it is not possible to express detailed causal relationships involving elements not arranged on the axes. As a result, missing of items is likely to occur. In a generally widely used deployment table, since a factor and a result are merely arranged on two axes (a horizontal axis and a vertical axis), respectively, it is not possible to give information on why such a relationship is made at the very beginning. Meanwhile, a multiaxial quality function development is effective in which three or more axes are arranged perpendicular to each other, and among factors constituting causal relationships, important things are extracted and described so as to schematically express the causal relationships.

From the above, the relationship diagram and the multiaxial deployment table may be used in combination so that mainly in the relationship diagram, it is possible to extract and describe causal relationships in detail without omission/redundancy, and mainly in the deployment table, it is possible to briefly display relationships between a large number of factors and results. However, conversion between the relationship diagram and the multiaxial deployment table is complicated, and thus for such a purpose, a system supporting the conversion becomes necessary.

There is already a system that draws a relationship diagram in which causal relationships are hierarchized, and selects hierarchies so as to display a biaxial deployment table. However, in order to create a relationship diagram in a hierarchized state, it is necessary that causal relationships are hierarchically organized from the beginning. Thus, it is difficult to perform detailed development of causal relationships without omission/redundancy, which is an original purpose. Even in a case where factors are divided into hierarchies, if all factors of selected hierarchies are displayed on a deployment table, an amount of information pieces to be displayed increases, and thus it is not possible to achieve the purpose of “extracting important factors” and displaying the factors.

In order to address such a problem, in Patent Document 1, there is proposed a technique in which in a created relationship diagram, elements corresponding to respective axes in a deployment table are selected and then deployed on the deployment table.

When a relationship diagram is created, an amount of information pieces in the relationship diagram increases so as to describe relationships between factors and results in detail without omission or redundancy. Whereas, a deployment table indicates causal relationships focused on important factors, and thus has a smaller amount of information pieces than the relationship diagram. Therefore, when the created relationship diagram is converted into the deployment table, information needs to be reduced. Meanwhile, in some cases, a hypothesis and a verification result on a causal relationship between factors is reflected in the deployment table. At this time, the reflection result also has to be reflected in the relationship diagram. However, as described above, only a causal relationship between important factors may be described in the deployment table, and it is not possible to describe what type of mechanism the causal relationship is made, in the deployment table. Accordingly, when a result of editing on the deployment table, as it is, is reflected in the relationship diagram, a relationship, which is not deeply discussed, is described in the relationship diagram. As a result, a causal relationship between factors becomes unclear on the relationship diagram or omission/redundancy occurs in the causal relationship. This causes confusion.

Therefore, in the second exemplary embodiment, (A1) created and changed information of a relationship diagram is reflected in a deployment table, (A2) created and changed information of a deployment table is reflected in a relationship diagram, and (A3) information reflected by (A2) is displayed in a manner distinguishable from others.

(A4), in (A1), confirmation processing is performed on information expressed by a box or connector in the relationship diagram, which is reflected by (A2) in a manner distinguishable from others, so that the display thereof may be changed in a manner undistinguishable from others.

As described above, in a deployment table, it is difficult to describe a causal relationship in detail. Thus, when correction to the deployment table is reflected in a relationship diagram, there is a possibility that the relationship diagram may be placed in a state where the causal relationship is not described in detail (there may be an omission/redundancy or a jump in logic).

Therefore, when displaying is made such that it is found that correction of the deployment table has been reflected, through application of the second exemplary embodiment, the fact that the description of the causal relationship has not been made through deep discussion that prevents an omission/redundancy or a jump in logic is clearly stated. This prevents cases of confusion. The causal relationship inserted in this manner, which is not described in detail, may be corrected on the relationship diagram and then changed to a causal relationship having no omission/redundancy nor a jump in logic.

Thereafter, through application of (A4), a normal display state is made. Then, the relationship diagram may not have any omission/redundancy or a jump in logic, as a whole. Keeping such a state may make it easier to find a correction portion when a new correction is made from the deployment table.

FIG. 28 is a schematic module diagram of an example of a configuration according to the second exemplary embodiment.

The same portions as those of the first exemplary embodiment are denoted by the same reference numerals and redundant explanations thereof will be omitted. The first exemplary embodiment and the second exemplary embodiment may be combined with each other.

The “correction” includes change and deletion of original information, and addition of new information.

The term “part” refers to a part constituting a relationship diagram. For example, an item for which an element is input is expressed by a box part, and a relationship line connecting item boxes is expressed by a connector part. For example, when an item on an axis in a deployment table is corrected, an element in a relationship diagram corresponding to the corrected item is corrected, and then the corrected element is converted into a mode different from that of the uncorrected element. When a symbol or a numerical value arranged in a matrix form in a deployment table is corrected, a relationship line in a relationship diagram corresponding to the corrected symbol or the corrected numerical value is corrected, and then the corrected relationship line is converted into a mode different from that of the uncorrected relationship line.

A “display module (a deployment table display module 2820 or a relationship diagram display module 2835)” may take any of forms (1) a display module that includes a display device, and causes the display device to display a target (a relationship diagram or a deployment table), and (2) a display control module (a control module not including the display device itself) that performs a control to display a target on a display device.

When a relationship diagram is corrected, “a correction module (a deployment table correction module 2815 or a relationship diagram correction module 2830)” may correct a deployment table corresponding to the relationship diagram. Then, a display module may display elements in the deployment table corrected by the correction module in such a way that the corrected element is displayed in a mode different from that of an uncorrected element. Alternatively, the display module may display elements in the deployment table corrected by the correction module in such a way that the corrected element is displayed in the same mode as that of the uncorrected element.

An information processing apparatus 2800 includes a relationship diagram deployment table storage module 125, and a deployment table relationship diagram correction module 2805.

The relationship diagram deployment table storage module 125 includes a relationship diagram storage module 130, a deployment table storage module 135, and a relationship diagram deployment table association storage module 140, and is connected to the deployment table relationship diagram correction module 2805.

The deployment table relationship diagram correction module 2805 includes a deployment table correcting operation receiving module 2810, the deployment table correction module 2815, the deployment table display module 2820, a relationship diagram correcting operation receiving module 2825, the relationship diagram correction module 2830, and the relationship diagram display module 2835. The deployment table relationship diagram correction module 2805 performs a processing related to correction of a deployment table or a relationship diagram.

The deployment table correcting operation receiving module 2810, the deployment table correction module 2815, and the deployment table display module 2820 perform a processing (e.g., creation, correction, or displaying) on a deployment table in which relationships between items listed on plural (particularly, three or more) axes perpendicular to each other are indicated by symbols or numerical values arranged in a matrix form.

The relationship diagram correcting operation receiving module 2825, the relationship diagram correction module 2830, and the relationship diagram display module 2835 perform a processing (creation, correction, displaying or the like) on a relationship diagram (a tree diagram is typical) in which relationship lines connect elements to each other so as to express relationships.

Then, the deployment table correction module 2815, and the relationship diagram correction module 2830 select an element in a relationship diagram corresponding to an axis of a deployment table so as to give a correspondence relationship to the two, and perform a processing such as mutual conversion.

The deployment table correcting operation receiving module 2810 is connected to the deployment table correction module 2815. The deployment table correcting operation receiving module 2810 receives a correcting user's operation on a deployment table displayed by the deployment table display module 2820.

The deployment table correction module 2815 is connected to the deployment table correcting operation receiving module 2810, the deployment table display module 2820, and the relationship diagram correction module 2830. The deployment table correction module 2815 corrects the deployment table according to the correcting operation received by the deployment table correcting operation receiving module 2810.

When a relationship diagram is corrected, the deployment table correction module 2815 corrects a deployment table corresponding to the relationship diagram.

The deployment table display module 2820 is connected to the deployment table correction module 2815. The deployment table display module 2820 displays the deployment table corrected by the deployment table correction module 2815, on a display device such as a liquid crystal display.

The relationship diagram correcting operation receiving module 2825 is connected to the relationship diagram correction module 2830. The relationship diagram correcting operation receiving module 2825 receives a correcting user's operation on a relationship diagram displayed by the relationship diagram display module 2835.

The relationship diagram correction module 2830 is connected to the deployment table correction module 2815, the relationship diagram correcting operation receiving module 2825, and the relationship diagram display module 2835. The relationship diagram correction module 2830 corrects the relationship diagram according to the correcting operation received by the relationship diagram correcting operation receiving module 2825. Then, when a deployment table is corrected, the relationship diagram correction module 2830 corrects a relationship diagram corresponding to the deployment table.

The relationship diagram display module 2835 is connected to the relationship diagram correction module 2830. The relationship diagram display module 2835 displays a relationship diagram corrected by the relationship diagram correction module 2830, on a display device such as a liquid crystal display.

The relationship diagram display module 2835 displays elements in the relationship diagram corrected by the relationship diagram correction module 2830 in such a way that the corrected element is displayed in a different mode from uncorrected elements.

The “different mode” may include not only addition of, for example, a character, a figure, or a symbol, but also a change of a shape, a pattern, or a color, a dynamic change thereof (e.g., flash, animation, or blinking (a changing target in blinking may include, for example, whether to perform the blinking, a blinking time period, and a blinking interval)), or a combination thereof. For example, the “different mode” corresponds to adding, for example, a character, a figure, or a symbol (characters such as “corrected”) indicating a correction, to a character string in an element, converting a rectangular element shape indicated by a solid line into a shape by a dashed line, converting a relationship line as a solid line into a line as a dashed line, changing a background color of an element from white to red or the like. It is desirable to employ a form by which correction is easily recognized. For example, this may correspond to conversion into, for example, a red color which is conspicuous.

Each of the deployment table display module 2820 and the relationship diagram display module 2835 may take any of forms, that is, (1) a display module that includes a display device, and causes the display device to display a target (a relationship diagram or a deployment table), and (2) a display control module (a control module not including the display device itself) that performs a control to display a target on a display device.

When a relationship diagram is corrected, the relationship diagram correction module 2830 may correct a deployment table corresponding to the relationship diagram. Then, the relationship diagram display module 2835 may display elements in the deployment table corrected by the relationship diagram correction module 2830 in such a way that the corrected element is displayed in a different mode from the uncorrected element. Alternatively, the relationship diagram display module 2835 may display elements in the deployment table corrected by the relationship diagram correction module 2830 in such a way that the corrected element is displayed in the same mode as the uncorrected element.

The relationship diagram correcting operation receiving module 2825 may receive user's operation indicating that a corrected part in a relationship diagram is approved and adopted, with respect to the relationship diagram displayed by the relationship diagram display module 2835. In this case, after a target part is selected, an operation of approving the selected part may be performed. Otherwise, an operation of collectively approving corrections to all parts may be performed. An operation of approving the correction of the selected part may be performed by selecting a button on a screen for correction approval, with a mouse, by selecting a button on a touch panel screen with a user finger, or by operating a keyboard key, after the part is selected.

Then, when an operation (user's operation indicating that the corrected part in the relationship diagram is approved) is received by the relationship diagram correcting operation receiving module 2825, the relationship diagram display module 2835 may change the mode of the corrected part to a mode equivalent to the mode of uncorrected parts, which do not affect the correction of the part in the relationship diagram by the correction of the deployment table.

As used herein, the term “equivalent” means that while the correction is reflected, the mode of display of the corrected part (displayed in a different mode from the uncorrected part) is changed to be the same as that of the uncorrected part. This means that the correction on the relationship diagram is formally reflected.

When the operation (the user's operation indicating that the correction is approved) is received by the relationship diagram correcting operation receiving module 2825, the relationship diagram correction module 2830 may confirm the correction of the part. Until the correction confirming operation (user's operation indicating that the correction is approved) is received, the correction in the relationship diagram is also treated as not being confirmed. As the confirmation operation is received, the correction in the relationship diagram is also confirmed.

When an operation (a user's operation indicating that the correction is approved) is received by the relationship diagram correcting operation receiving module 2825, the deployment table correction module 2815 may confirm the correction of the deployment table. Until the correction confirming operation (user's operation indicating that the correction is approved) is received on the relationship diagram, the correction in the deployment table is also treated as not being confirmed. As the confirmation operation is received, the correction in the deployment table is also confirmed.

After a relationship line in a relationship diagram is corrected, the relationship diagram correcting operation receiving module 2825 may receive user's operation indicating that an element is added in the middle of the relationship line.

Then, when an operation (the user's operation indicating that the element is added in the middle of the relationship line) is received by the relationship diagram correcting operation receiving module 2825, the relationship diagram display module 2835 may display that the element is added in the middle of the corresponding relationship line.

Since a detailed description is made without omission or redundancy in a relationship diagram, when correction is made to a deployment table, in many cases, there is a high possibility that an element is added in the middle of a relationship line in the relationship diagram corresponding to the deployment table. That is, when a meaning of the correction in the deployment table is reflected in detail in the relationship diagram, in many cases, addition of an element is performed in the relationship diagram.

A display that demands addition of an element in the middle of a relationship line may be made, or an element may be forcibly added in the middle of a relationship line (in a case where the addition is unnecessary, an operation indicating that addition is not performed may be needed).

In a case where an element is added in the middle of a relationship line, the relationship diagram correction module 2830 may confirm correction of a relationship line after the element is added in the middle of the corresponding relationship line.

Then, in a case where an element is added in the middle of a relationship line, the deployment table correction module 2815 may confirm correction of a deployment table.

Correcting a deployment table may include newly creating the deployment table.

When the deployment table is newly created, the relationship diagram display module 2835 may display an element in a relationship diagram, which is newly generated from the deployment table, in a form different from elements in a case where the relationship diagram is created alone. The new creation of the deployment table is also included in the correction, and in this case, all elements in the relationship diagram, which are created from the deployment table, are displayed as corrected elements. The “case where the relationship diagram is created alone” refers to a case where a relationship diagram is newly created regardless of a deployment table, instead of a case where a deployment table is firstly created, and then a relationship diagram corresponding to the deployment table is generated. That is, in a case where a deployment table is created in a state where a relationship diagram is not present, and a relationship diagram corresponding to the deployment table is generated, all elements in the generated relationship diagram are treated as elements corrected by correction of the deployment table.

Then, the relationship diagram correcting operation receiving module 2825 may receive user's operation indicating that a generated relationship diagram is approved, with respect to the relationship diagram displayed by the relationship diagram display module 2835.

When an operation (the user's operation indicating that the generated relationship diagram is approved) is received by the relationship diagram correcting operation receiving module 2825, the relationship diagram correction module 2830 may confirm the correspondence between a deployment table and the relationship diagram.

The generated relationship diagram as a whole may not be approved, but edited parts may be individually examined. Then, an item may be added and a relationship line may be re-connected as necessary, and the parts may be sequentially confirmed.

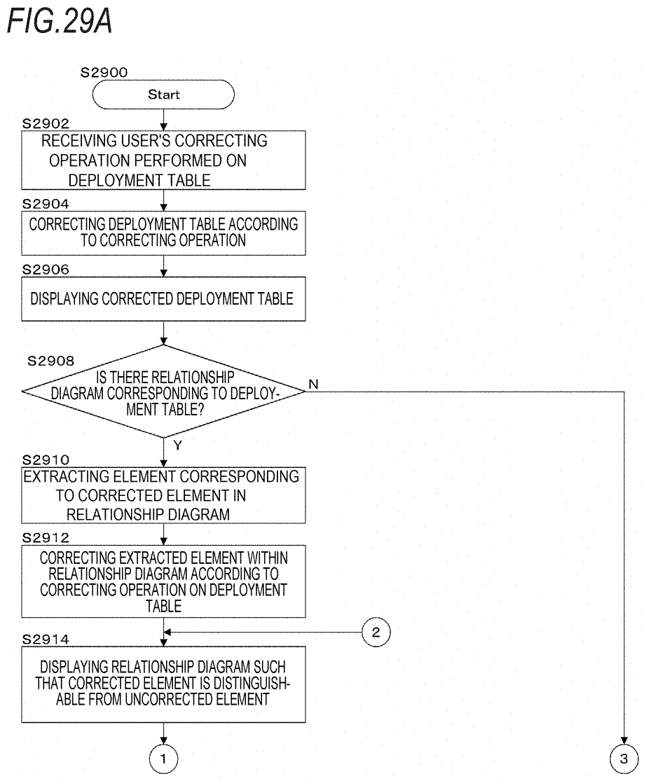

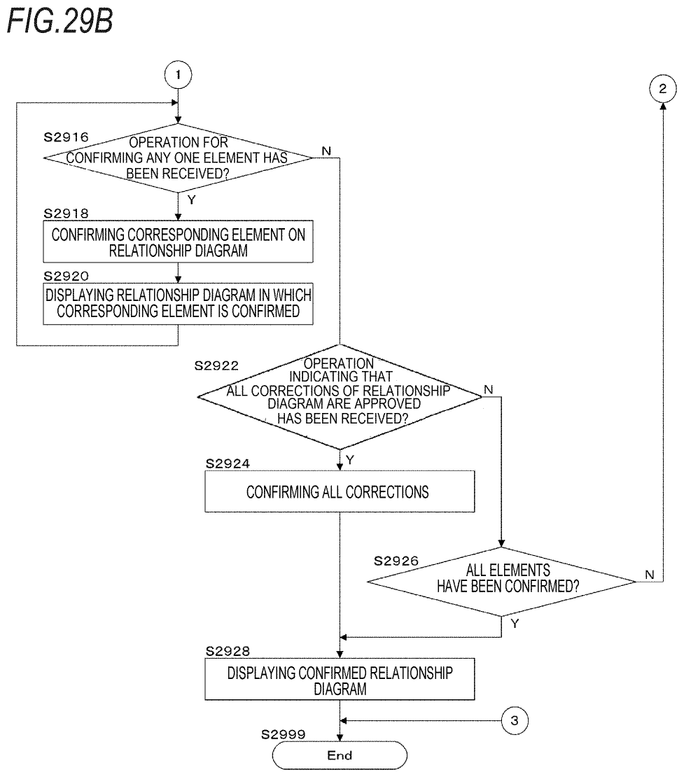

FIGS. 29A and 29B are flowcharts illustrating an example of a processing according to the second exemplary embodiment.

In step S2902, the deployment table correcting operation receiving module 2810 receives a correcting user's operation, which is performed on a deployment table.

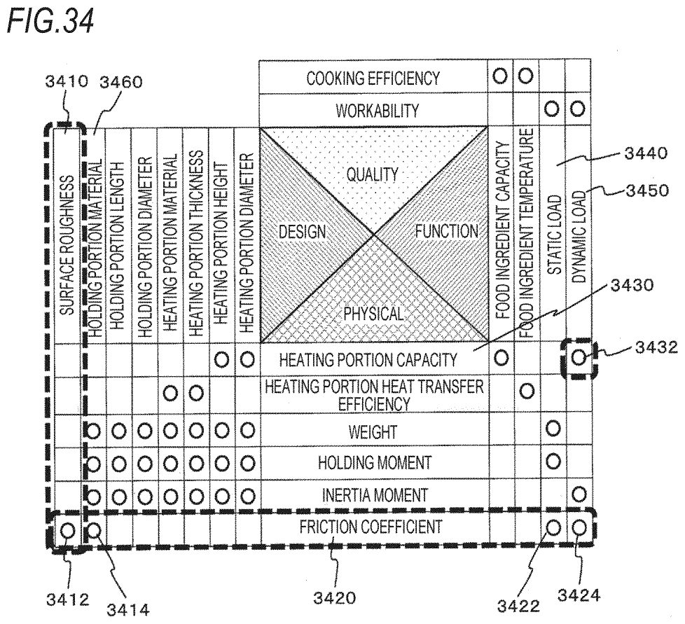

In step S2904, the deployment table correction module 2815 corrects the deployment table according to the correcting operation. Details will be described below by using the example in FIG. 34.

In step S2906, the deployment table display module 2820 displays the corrected deployment table.

In step S2908, the relationship diagram correction module 2830 determines whether there is a relationship diagram corresponding to the deployment table. When it is determined that there is a relationship diagram, the process proceeds to step S2910. Otherwise, the process ends (step S2999).

In step S2910, the relationship diagram correction module 2830 extracts a part in the relationship diagram, which corresponds to a corrected element.

In step S2912, the relationship diagram correction module 2830 corrects, the extracted part in the relationship diagram, according to the correcting operation on the deployment table.

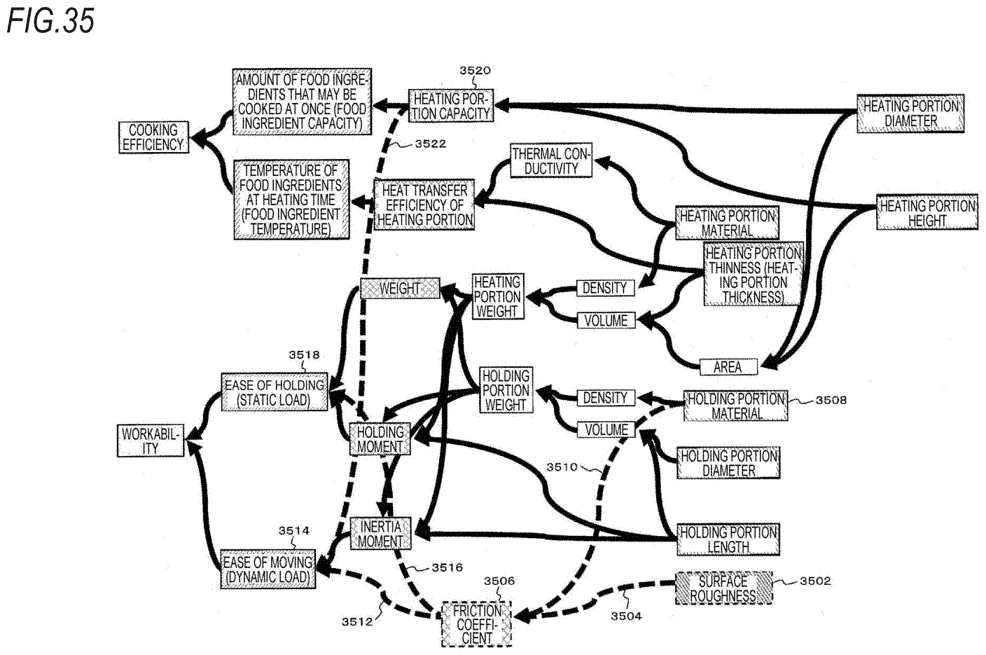

In step S2914, the relationship diagram display module 2835 displays the relationship diagram such that a corrected part and an uncorrected part are distinguished from each other. For the corrected part, a user has to determine, for example, a relationship of these elements and confirmation of a missing element, on the relationship diagram. Details will be described below by using the example of FIG. 35.

In step S2916, the relationship diagram correcting operation receiving module 2825 determines whether or not an operation of confirming any one part has been received. When it is determined that such an operation has been received, the process proceeds to step S2918. Otherwise, the process proceeds to step S2922.

In step S2918, the relationship diagram correction module 2830 confirms a corresponding part on the relationship diagram.

In step S2920, the relationship diagram display module 2835 displays the relationship diagram in which the corresponding part is confirmed (a corrected part is displayed in the same form as an uncorrected part), and returns to step S2916.

In step S2922, the relationship diagram correcting operation receiving module 2825 determines whether an operation indicating that corrections of the relationship diagram as a whole are approved has been received. When it is determined that an operation has been received, the process proceeds to step S2924. Otherwise, the process proceeds to step S2926.

In step S2924, the relationship diagram correction module 2830 confirms all the corrections.

In step S2926, the relationship diagram correcting operation receiving module 2825 determines whether all parts have been confirmed. When it is determined that all parts have been confirmed, the process proceeds to step S2928. Otherwise, the process returns to step S2914.

In step S2928, the relationship diagram display module 2835 displays the confirmed relationship diagram.

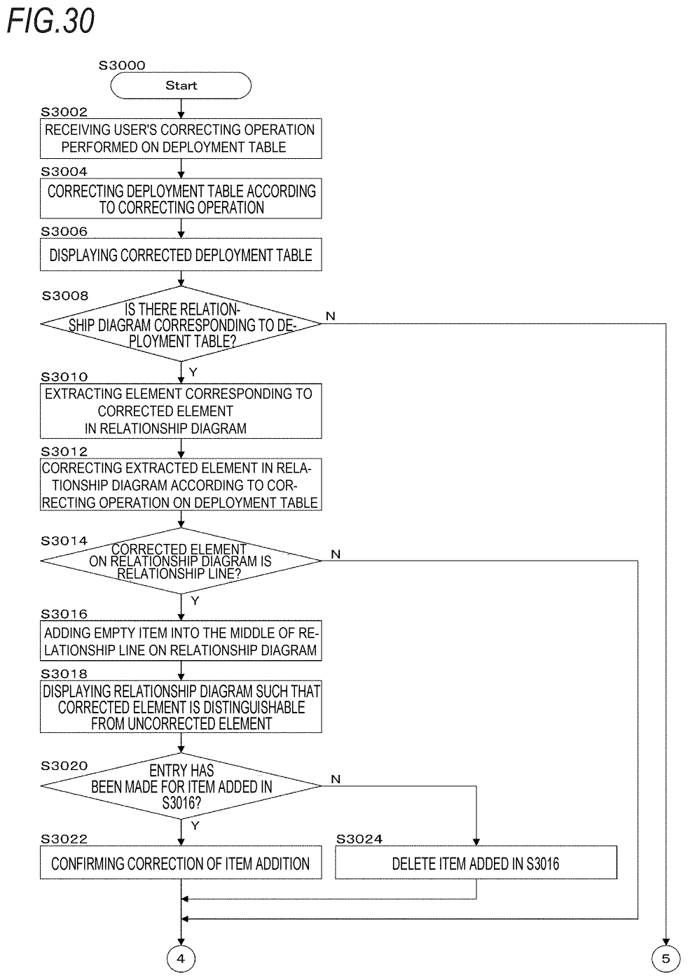

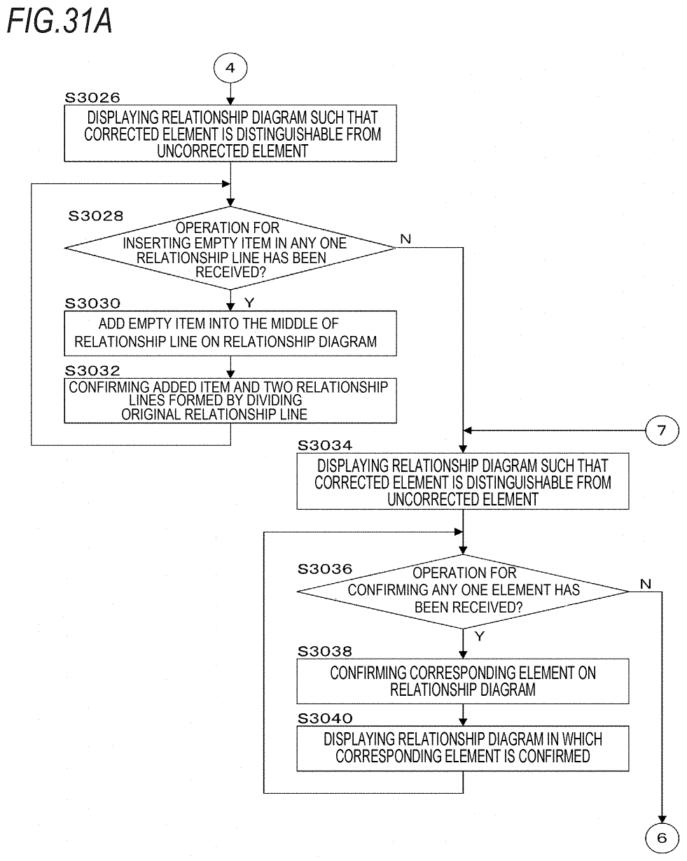

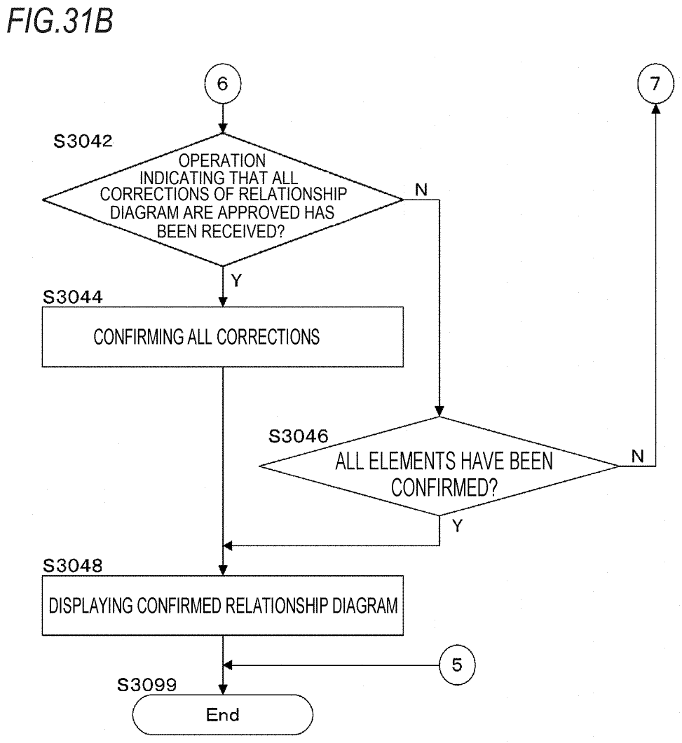

FIGS. 30, 31A, and 31B are flowcharts illustrating an example of a processing according to the second exemplary embodiment.

In step S3002, the deployment table correcting operation receiving module 2810 receives a correcting user's operation, which is performed on a deployment table.

In step S3004, the deployment table correction module 2815 corrects the deployment table according to the correcting operation. Details will be described below by using the example in FIG. 34.

In step S3006, the deployment table display module 2820 displays the corrected deployment table.

In step S3008, the relationship diagram correction module 2830 determines whether there is a relationship diagram corresponding to the deployment table. When it is determined that there is a relationship diagram, the process proceeds to step S3010. Otherwise, the process ends (step S3099).

In step S3010, the relationship diagram correction module 2830 extracts a part in the relationship diagram, which corresponds to a corrected part.

In step S3012, the relationship diagram correction module 2830 corrects the extracted part in the relationship diagram, according to the correcting operation on the deployment table.

In step S3014, the relationship diagram correction module 2830 determines whether the corrected part on the relationship diagram is a relationship line. When it is determined that the corrected part is a relationship line, the process proceeds to step S3016. Otherwise, the process proceeds to step S3026.

In step S3016, the relationship diagram correction module 2830 adds an empty item in the middle of the relationship line, on the relationship diagram.

In step S3018, the relationship diagram display module 2835 displays the relationship diagram such that a corrected part and an uncorrected part are distinguished from each other. For the corrected part, a user has to determine, for example, a relationship of these elements and confirmation of a missing element, on the relationship diagram.

In step S3020, the relationship diagram correcting operation receiving module 2825 determines whether an entry has been made for the item added in step S3016. When it is determined that an entry has been made, the process proceeds to step S3022. Otherwise, the process proceeds to step S3024.

In step S3022, the relationship diagram correction module 2830 confirms correction of item addition.

In step S3024, the relationship diagram correction module 2830 deletes the item added in step S3016.

In step S3026, the relationship diagram display module 2835 displays the relationship diagram such that a corrected part and an uncorrected part are distinguished from each other.

In step S3028, the relationship diagram correcting operation receiving module 2825 determines whether or not an operation of inserting an empty item in any one relationship line has been received. When it is determined that such an operation has been received, the process proceeds to step S3030. Otherwise, the process proceeds to step S3034.

In step S3030, the relationship diagram correction module 2830 adds an empty item in the middle of the relationship line on the relationship diagram.

In step S3032, the relationship diagram correction module 2830 confirms the added item and two relationship lines formed by dividing the original relationship line, and returns to step S3028.

In step S3034, the relationship diagram display module 2835 displays the relationship diagram such that a corrected part and an uncorrected part are distinguished from each other.

In step S3036, the relationship diagram correcting operation receiving module 2825 determines whether or not an operation of confirming any one part has been received. When it is determined that such an operation has been received, the process proceeds to step S3038. Otherwise, the process proceeds to step S3042.

In step S3038, the relationship diagram correction module 2830 confirms a corresponding part on the relationship diagram.

In step S3040, the relationship diagram display module 2835 displays the relationship diagram in which the corresponding part is confirmed, and returns to step S3036.

In step S3042, the relationship diagram correcting operation receiving module 2825 determines whether an operation indicating that corrections of the relationship diagram as a whole are approved has been received. When an operation has been received, the process proceeds to step S3044. Otherwise, the process proceeds to step S3046.

In step S3044, the relationship diagram correction module 2830 confirms all the corrections.

In step S3046, the relationship diagram correction module 2830 determines whether all parts have been confirmed. When it is determined that all parts have been confirmed, the process proceeds to step S3048. Otherwise, the process returns to step S3034.

In step S3048, the relationship diagram display module 2835 displays the confirmed relationship diagram.

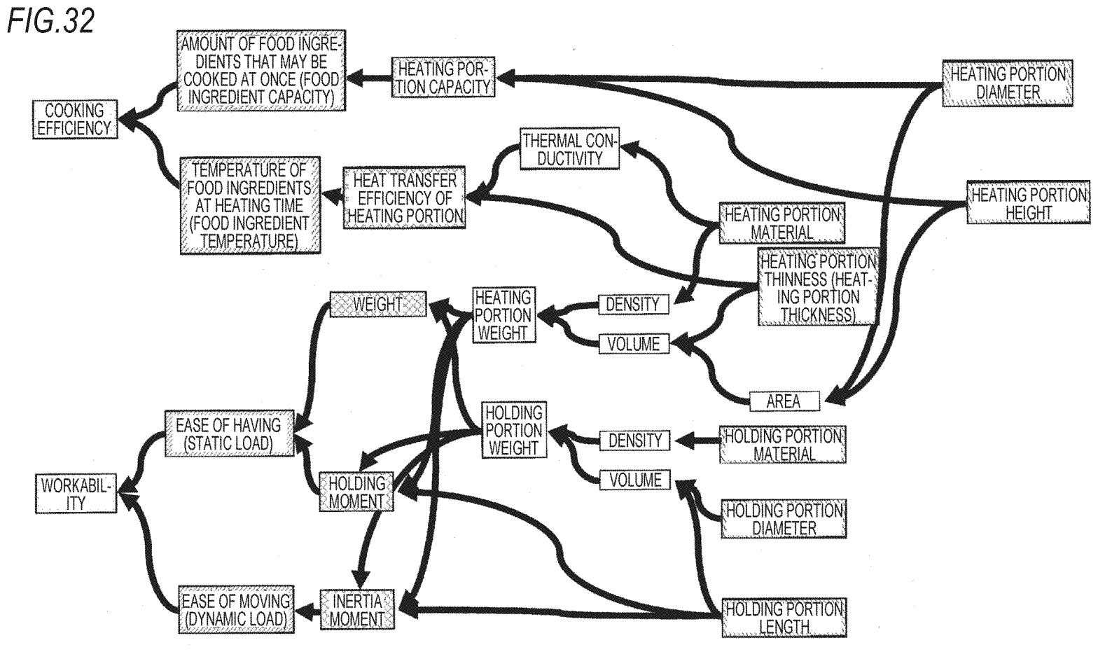

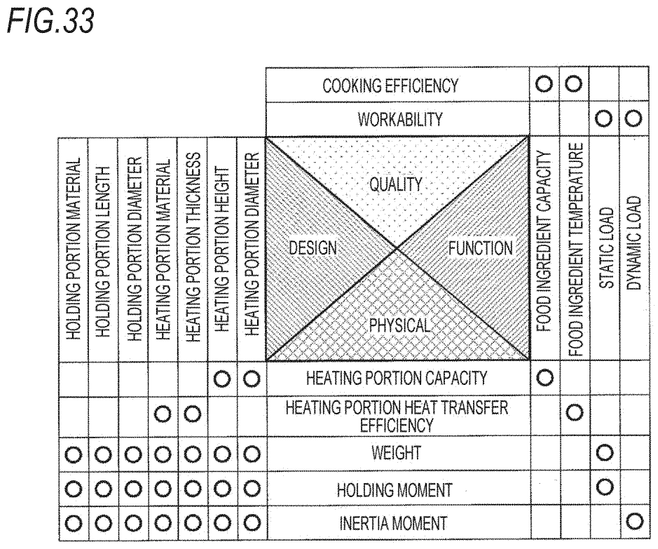

FIG. 32 is an explanatory view illustrating an example of a relationship diagram before corrected. FIG. 33 is an explanatory view illustrating an example of a deployment table before corrected. The relationship diagram exemplified in FIG. 32 corresponds to the deployment table exemplified in FIG. 33.

Specifically, as items corresponding to items on a quality axis (first axis) in the deployment table illustrated in the example of FIG. 33, there are “cooking efficiency” and “workability” in the relationship diagram illustrated in the example of FIG. 32 (two elements present at the left end in the example of FIG. 32). These may be displayed in a first color, for example, red.

As items corresponding to items on a function axis (second axis) in the deployment table illustrated in the example of FIG. 33, there are “amount of food ingredients that may be cooked at once (food ingredient capacity),” “temperature of food ingredients at the heating time (food ingredient temperature),” “ease of having (static load),” and “ease of moving (dynamic load)” in the relationship diagram illustrated in the example of FIG. 32 (four elements present in the second hierarchy from the left end in the example of FIG. 32). These may be displayed in a second color, for example, yellow.

As items corresponding to items on a physical axis (third axis) in the deployment table illustrated in the example of FIG. 33, there are “heating portion capacity,” “heating portion heat transfer efficiency,” “weight,” “holding moment,” and “inertia moment” in the relationship diagram illustrated in the example of FIG. 32 (five elements present in the third hierarchy from the left end in the example of FIG. 32). These may be displayed in a third color, for example, blue.

As items corresponding to items on a design axis (fourth axis) in the deployment table illustrated in the example of FIG. 33, there are “heating portion diameter,” “heating portion height,” “heating portion material,” “heating portion thinness (heating portion thickness),” “holding portion material,” “holding portion diameter,” and “holding portion length” in the relationship diagram illustrated in the example of FIG. 32 (seven elements present in the fourth and subsequent hierarchies from the left end in the example of FIG. 32). These may be displayed in a fourth color, for example, green.

The elements in the relationship diagram corresponding to each axis (first axis, second axis, third axis, fourth axis) of the deployment table are associated with a color, but may be associated with any form other than a color (e.g., a line type (e.g., a thick line or a dotted line) of a rectangle surrounding an element or addition of a corresponding character string (first axis, second axis, third axis, or fourth axis) to each axis).

As described above, in general, after a relationship diagram is created, a deployment table is created so as to display a relationship between elements in an easy-to-understand manner. Then, an element in the relationship diagram corresponds to an item on an axis in the deployment table. The relationship diagram has a larger amount of information pieces than the deployment table, and thus includes elements not reflected in the deployment table (e.g., “thermal conductivity,” “heating portion weight,” and “density”). A relationship line in the relationship diagram corresponds to a symbol in a matrix in the deployment table (“o” in the example of FIG. 33). In the relationship diagram illustrated in FIG. 32, “cooking efficiency” is connected to “amount of food ingredients that may be cooked at once (food ingredient capacity)” and “temperature of food ingredients at the heating time (food ingredient temperature)” while in the deployment table illustrated in FIG. 33, “o” is described in a cell at the intersection between “cooking efficiency” on the first axis and “food ingredient capacity” on the second axis, and “o” is described in a cell at the intersection between “cooking efficiency” on the first axis and “food ingredient temperature” on the second axis. In the relationship diagram illustrated in FIG. 32, “workability” is connected to “ease of having (static load)” and “ease of moving (dynamic load)” while in the deployment table illustrated in FIG. 33, “o” is described in a cell at the intersection between “workability” on the first axis and “static load” on the second axis, and “o” is described in a cell at the intersection between “workability” on the first axis and “dynamic load” on the second axis. Other relationship lines and “o” in other cells also similarly correspond to each other.

FIG. 34 is an explanatory view illustrating an example of a deployment table after corrected. This illustrates an example in a state where a correcting user's operation has been performed on the deployment table illustrated in the example of FIG. 33.

Specifically, in the deployment table illustrated in the example of FIG. 33, a “surface roughness” 3410 is added to the design axis (fourth axis), a “friction coefficient” 3420 is added to the physical axis (third axis), and a relation between surface roughness friction coefficient 3412, a relation between holding portion material friction coefficient 3414, a relation between friction coefficient static load 3422, a relation between friction coefficient dynamic load 3424, and a relation between heating portion capacity dynamic load 3432 are added in cells of the matrix.

FIG. 35 is an explanatory view illustrating an example of a relationship diagram. This illustrates an example of a result of a processing according to the second exemplary embodiment (an example of a display of a relationship diagram). This illustrates a result of a processing by the flowchart illustrated in the example of FIG. 29 (an example of a display in a manner distinguishable from an uncorrected part).

Unlike in FIG. 32, in the relationship diagram illustrated in the example of FIG. 35, as elements, a “surface roughness (temporary)” 3502 (corresponding to the “surface roughness” 3410), and a “friction coefficient (temporary)” 3506 (corresponding to the “friction coefficient” 3420) are added, and as relationship lines, a temporary relationship line 3504 (corresponding to the relation between surface roughness friction coefficient 3412) connecting the “surface roughness (temporary)” 3502 (corresponding to the “surface roughness” 3410) to the “friction coefficient (temporary)” 3506 (corresponding to the “friction coefficient” 3420), a temporary relationship line 3510 (corresponding to the relation between holding portion material friction coefficient 3414) connecting a “holding portion material” 3508 (corresponding to a “holding portion material” 3460) to the “friction coefficient (temporary)” 3506 (corresponding to the “friction coefficient” 3420), a temporary relationship line 3516 (corresponding to the relation between friction coefficient static load 3422) connecting the “friction coefficient (temporary)” 3506 (corresponding to the “friction coefficient” 3420) to an “ease of having (static load)” 3518 (corresponding to a “static load” 3440), a temporary relationship line 3512 (corresponding to the relation between friction coefficient dynamic load 3424) connecting the “friction coefficient (temporary)” 3506 (corresponding to the “friction coefficient” 3420) to an “ease of moving (dynamic load)” 3514 (corresponding to a “dynamic load” 3450), and a temporary relationship line 3522 (corresponding to the relation between heating portion capacity dynamic load 3432) connecting a “heating portion capacity” 3520 (corresponding to a heating portion capacity 3430) to the “ease of moving (dynamic load)” 3514 (corresponding to the “dynamic load” 3450) are added. Then, these added things are displayed in a form different from original parts. That is, a corrected relationship line is indicated by a dotted line instead of a solid line, and a corrected element is surrounded by a dotted line rectangle instead of a solid line rectangle.

In this state, when an operation indicating that these corrections (e.g., additions) are approved (e.g., an operation of pressing a “correction reflecting button”) is made, corrected parts are displayed in a manner equivalent to the original parts. Specifically, relationship lines indicated by dotted lines are changed to relationship lines indicated by solid lines, and dotted line rectangles are changed to solid line rectangles.

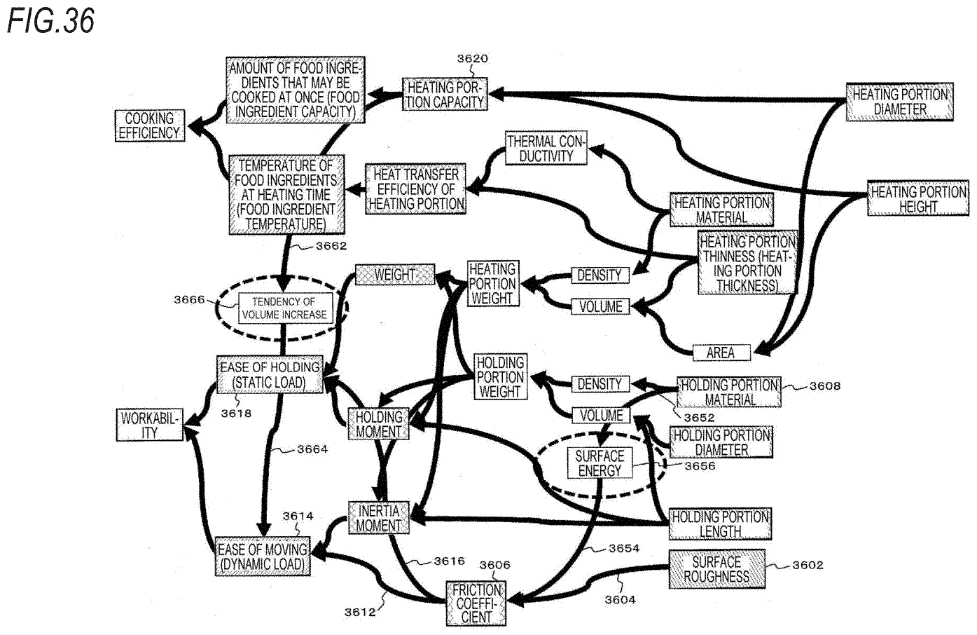

FIG. 36 is an explanatory view illustrating an example of a relationship diagram. This illustrates an example of a result of a processing according to the second exemplary embodiment (an example of a display in a case where a detailed causal relationship is described in the middle of a relationship line in the relationship diagram). This illustrates a result of a processing by the flowchart illustrated in the example of FIGS. 30, 31A, and 31B (an example of a display in a manner distinguishable from an uncorrected part).

An element is added in the middle of a newly added relationship line. Specifically, a “surface energy” 3656 is added in the middle of a relationship line connecting a “holding portion material” 3608 to a “friction coefficient” 3606, and a relationship line (confirmed) 3652 connecting the “holding portion material” 3608 to the “surface energy” 3656, and a relationship line (confirmed) 3654 connecting the “surface energy” 3656 to the “friction coefficient” 3606 are added. Then, an “ease of volume increase” 3666 is added in the middle of a relationship line connecting a “heating portion capacity” 3620 to an “ease of moving (dynamic load)” 3614, and a relationship line (confirmed) 3662 connecting the “heating portion capacity” 3620 to the “ease of volume increase” 3666, and a relationship line (confirmed) 3664 connecting the “ease of volume increase” 3666 to the “ease of moving (dynamic load)” 3614 are added. A rectangle (a dotted line rectangle) in which an element may be written was added and displayed in the middle of each of a relationship line (confirmed) 3604 connecting a “surface roughness” 3602 to the “friction coefficient” 3606, a relationship line (confirmed) 3616 connecting the “friction coefficient” 3606 to an “ease of having (static load)” 3618, and a relationship line (confirmed) 3612 connecting the “friction coefficient” 3606 to the “ease of moving (dynamic load)” 3614. However, the rectangle has been deleted because a description in the rectangle was not made by a user (otherwise, an operation of deleting the rectangle was made).

A user selects the temporary relationship line 3522 or the temporary relationship line 3510, which is added by correction in FIG. 35 and displayed in a mode (dotted line) different from other parts, and gives an instruction to insert an item. Based on the item insertion instruction, an empty item inserted in the relationship line is displayed, and item contents are input to the item. Thereafter, when an operation of confirming corrected contents is made, the relationship lines and inserted items as parts added in the relationship diagram corresponding to the edited deployment table are confirmed. When a new part item is inserted in a relationship line, a new relationship line is generated between a connection source of an original relationship line and the newly inserted item, and a new relationship line is generated between a connection destination of the original relationship line and the newly inserted item. As illustrated in FIG. 35, the relationship line 3522 connects the item “heating portion capacity” 3520 as a connection source to the item the “ease of moving (dynamic load)” 3514 as a connection destination. When the item “ease of volume increase” 3666 indicating a new element is inserted in the relationship line 3522 as illustrated in FIG. 36, two new relationship lines, that is, the relationship line 3662 connecting the item “heating portion capacity” 3620 as a connection source to the inserted item “ease of volume increase” 3666 as a connection destination, and the relationship line 3664 connecting the inserted item “ease of volume increase” 3666 as a connection source to the item “ease of moving (dynamic load)” 3614 as a connection destination are generated. Likewise for the relationship line 3510 illustrated in FIG. 35, after the relationship line 3510 is selected and an instruction is made to insert an item, when the item “surface energy” 3656 is input and then the insertion processing is confirmed as illustrated in FIG. 36, the relationship line 3652, the item “surface energy” 3656, and the relationship line 3654 are newly generated.

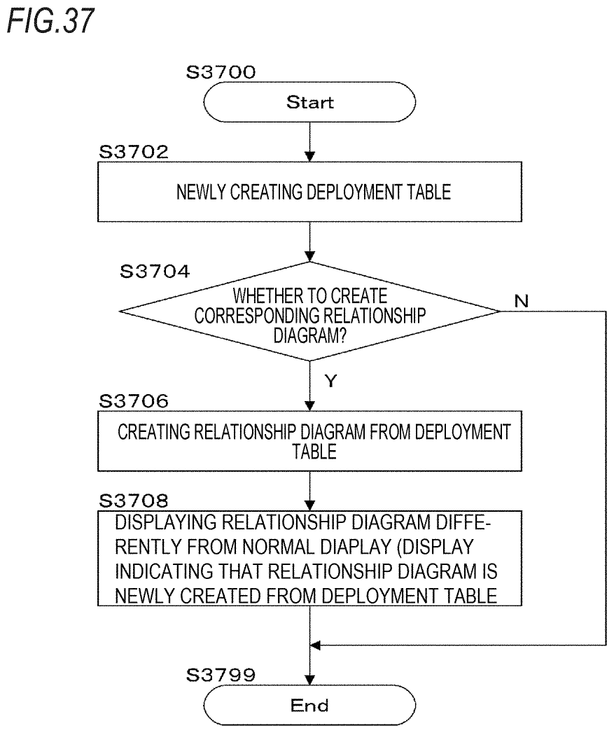

FIG. 37 is a flowchart illustrating an example of a processing according to the second exemplary embodiment. As described above, in general, after a relationship diagram is created by a user, a deployment table corresponding to the relationship diagram is generated. However, in some cases, after a deployment table is created by a user, a relationship diagram corresponding to the deployment table is generated. This illustrates an example of a processing of such a case.

In step S3702, the deployment table correction module 2815 newly creates a deployment table according to user's operation received by the deployment table correcting operation receiving module 2810.

In step S3704, the deployment table correcting operation receiving module 2810 determines whether to create a corresponding relationship diagram according to user's operation. When it is determined to create a relationship diagram, the process proceeds to step S3706. Otherwise, the process ends (step S3799).

In step S3706, the relationship diagram correction module 2830 creates a relationship diagram from the deployment table.

In step S3708, the relationship diagram display module 2835 performs a display different from a normal display, on the relationship diagram (a display indicating that the relationship diagram is newly created from the deployment table). For example, like the “surface roughness (temporary)” 3502, and the temporary relationship line 3504 in the relationship diagram illustrated in FIG. 35, an element surrounded by a dotted line rectangle, and a relationship line as a dotted line may be displayed. For these, a user has to determine, for example, a relationship of these elements and confirmation of a missing element or the like, on the relationship diagram.

A “normal display” corresponds to, for example, a display of a relationship diagram in a case where the relationship diagram is firstly created between a deployment table and the relationship diagram.

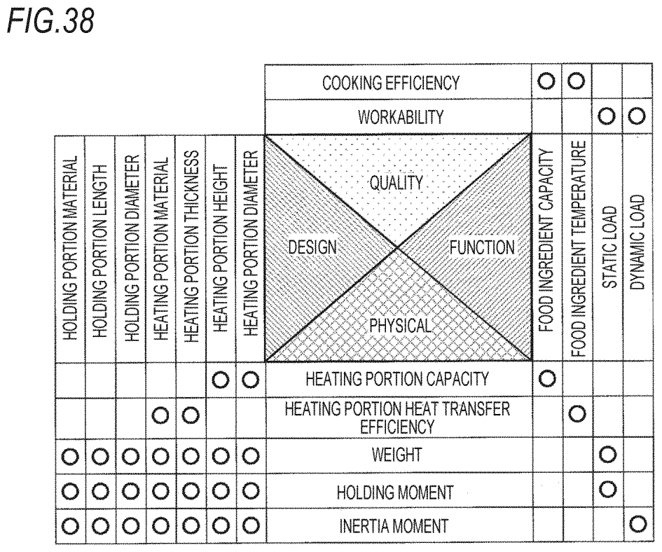

Thereafter, an example will be illustrated by using an example illustrated in FIGS. 38 to 41, in which a deployment table is created first, a relationship diagram is generated from the deployment table, and the relationship diagram is corrected and then is completed. That is, when a deployment table is newly created, a generated relationship diagram corresponding to the deployment table is placed in a state where all relationship lines are not confirmed. This illustrates an example in which an operation of confirming the relationship lines in the state (including addition of a part in the middle of a relationship line as well as a simple confirmation operation) is received to complete the relationship diagram.

FIG. 38 is an explanatory view illustrating an example of a deployment table. This deployment table is a newly created deployment table. This is equivalent to the deployment table illustrated in the example of FIG. 33. At this point in time, a relationship diagram has not been created.

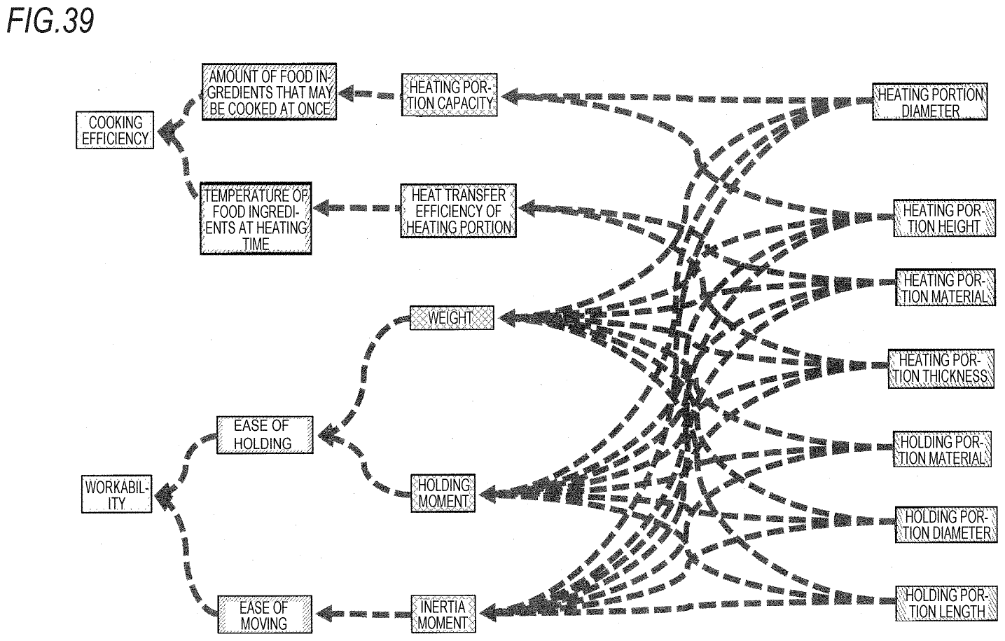

FIG. 39 is an explanatory view illustrating an example of a relationship diagram created from a deployment table. That is, the relationship diagram has been generated from the deployment table exemplified in FIG. 38. In this state, all relationship lines remain as dashed lines. That is, since confirmation has not been made on the relationship diagram, relationship lines as dashed lines are displayed unlike relationship lines as solid lines in a case where a relationship diagram is created alone (a case where a relationship diagram is newly created).

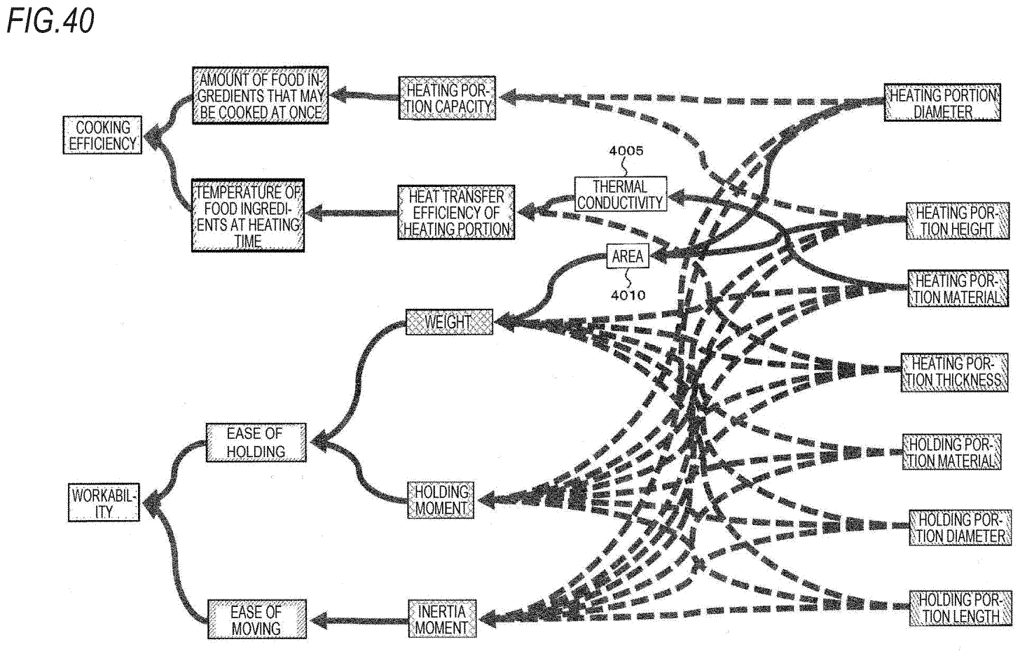

FIG. 40 is an explanatory view illustrating an example of a relationship diagram. This illustrates an example of a relationship diagram when a confirmation work is being performed on the relationship diagram illustrated in the example of FIG. 39.

In this case, a user confirms a portion with no jump in logic to change a dashed line of a relationship line into a solid line, and inserts elements (a thermal conductivity and an area) between required portions so that confirmations are sequentially performed.

As described above, an exemplary embodiment in which an element is inserted in the middle of a selected relationship line is utilized in this case.

Specifically, by inserting a “thermal conductivity 4005” between (in the middle of a relationship line) “heating portion material” and “heating portion heat transfer efficiency,” relationship lines that connect “heating portion material” to the “thermal conductivity 4005” and the “thermal conductivity 4005” to “heating portion heat transfer efficiency” are confirmed.

Then, in the case of an “area 4010,” two relationship lines are selected, and an element is inserted in the middle of the relationship lines. In this manner, plural relationship lines may be selected and an element may be inserted therebetween. Specifically, the “area 4010” is inserted between “heating portion diameter” and “weight” (in the middle of a relationship line) to confirm relationship lines connecting “heating portion diameter” to the “area 4010,” and the “area 4010” to “weight.” The same “area 4010” is inserted between “heating portion height” and “weight” (in the middle of a relationship line) to confirm relationship lines connecting “heating portion height” to the “area 4010,” and the “area 4010” to “weight.”

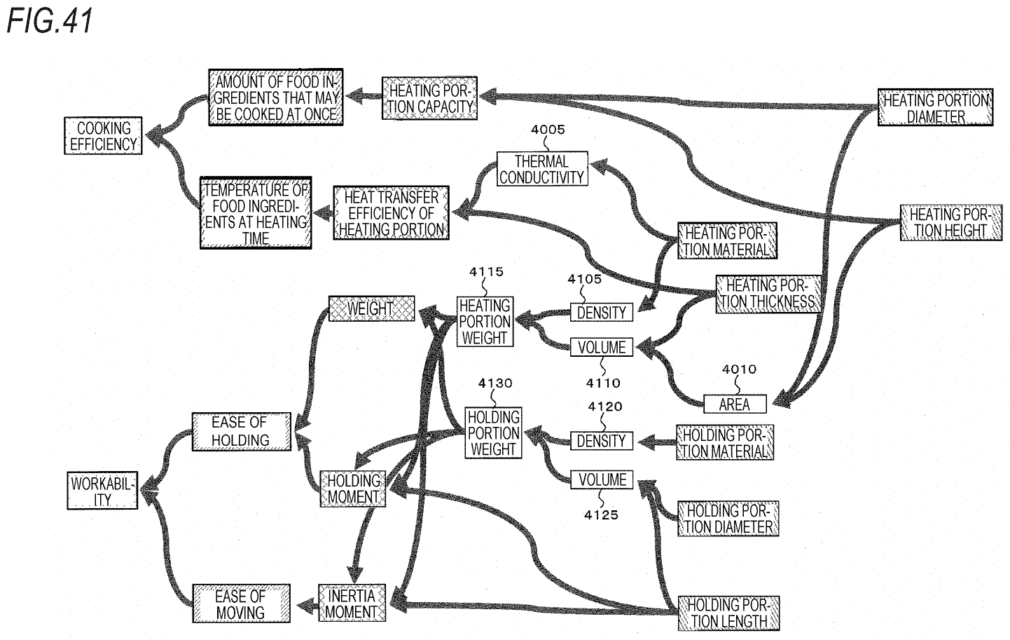

FIG. 41 is an explanatory view illustrating an example of a relationship diagram. This illustrates an example of a relationship diagram when a confirmation work has been completed on the relationship diagram illustrated in the example of FIG. 39. Since a user thinks about a mechanism on the relationship diagram, the relationship diagram has become clear and easy to see. Specifically, in addition to a relationship line confirmation operation (e.g., confirmation of a relationship line between “heating portion diameter” and “heating portion capacity”), like the “thermal conductivity 4005” and the “area 4010” illustrated in the example of FIG. 40, a “density 4105,” a “volume 4110,” a “heating portion weight 4115,” a “density 4120,” a “volume 4125,” and a “holding portion weight 4130” are added to confirm relationship lines.

### Third Exemplary Embodiment

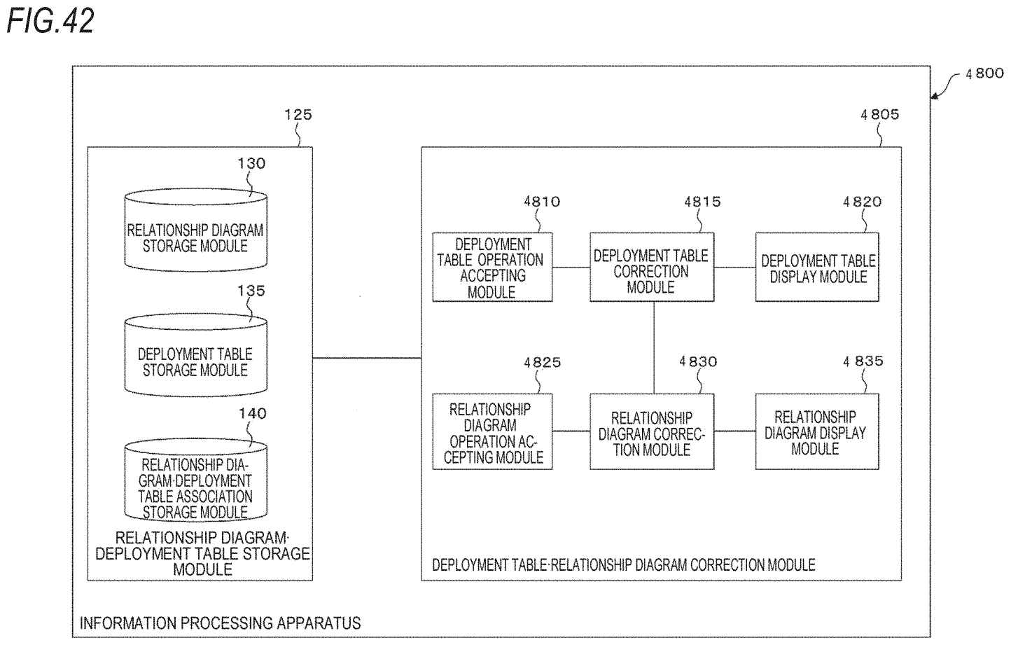

Prior to explanation of the third exemplary embodiment, descriptions will be made on a background of a deployment table and a relationship diagram. In particular, this explanation (from this paragraph to explanation using FIG. 42) is intended to facilitate the understanding of the third exemplary embodiment, and it is not intended to limit interpretation by using this explanation. Then, it is natural that using only this explanation part, it should not be determined that the invention to be patented is described in the detailed description of the invention.

In particular, in complicated causal relationships such as a relationship between a design and a quality in a system using complex physical phenomena, in general, many elements are linked to each other in a chain-like manner, in which, for example, for the result such as a final quality of a product, there are plural elements that become factors of the result, there are plural elements that become factors from which these elements are generated as a result, there are plural elements that become factors from which the elements are generated as a result, and . . . . In such a complicated system, since there are many qualities that have to be satisfied, causal relationships between a design group and a quality group become highly complicated. This tends to cause a problem that it is difficult to find a design item to satisfy a desired quality, or it is difficult to find that a change in a design value to satisfy a certain quality adversely affects another quality. Here, the factor refers to an element that may become a cause of a certain element.

There are several ways to visualize and organize such complicated causal relationships. Representative examples include (1) a relationship diagram (a logic tree is typical) in which relationship lines connect results to their factors so as to express causal relationships, and (2) a deployment table in which relationships between elements listed on plural axes orthogonal to each other are indicated by symbols or numerical values arranged in a matrix form. The relationship diagram is suitable for describing results and factors thereof in detail without omission or redundancy. Meanwhile, when the number of elements as targets excessively increases, the diagram becomes excessively complicated, and becomes hypertrophic. This causes difficulty in a practical use. Meanwhile, in the deployment table, among many elements, important things are extracted and arranged on axes, and then causal relationships are expressed in a matrix. Thus, relationships between many results and many factors may be simply expressed. However, it is not possible to express detailed causal relationships involving elements not arranged on the axes. As a result, missing of items is likely to occur. In a generally widely used deployment table, since a factor and a result are merely arranged on two axes (a horizontal axis and a vertical axis), respectively, it is not possible to give information on why such a relationship is made at the very beginning. Meanwhile, a multiaxial quality function development is effective in which three or more axes are arranged perpendicular to each other, and among factors constituting causal relationships, important things are extracted and described so as to schematically express the causal relationships.

From the above, the relationship diagram and the multiaxial deployment table may be used in combination so that it is possible to extract and describe causal relationships in detail without omission or redundancy, and to briefly display relationships between a large number of factors and results. However, conversion between the relationship diagram and the multiaxial deployment table is complicated, and thus for such a purpose, a system supporting the conversion becomes necessary.

There is already a system that draws a relationship diagram in which causal relationships are hierarchized, and selects hierarchies so as to display a biaxial deployment table. However, in order to create a relationship diagram in a hierarchized state, it is necessary that causal relationships are hierarchically organized from the beginning. Thus, it is difficult to perform detailed development of causal relationships without omission/redundancy, which is an original purpose. Even in a case where factors are divided into hierarchies, if all factors of selected hierarchies are displayed on a deployment table, an amount of information pieces to be displayed increases, and thus it is not possible to achieve the purpose of “extracting important factors” and displaying the factors.

In order to address such a problem, in Patent Document 1, there is proposed a technique in which in a created relationship diagram, elements corresponding to respective axes in a deployment table are selected and then deployed on the deployment table. However, in this method, information pieces of the relationship diagram are reduced to create the deployment table. Thus, the deployment table has a much smaller amount of information pieces than the relationship diagram. For this reason, there is a problem in that it is possible to perform development from the relationship diagram to the deployment table, but it is difficult to reflect a change of the deployment table in the relationship diagram in reverse.

As described above, in structures of a relationship diagram and a deployment table, the same causal relationship is visualized with different roles. Thus, it is possible to use only one side, or perform unilateral conversion from one side to the other side. Further, it is necessary that information pieces indicating complicated causal relationships are included without exception, and then exchangeably created and viewed.

In the technique described in Patent Document 1, when in a relationship diagram, elements corresponding to axes in a deployment table are connected to each other via an element not corresponding to an axis in the deployment table, and a corresponding causal relationship is deleted from a matrix in the deployment table, it is not possible to determine which causal relationship between elements has to be deleted from the relationship diagram. This causes an obstacle in linkage between the deployment table and the relationship diagram.

FIG. 42 is a schematic module diagram of an example of a configuration according to the third exemplary embodiment.

The same portions as those of the first exemplary embodiment are denoted by the same reference numerals and redundant explanations thereof will be omitted. The first exemplary embodiment and the third exemplary embodiment may be combined with each other.

The “correction” includes change and deletion of original information, and addition of new information.

The term “part” refers to a part constituting a relationship diagram, corresponds to an element (also referred to as a box) and a relationship line (also referred to as a connection line) as described above, and corresponds to a node (node or vertex) and an edge (branch, side, or connector) in a graph theory. For example, when an item on an axis in a deployment table is corrected, an element in a relationship diagram corresponding to the corrected item is corrected, and then the corrected element is converted into a mode different from that of the uncorrected element. When a symbol or a numerical value arranged in a matrix form in a deployment table is corrected, a relationship line in a relationship diagram corresponding to the corrected symbol or the corrected numerical value is corrected, and then the corrected relationship line is converted into a mode different from that of the uncorrected relationship line.

A display module (a deployment table display module 4820 or a relationship diagram display module 4835) may take any of forms (1) a display module that includes a display device, and causes the display device to display a target (a relationship diagram or a deployment table), and (2) a display control module (a control module not including the display device itself) that performs a control to display a target on a display device.

An information processing apparatus 4800 includes a relationship diagram deployment table storage module 125, and a deployment table relationship diagram correction module 4805.

The relationship diagram deployment table storage module 125 includes a relationship diagram storage module 130, a deployment table storage module 135, and a relationship diagram deployment table association storage module 140, and is connected to the deployment table relationship diagram correction module 4805.

The deployment table relationship diagram correction module 4805 includes a deployment table operation receiving module 4810, a deployment table correction module 4815, the deployment table display module 4820, a relationship diagram operation receiving module 4825, a relationship diagram correction module 4830, and the relationship diagram display module 4835, and is connected to the relationship diagram deployment table storage module 125. The deployment table relationship diagram correction module 4805 performs a processing related to correction of a deployment table or a relationship diagram.

The deployment table operation receiving module 4810, the deployment table correction module 4815, and the deployment table display module 4820 perform a processing (e.g., creation, correction, or displaying) on a deployment table in which relationships between items listed on plural (particularly, three or more) axes perpendicular to each other are indicated by symbols or numerical values arranged in a matrix form.

The relationship diagram operation receiving module 4825, the relationship diagram correction module 4830, and the relationship diagram display module 4835 perform a processing (e.g., creation, correction, or displaying) on a relationship diagram (a tree diagram is typical) in which relationship lines connect elements to each other so as to express relationships.

The deployment table correction module 4815 and the relationship diagram correction module 4830 select an element in a relationship diagram corresponding to an axis in a deployment table so as to give a correspondence relationship to the two, and perform a processing such as mutual conversion between the relationship diagram and the deployment table. In the mutual conversion processing, the above described technique described in, for example, Patent Document 1 may be used. Techniques other than the technique described in, for example, Patent Document 1 will be mainly described below.

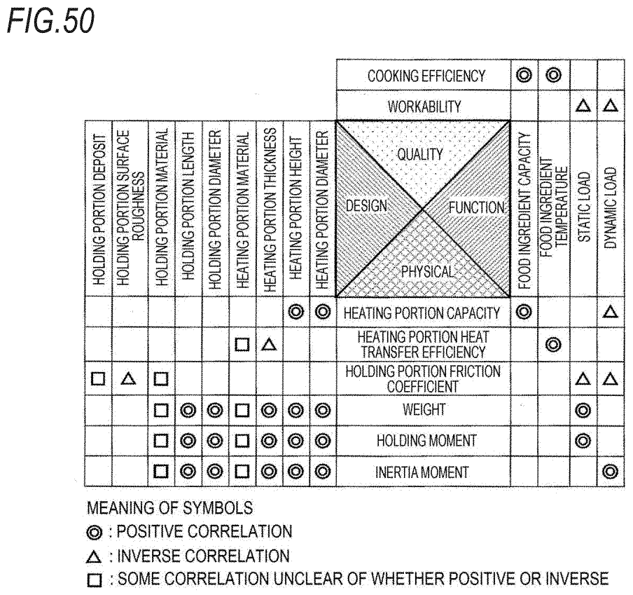

The deployment table operation receiving module 4810 is connected to the deployment table correction module 4815. The deployment table operation receiving module 4810 receives user's operation on a deployment table displayed by the deployment table display module 4820. For example, there is an operation of deleting a causal relationship in a deployment table. The “deleting a causal relationship in a deployment table” refers to deleting a mark in a cell of a matrix, the mark indicating a causal relationship in the deployment table (e.g., “⊚ (double circle),” “□ (square),” or “Δ (triangle)” in a deployment table described in FIG. 50 to be described below). These marks indicate causal relationships among items on axes. That is, in a cell present at a position where two items on adjacent axes intersect, a mark is drawn indicating a causal relationship between the two items (e.g., (1) positively correlated, (2) inversely correlated, or (3) related but it is unclear whether the correlation is positive or inverse). Namely, “Q” “A,” and “E” mean “positive correlation,” “inverse correlation,” and “some correlation unclear of whether positive or inverse,” respectively. The meaning of these symbols applies to FIGS. 50, 51, 53, and 55.

The deployment table correction module 4815 is connected to the deployment table operation receiving module 4810, the deployment table display module 4820, and the relationship diagram correction module 4830. The deployment table correction module 4815 corrects the deployment table according to the operation received by the deployment table operation receiving module 4810.

The deployment table display module 4820 is connected to the deployment table correction module 4815. The deployment table display module 4820 displays the deployment table corrected by the deployment table correction module 4815, on a display device such as a liquid crystal display.

The relationship diagram operation receiving module 4825 is connected to the relationship diagram correction module 4830. The relationship diagram operation receiving module 4825 receives user's operation on a relationship diagram displayed by the relationship diagram display module 4835.

The relationship diagram correction module 4830 is connected to the deployment table correction module 4815, the relationship diagram operation receiving module 4825, and the relationship diagram display module 4835. The relationship diagram correction module 4830 corrects the relationship diagram according to the operation received by the relationship diagram operation receiving module 4825.

The relationship diagram display module 4835 is connected to the relationship diagram correction module 4830. The relationship diagram display module 4835 displays the relationship diagram generated by the relationship diagram correction module 4830, on a display device such as a liquid crystal display.

When the operation received by the deployment table operation receiving module 4810 is an operation of deleting a causal relationship in the deployment table, the deployment table display module 4820 does not delete the causal relationship in the deployment table but displays the causal relationship in a manner distinguishable from others. Here, “not delete the causal relationship in the deployment table” means that deletion is not performed only by the fact that the deleting operation has been made. For example, after an operation of deleting a causal relationship in a deployment table is made, a confirmation in a relationship diagram corresponding to the deployment table (specifically, a confirmation as to whether a relationship line corresponding to the causal relationship as a deletion target is to be deleted) is demanded. Then, after it is determined that deletion in the deployment table is proper, the deletion may be performed.

The “distinguishable” indicates that a form of a mark indicating a causal relationship as a deletion target is made distinguishable from a form of a mark indicating a causal relationship as a non-deletion target, and includes a so-called highlight display. The form may include a color, a shape, or a pattern of a mark, a dynamic change (e.g., flash or animation), blinking (a changing target in blinking may include, for example, whether to perform the blinking, a blinking time period, or a blinking interval), addition of a character (including, for example, a figure or a symbol), or a combination thereof.

When the operation received by the deployment table operation receiving module 4810 is an operation of deleting a causal relationship in the deployment table, the relationship diagram display module 4835 does not delete a relationship line corresponding to the causal relationship, in the relationship diagram corresponding to the deployment table, but displays the relationship line in a manner distinguishable from others.

In a case where a working frequency in a deployment table is low mainly to examine a causal relationship in a relationship diagram, when the relationship diagram changes as a causal relationship is deleted in the deployment table, a confusion occurs. In this case, it is desirable not to delete a causal relationship in a deployment table, and to indicate which causal relationship on a relationship diagram may be deleted to perform such a change. After a causal relationship on the relationship diagram is edited, when a deletion work is completed, the following deletion work may be performed.

When the relationship diagram operation receiving module 4825 receives an operation of not deleting a relationship line displayed in a manner distinguishable from others in the relationship diagram, the relationship diagram display module 4835 returns a display of the relationship line to a display not distinguishable from others. That is, a user has determined that it is not proper to delete the relationship line in the relationship diagram (a relationship line corresponding to a causal relationship as a deletion target in the deployment table), and thus the relationship line is not to be deleted in the relationship diagram.

Then, only when the relationship diagram operation receiving module 4825 receives an operation of deleting a relationship line displayed in a manner distinguishable from others in the relationship diagram, the relationship diagram display module 4835 deletes the relationship line from the relationship diagram. That is, even when a causal relationship is set as a deletion target in the deployment table, as long as there is no confirmation in the relationship diagram, a relationship line corresponding to the causal relationship set as the deletion target is not deleted.

In a case where an operation received by the deployment table operation receiving module 4810 is an operation of deleting a causal relationship in the deployment table, when deletion of a relationship line corresponding to the causal relationship in the relationship diagram corresponding to the deployment table causes a change of another causal relationship in the deployment table, the relationship diagram correction module 4830 does not delete the relationship line.

Then, the relationship diagram display module 4835 displays a relationship line not to be deleted in a manner distinguishable from others.

When deletion of a relationship line corresponding to a causal relationship in the relationship diagram does not cause a change of another causal relationship in the deployment table, the relationship diagram correction module 4830 may delete the relationship line.

In a case where another causal relationship on the deployment table is changed no matter which one of relationship lines defined as deletion targets is deleted, the relationship diagram display module 4835 may give notification that deletion is not allowed.

In a case where a working frequency on a relationship diagram is low mainly to examine a causal relationship in a deployment table, it is necessary to delete a causal relationship without working on the relationship diagram. However, from the deployment table, it is not possible to determine whether there is a causal relationship associated with elements not set on axes in the deployment table, on the relationship diagram. Thus, when it is not intended to delete the causal relationship of the relationship diagram, inconsistency occurs between the relationship diagram and the deployment table. When all relationship lines on the relationship diagram, which constitute the causal relationship to be deleted, are deleted, there is a possibility that another causal relationship of the deployment table is unintentionally affected. According to the third exemplary embodiment, it is possible to delete a causal relationship on the deployment table in a state where consistency is maintained between the relationship diagram and the deployment table.

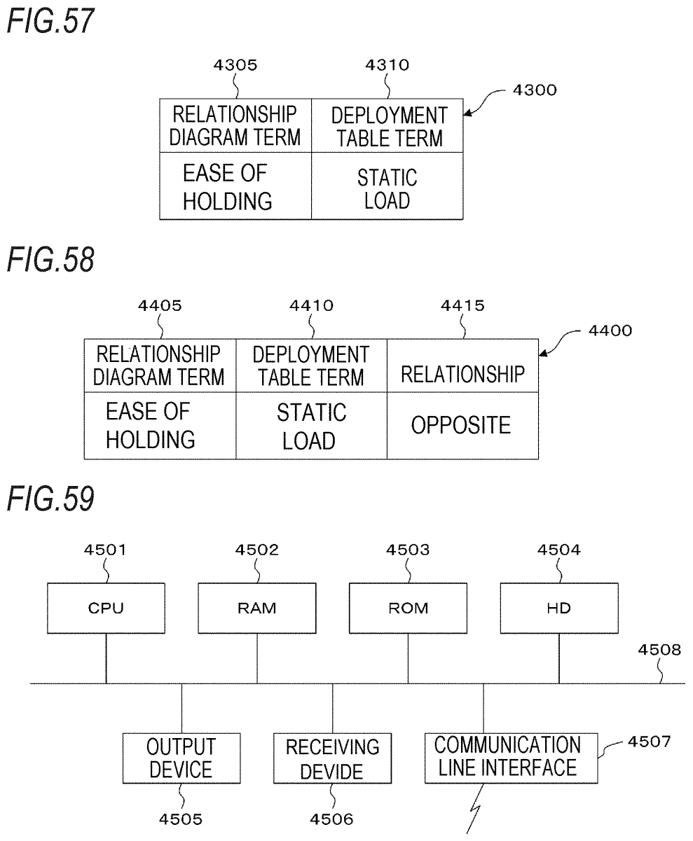

The deployment table correction module 4815 or the relationship diagram correction module 4830 includes a storage unit (corresponding to a relationship diagram term deployment table term correspondence table 4300 illustrated in the example of FIG. 57 to be described later) that stores a first term used in a relationship diagram and a second term used in a deployment table in association with each other. When converting a relationship diagram into a deployment table or a deployment table into a relationship diagram, the deployment table correction module 4815 or the relationship diagram correction module 4830 may convert a first term or a second term into a second term or a first term by using the storage unit. As for the “term,” there is mainly an element name. Otherwise, a term used in the comment (annotation) may be included. For example, as a first term, there is a “temperature of food ingredients at the heating time” (an element name used in a relationship diagram), and as a corresponding second term, there is a “food ingredient temperature” (an element name used in a deployment table).

Information indicating that a first term and a second term are opposite in the increase or decrease may be set in the storage unit in the deployment table correction module 4815 or the relationship diagram correction module 4830.

Then, when information indicating that a first term and a second term are opposite in the increase or decrease is set in the storage unit, the deployment table correction module 4815 or the relationship diagram correction module 4830 may perform a conversion into a deployment table or a relationship diagram as a conversion destination such that an increase/decrease is inversely related to that in a relationship diagram or a deployment table as a conversion source. Specifically, converting into a deployment table as a conversion destination is made such that an increase/decrease is inversely related to that in a relationship diagram, or converting into a relationship diagram as a conversion destination is made such that an increase/decrease is inversely related to that in a deployment table.

For example, in a case where a term “softness of board” is used in a relationship diagram, and a term “rigidity” is used in a deployment table, in the correspondence between these two terms, “information indicating that increase or decrease is reversed” is set in a storage unit (corresponding to a relationship field 4415 of a relationship diagram term deployment table term correspondence table 4400 illustrated in the example of FIG. 58 to be described later). When a relationship diagram is converted into a deployment table, a relationship opposite to the increase/decrease relationship with respect to a relationship line in the relationship diagram is set in the deployment table. On the other hand, when a deployment table is converted into a relationship diagram, a relationship opposite to the increase/decrease relationship in the deployment table is expressed by a relationship line in the relationship diagram.

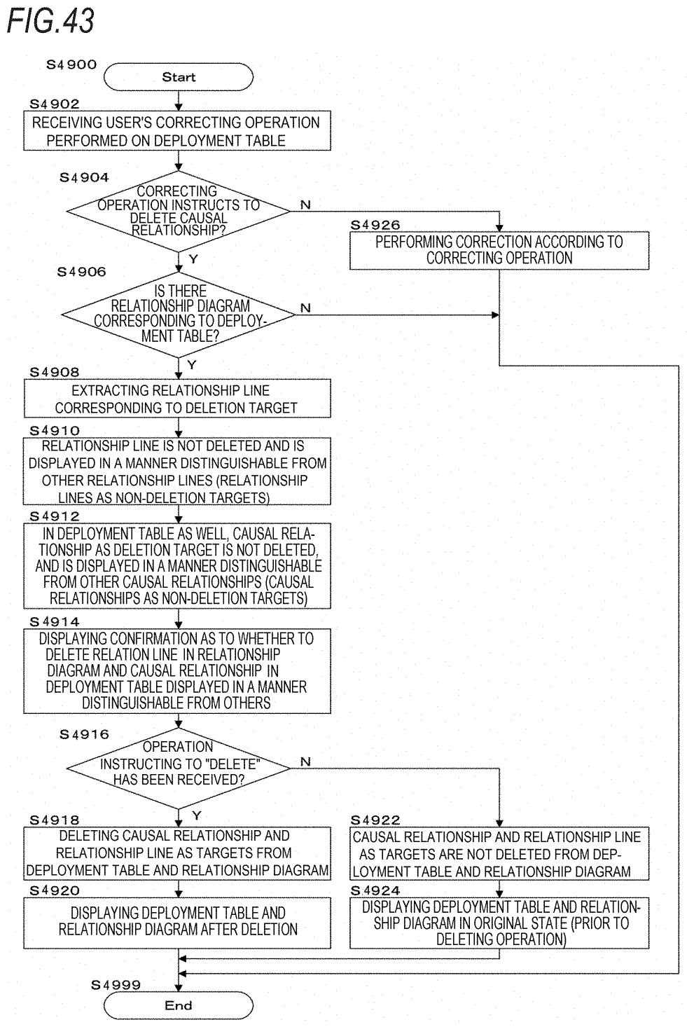

FIG. 43 is a flowchart illustrating an example of a processing according to the third exemplary embodiment. This mainly illustrates an example of a processing on a display of a causal relationship as a deletion target, and a relationship line corresponding to the causal relationship.

In step S4902, the deployment table operation receiving module 4810 receives a correcting user's operation, which has been performed on a deployment table.

In step S4904, the deployment table correction module 4815 determines whether or not the correcting operation instructs to delete a causal relationship. When it is determined that the operation instructs to delete a causal relationship, the process proceeds to step S4906.

Otherwise, the process proceeds to step S4926.

In step S4906, the relationship diagram correction module 4830 determines whether there is a relationship diagram corresponding to the deployment table. When it is determined that there is a relationship diagram, the process proceeds to step S4908. Otherwise, the process ends (step S4999).

In step S4908, the relationship diagram correction module 4830 extracts a relationship line corresponding to the deletion target.

In step S4910, the relationship diagram display module 4835 does not delete the relationship line, and displays the relationship line in a manner distinguishable from other relationship lines (relationship lines as non-deletion targets).

In step S4912, in the deployment table as well, the deployment table display module 4820 does not delete the causal relationship as the deletion target, and displays the causal relationship in a manner distinguishable from other causal relationships (causal relationships as non-deletion targets).

In step S4914, the deployment table display module 4820 or the relationship diagram display module 4835 displays a confirmation as to whether to delete the relationship line in the relationship diagram and the causal relationship in the deployment table, which are displayed in a manner distinguishable from others.

In step S4916, the deployment table display module 4820 or the relationship diagram display module 4835 determines whether an operation “delete” has been received. When it is determined that an operation “delete” has been received, the process proceeds to step S4918. Otherwise, the process proceeds to step S4922.

In step S4918, the deployment table correction module 4815 and the relationship diagram correction module 4830 delete the causal relationship and the relationship line as the targets from the deployment table and the relationship diagram.

In step S4920, the deployment table display module 4820 and the relationship diagram display module 4835 display the deployment table and the relationship diagram after the deletion.

In step S4922, the deployment table correction module 4815 and the relationship diagram correction module 4830 do not delete the causal relationship and the relationship line as the targets from the deployment table and the relationship diagram.

In step S4924, the deployment table display module 4820 and the relationship diagram display module 4835 display the deployment table and the relationship diagram in an original state (prior to the deletion operation).

In step S4926, the deployment table correction module 4815 performs a correction according to the correcting operation.

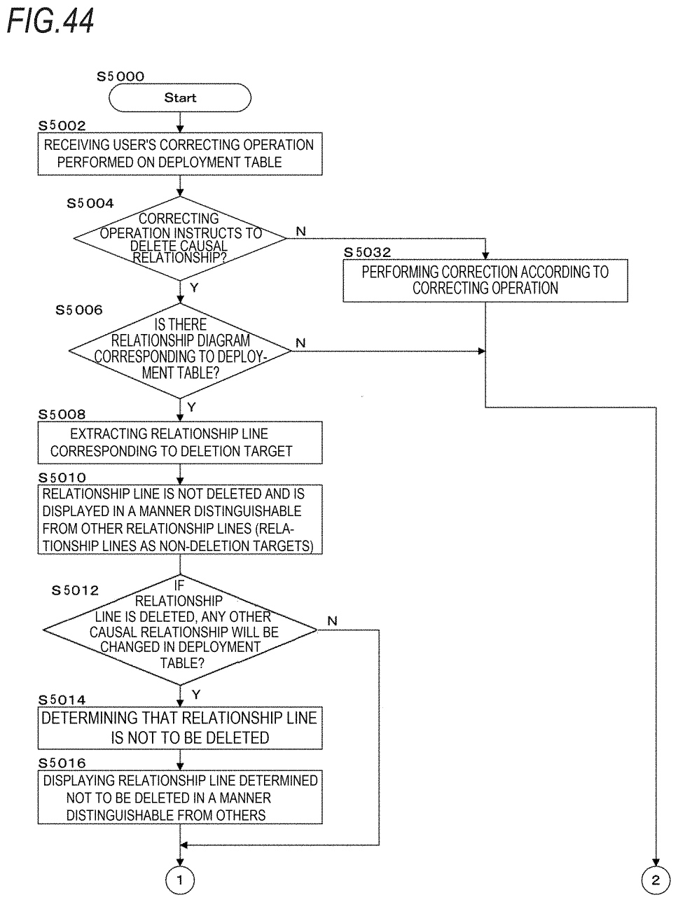

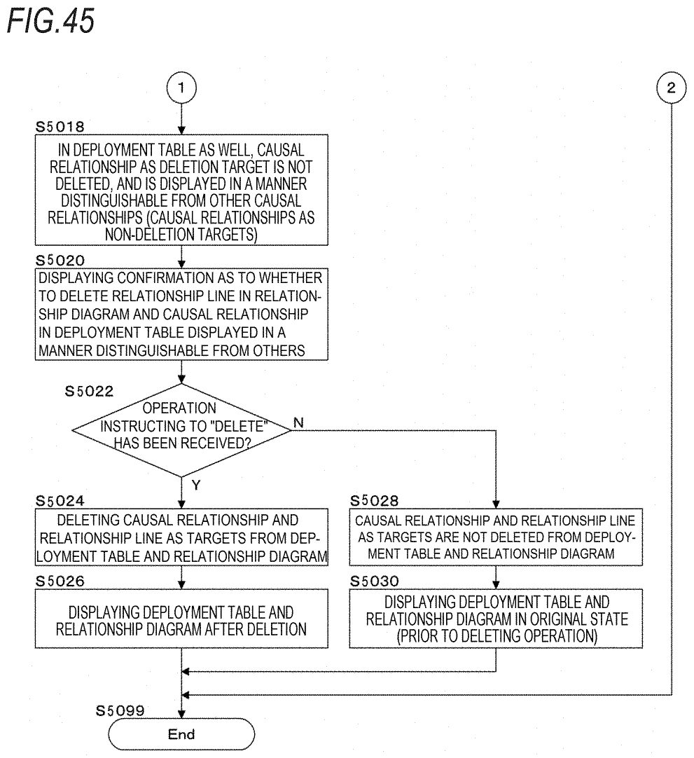

FIGS. 44 and 45 are flowcharts illustrating an example of a processing according to the third exemplary embodiment. This mainly illustrates an example of a processing (1) in a case where when a relationship line corresponding to a causal relationship as a deletion target is deleted, the causal relationship in a deployment table is also changed accordingly.

In step S5002, the deployment table operation receiving module 4810 receives a correcting user's operation, which has been performed on a deployment table.

In step S5004, the deployment table correction module 4815 determines whether or not the correcting operation instructs to delete a causal relationship. When it is determined that the operation instructs to delete a causal relationship, the process proceeds to step S5006. Otherwise, the process proceeds to step S5032.

In step S5006, the relationship diagram correction module 4830 determines whether there is a relationship diagram corresponding to the deployment table. When it is determined that there is a relationship diagram, the process proceeds to step S5008. Otherwise, the process ends (step S5099).

In step S5008, the relationship diagram correction module 4830 extracts a relationship line corresponding to the deletion target.

In step S5010, the relationship diagram display module 4835 does not delete the relationship line, and displays the relationship line in a manner distinguishable from other relationship lines (relationship lines as non-deletion targets).

In step S5012, the relationship diagram correction module 4830 determines whether another causal relationship in the deployment table is changed when the relationship line is deleted. When it is determined that another causal relationship is changed, the process proceeds to step S5014. Otherwise, the process proceeds to step S5018.

In step S5014, the relationship diagram correction module 4830 determines that the relationship line is not to be deleted.

In step S5016, the relationship diagram display module 4835 displays the relationship line determined not to be deleted, in a manner distinguishable from others. Here, “others” may include relationship lines which are not set as deletion targets, and/or relationship lines which are deletion targets but are not determined not to be deleted.

In step S5018, in the deployment table as well, the deployment table display module 4820 does not delete the causal relationship as the deletion target, and displays the causal relationship in a manner distinguishable from other causal relationships (causal relationships as non-deletion targets).

In step S5020, the deployment table display module 4820 or the relationship diagram display module 4835 displays a confirmation as to whether to delete the relationship line in the relationship diagram and the causal relationship in the deployment table, which are displayed in a manner distinguishable from others.

In step S5022, the deployment table display module 4820 or the relationship diagram display module 4835 determines whether an operation “delete” has been received. When it is determined that an operation has been received, the process proceeds to step S5024. Otherwise, the process proceeds to step S5028.

In step S5024, the deployment table correction module 4815 and the relationship diagram correction module 4830 delete the causal relationship and the relationship line as the targets from the deployment table and the relationship diagram.

In step S5026, the deployment table display module 4820 and the relationship diagram display module 4835 display the deployment table and the relationship diagram after the deletion.

In step S5028, the deployment table correction module 4815 and the relationship diagram correction module 4830 do not delete the causal relationship and the relationship line as the targets from the deployment table and the relationship diagram.

In step S5030, the deployment table display module 4820 and the relationship diagram display module 4835 display the deployment table and the relationship diagram in an original state (prior to the deletion operation).

In step S5032, the deployment table correction module 4815 performs a correction according to the correcting operation.

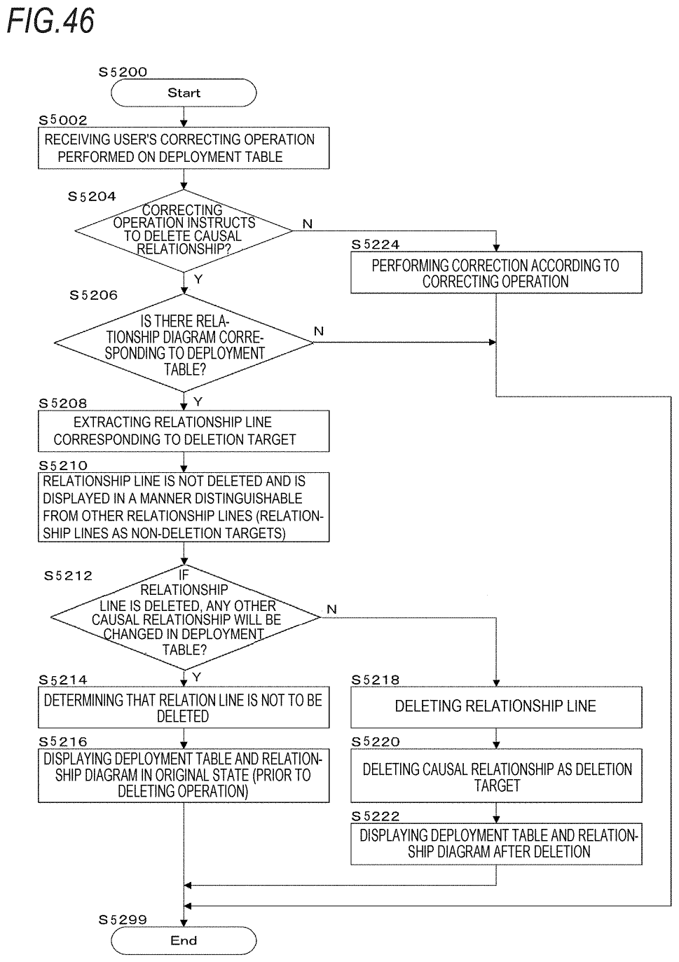

FIG. 46 is a flowchart illustrating an example of a processing according to the third exemplary embodiment. This mainly illustrates an example of a processing (2) in a case where when a relationship line corresponding to a causal relationship as a deletion target is deleted, the causal relationship in a deployment table is also changed accordingly.

In step S5202, the deployment table operation receiving module 4810 receives a correcting user's operation, which has been performed on a deployment table.

In step S5204, the deployment table correction module 4815 determines whether or not the correcting operation instructs to delete a causal relationship. When it is determined that the operation instructs to delete a causal relationship, the process proceeds to step S5206. Otherwise, the process proceeds to step S5224.

In step S5206, the relationship diagram correction module 4830 determines whether there is a relationship diagram corresponding to the deployment table. When it is determined that there is a relationship diagram, the process proceeds to step S5208. Otherwise, the process ends (step S5299).

In step S5208, the relationship diagram correction module 4830 extracts a relationship line corresponding to the deletion target.

In step S5210, the relationship diagram display module 4835 does not delete the relationship line, and displays the relationship line in a manner distinguishable from other relationship lines (relationship lines as non-deletion targets).

In step S5212, the relationship diagram correction module 4830 determines whether another causal relationship in the deployment table is changed when the relationship line is deleted. When it is determined that another causal relationship is changed, the process proceeds to step S5214. Otherwise, the process proceeds to step S5218.

In step S5214, the relationship diagram correction module 4830 determines that the relationship line is not to be deleted.

In step S5216, the deployment table display module 4820 and the relationship diagram display module 4835 display the deployment table and the relationship diagram in an original state (prior to the deletion operation).

In step S5218, the relationship diagram correction module 4830 deletes the relationship line.

In step S5220, the deployment table correction module 4815 deletes the causal relationship as the deletion target.

In step S5222, the deployment table display module 4820 and the relationship diagram display module 4835 display the deployment table and the relationship diagram after deletion.

In step S5224, the deployment table correction module 4815 performs a correction according to the correcting operation.

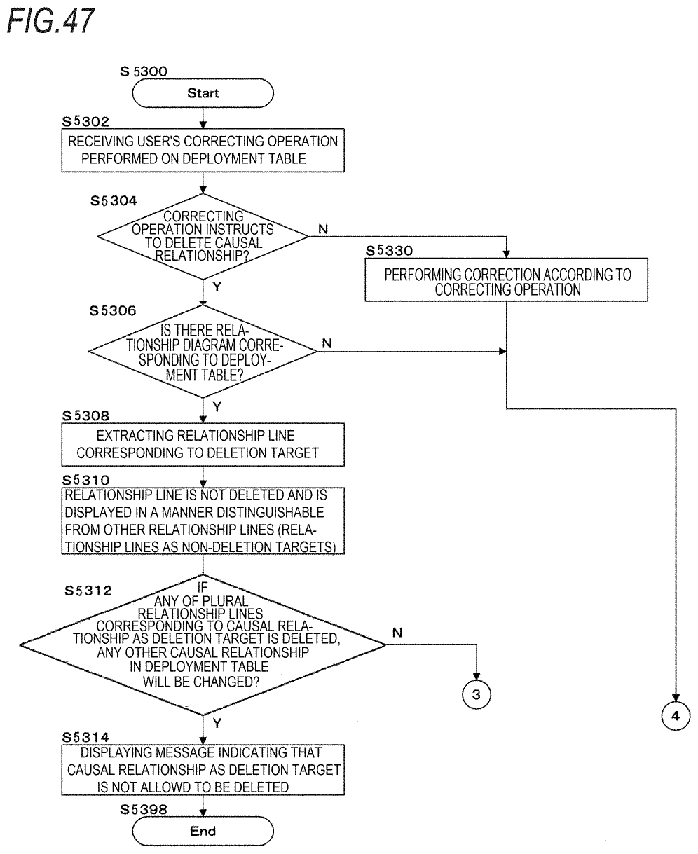

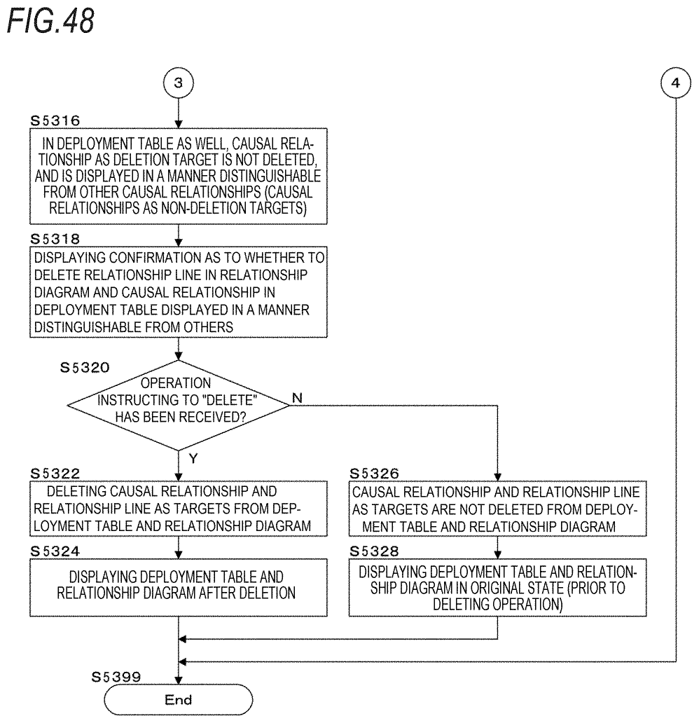

FIGS. 47 and 48 are flowcharts illustrating an example of a processing according to the third exemplary embodiment. This mainly illustrates an example of a processing in a case where there are plural relationship lines corresponding to a causal relationship as a deletion target.

In step S5302, the deployment table operation receiving module 4810 receives a correcting user's operation, which has been performed on a deployment table.

In step S5304, the deployment table correction module 4815 determines whether or not the correcting operation instructs to delete a causal relationship. When it is determined that the operation instructs to delete a causal relationship, the process proceeds to step S5306. Otherwise, the process proceeds to step S5330.

In step S5306, the relationship diagram correction module 4830 determines whether there is a relationship diagram corresponding to the deployment table. When it is determined that there is a relationship diagram, the process proceeds to step S5308. Otherwise, the process ends (step S5399).

In step S5308, the relationship diagram correction module 4830 extracts a relationship line corresponding to the deletion target.

In step S5310, the relationship diagram display module 4835 does not delete the relationship line, and displays the relationship line in a manner distinguishable from other relationship lines (relationship lines as non-deletion targets).

In step S5312, the relationship diagram correction module 4830 determines whether there are plural relationship lines corresponding to the causal relationship as the deletion target, and another causal relationship in the deployment table is changed no matter which one of relationship lines is deleted. When it is determined that another causal relationship is changed, the process proceeds to step S5314. Otherwise, the process proceeds to step S5316.

In step S5314, the deployment table display module 4820 displays a message that the causal relationship as the deletion target is not allowed to be deleted.

In step S5316, in the deployment table as well, the deployment table display module 4820 does not delete the causal relationship as the deletion target, and displays the causal relationship in a manner distinguishable from other causal relationships (causal relationships as non-deletion targets).

In step S5318, the deployment table display module 4820 or the relationship diagram display module 4835 displays a confirmation as to whether to delete the relationship line in the relationship diagram and the causal relationship in the deployment table, which are displayed in a manner distinguishable from others.

In step S5320, the deployment table display module 4820 or the relationship diagram display module 4835 determines whether an operation “delete” has been received. When it is determined that an operation “delete” has been received, the process proceeds to step S5322. Otherwise, the process proceeds to step S5326.

In step S5322, the deployment table correction module 4815 and the relationship diagram correction module 4830 delete the causal relationship and the relationship line as the targets from the deployment table and the relationship diagram.

In step S5324, the deployment table display module 4820 and the relationship diagram display module 4835 display the deployment table and the relationship diagram after the deletion.

In step S5326, the deployment table correction module 4815 and the relationship diagram correction module 4830 do not delete the causal relationship and the relationship line as the targets from the deployment table and the relationship diagram.

In step S5328, the deployment table display module 4820 and the relationship diagram display module 4835 display the deployment table and the relationship diagram in an original state (prior to the deletion operation).

In step S5330, the deployment table correction module 4815 performs a correction according to the correcting operation.

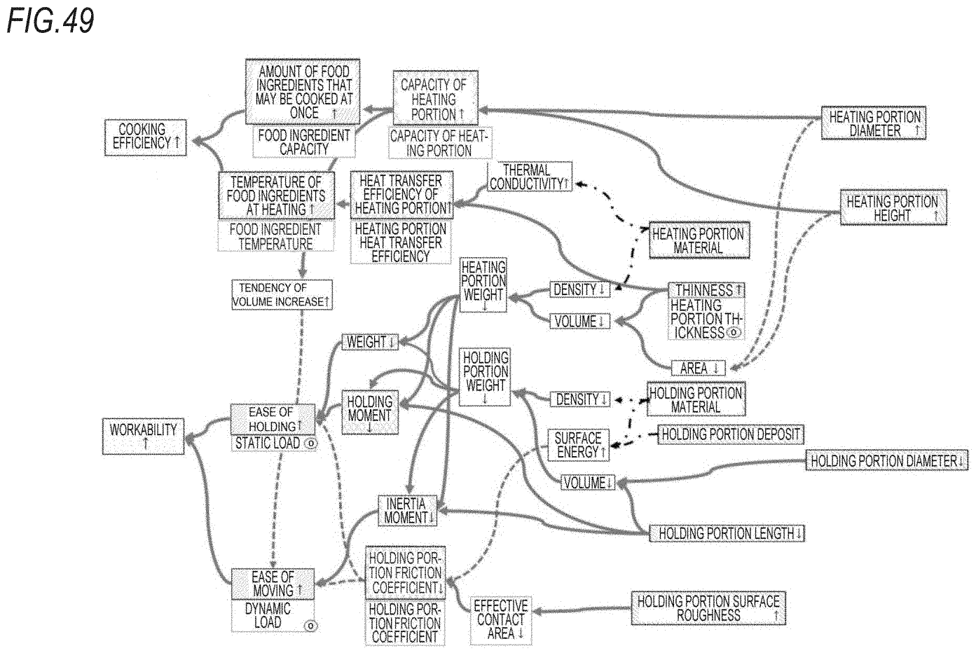

FIG. 49 is an explanatory view illustrating an example of a relationship diagram.

A workability (↑) and a cooking efficiency (↑) are selected for a first axis (quality) in a deployment table, an amount of food ingredients that may be cooked at once (↑), a temperature of food ingredients at the heating time (↑), an ease of having (↑), and an ease of moving (↑) are selected for a second axis (function) in a deployment table, a capacity of heating portion (↑), a heat transfer efficiency of heating portion (↑), a holding portion friction coefficient (↓), a weight (↓), a holding moment (↓), and an inertia moment (↓) are selected for a third axis (physical) in the deployment table, and a heating portion diameter (↑), a heating portion height (↑), a thinness (↑), a heating portion material, a holding portion diameter (↓), a holding portion length (↓), a holding portion surface roughness (↑), a holding portion material, and a holding portion deposit are selected for a fourth axis(design) in the deployment table.

Then, elements (the workability (↑) and the cooking efficiency (↑)) on the first axis are displayed, for example, in orange. Elements (the amount of food ingredients that may be cooked at once (↑), the temperature of food ingredients at the heating time (↑), the ease of having (↑) and the ease of moving (↑)) on the second axis are displayed, for example, in yellow. Elements (the capacity of heating portion (↑), the heat transfer efficiency of heating portion (↑), the holding portion friction coefficient (↓), the weight (↓), the holding moment (↓), and the inertia moment (↓)) on the third axis are displayed, for example, in blue. Elements (the heating portion diameter (↑), the heating portion height (↑), the thinness (↑), the heating portion material, the holding portion diameter (↓), the holding portion length (↓), the holding portion material, the holding portion surface roughness (↑), and the holding portion deposit) on the fourth axis are displayed, for example, in green.

The solid relationship lines indicate a relationship in which the tendency of occurrence of one element is similar to the tendency of occurrence of the other element. The dotted relationship lines indicate an opposite relationship. This relationship means that when one element occurs, an element opposite to the other element occurs. The one dot chain relationship lines indicate that there is no specifiable relationship between the tendencies of occurrence of elements.

The “tendencies of occurrence of elements are coincident” is not necessarily limited to coincidence of elements in increase/decrease. For example, a required time decreases as a moving speed to a destination increases, and thus, the tendencies of occurrence of elements “an increase in speed” and “a decrease in time” are coincident. However, an increase or decrease in “speed” is opposite to an increase or decrease in “time.”

FIG. 50 is an explanatory view illustrating an example of a deployment table. This is a deployment table corresponding to the relationship diagram illustrated in the example of FIG. 49.

The deployment table illustrated in the example of FIG. 50 includes a workability and a cooking efficiency on the first axis (quality), and a food ingredient capacity, a food ingredient temperature, a static load, and a dynamic load on the second axis (function). The deployment table includes a heating portion capacity, a heating portion heat transfer efficiency, a holding portion friction coefficient, a weight, a holding moment, and an inertia moment on the third axis (physical). The deployment table includes a heating portion diameter, a heating portion height, a heating portion thickness, a heating portion material, a holding portion diameter, a holding portion length, a holding portion material, a holding portion surface roughness, and a holding portion deposit on the fourth axis (design).

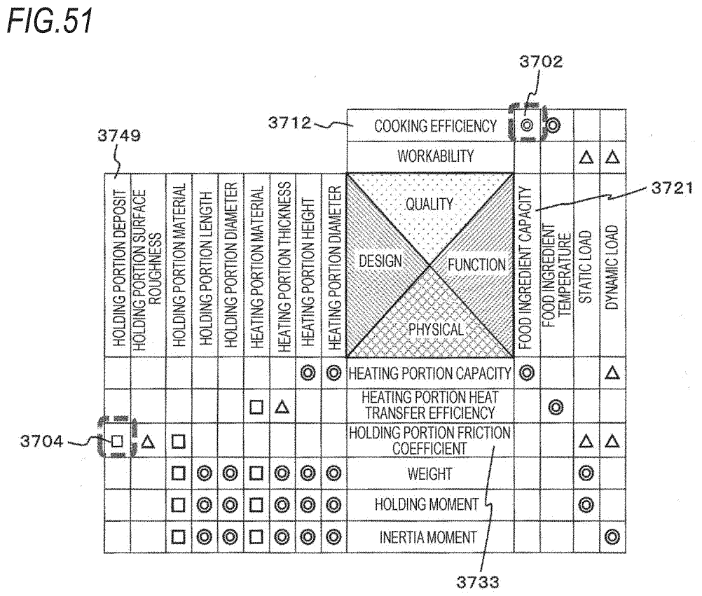

FIG. 51 is an explanatory view illustrating an example of a deleting operation on a deployment table.

This illustrates an example in which a causal relationship 3702 and a causal relationship 3704 are set as deletion targets by user's operation on the deployment table illustrated in the example of FIG. 50.

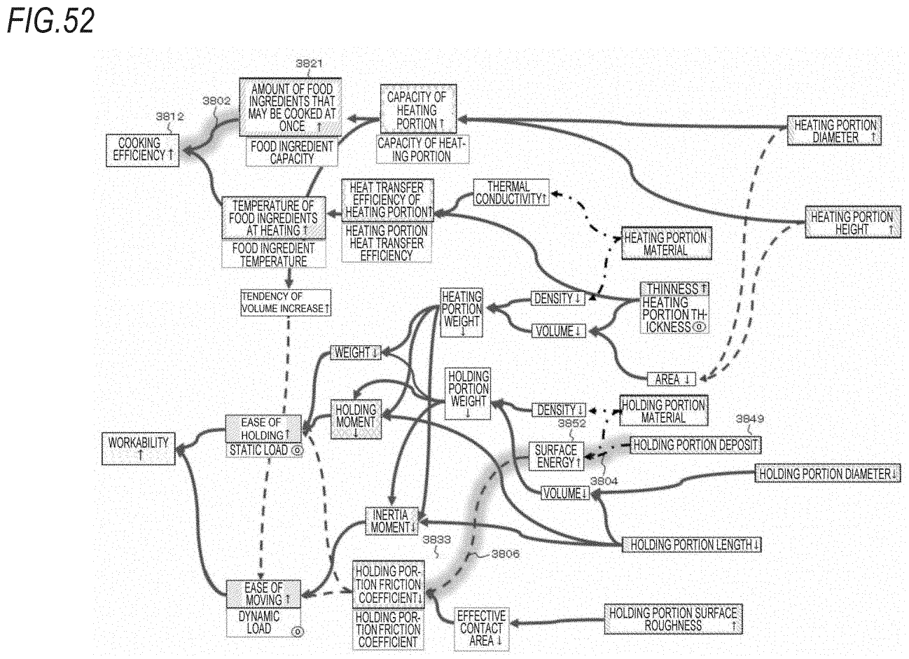

In this manner, even when a deleting operation is performed by a user, deletion from the deployment table is not immediately performed. As illustrated in the example of FIG. 51, display is performed in such a manner that the causal relationship 3702 and the causal relationship 3704 are surrounded by red thick dotted line frames. Then, as in a relationship diagram illustrated in the example of FIG. 52, relationship lines corresponding to the causal relationship 3702 and the causal relationship 3704 are displayed in a manner distinguishable from others, and a confirmation on a deletion target on the relationship diagram is made.

The causal relationship 3702 indicates that there is a causal relationship between a cooking efficiency 3712 and a food ingredient capacity 3721. The causal relationship 3704 indicates that there is a causal relationship between a holding portion friction coefficient 3733 and a holding portion deposit 3749.

FIG. 52 is an explanatory view illustrating an example of a relationship diagram. In the relationship diagram illustrated in the example of FIG. 52, a confirmation on a relationship line as a deletion target on the relationship diagram is made according to the deleting operation on the deployment table illustrated in the example of FIG. 51.

A cooking efficiency (↑) 3812 corresponds to the cooking efficiency 3712 of the deployment table illustrated in the example of FIG. 51. An amount of food ingredients that may be cooked at once (↑) 3821 corresponds to the food ingredient capacity 3721 of the deployment table illustrated in the example of FIG. 51. Accordingly, a relationship line 3802 corresponds to the causal relationship 3702 of the deployment table illustrated in the example of FIG. 51.

A holding portion friction coefficient (↓) 3833 corresponds to the holding portion friction coefficient 3733 of the deployment table illustrated in the example of FIG. 51. A holding portion deposit 3849 corresponds to a holding portion deposit 3749 of the deployment table illustrated in the example of FIG. 51. Then, a surface energy (↑) 3852 is present between the holding portion deposit 3849 and the holding portion friction coefficient (↓) 3833, and is connected. Therefore, a relationship line 3804 and a relationship line 3806 correspond to the causal relationship 3704 of the deployment table illustrated in the example of FIG. 51. As indicated in the above description, as compared in the deployment table, in the relationship diagram, a more detailed examination has been performed, and the holding portion deposit 3849 is related to the holding portion friction coefficient (↓) 3833. Also, the holding portion deposit 3849 is related to the holding portion friction coefficient (↓) 3833 via the surface energy (↑) 3852. Meanwhile, in the deployment table, the surface energy (↑) 3852 is omitted because important factors (the holding portion deposit 3849, and the holding portion friction coefficient (↓) 3833) are extracted to improve a listing property.

In displaying the relationship diagram, the relationship diagram display module 4835 performs a display indicating that the relationship line 3802 corresponding to the causal relationship 3702 set as the deletion target in the deployment table, and the relationship line 3804 and the relationship line 3806 corresponding to the causal relationship 3704 set as the deletion target in the deployment table are set as deletion targets. For example, causing the relationship line 3802, the relationship line 3804, and the relationship line 3806 themselves or surroundings thereof to shine in red is performed.

In causing something to shine in red, the background may be colored in the corresponding color or may blink in the corresponding color, or another form may be made different (a rectangle surrounding an element, e.g., a general rectangle, a double-frame rectangle, or an edge-rounded rectangle). That is, the relationship line corresponding to the causal relationship as the deletion target in the deployment table only has to be displayed in a manner distinguishable from other relationship lines (relationship lines corresponding to causal relationships not set as the deletion target in the deployment table).

Thereafter, when the relationship line 3802, the relationship line 3804, and the relationship line 3806 set as the deletion targets are deleted by user's operation, causal relationships set as the deletion targets in the deployment table are also deleted. That is, even when a deleting operation on causal relationships is performed in the deployment table, unless a confirmation in the relationship diagram corresponding to the deployment table (deletion of relationship lines corresponding to the causal relationships) is performed, deletion in the deployment table is not reflected.

Deletion of at least one of the relationship line 3804 and the relationship line 3806 corresponds to deletion of the causal relationship 3704 in the deployment table. Deletion of either or both of the relationship line 3804 or/and the relationship line 3806 is determined by a user. Of course, when nothing is deleted, the causal relationship 3704 in the deployment table is also not deleted.

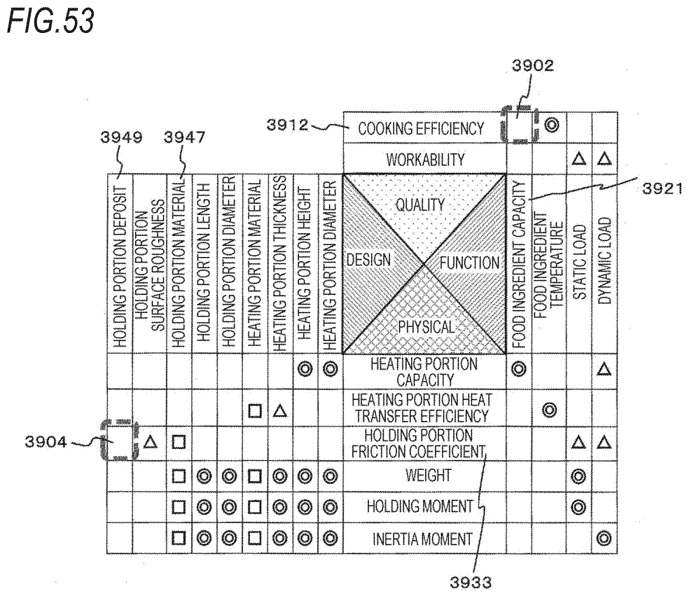

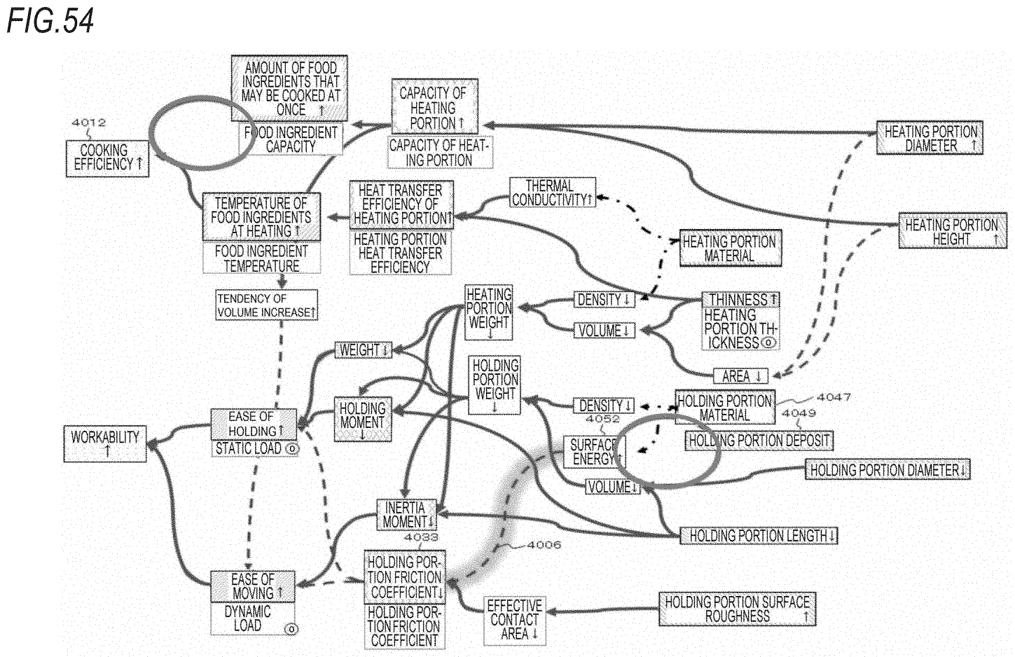

Another example will be described by using an example of FIGS. 53 and 54.

In a relationship diagram corresponding to a deployment table, in a case where when a relationship line corresponding to a causal relationship as a deletion target is deleted, another causal relationship in the deployment table is changed, the relationship line is not allowed to be deleted. Then, in a case where even when a relationship line in the relationship diagram corresponding to a causal relationship in the deployment table is deleted, another causal relationship in the deployment table is not changed, the relationship line is allowed to be deleted.

FIG. 53 is an explanatory view illustrating an example of a deployment table. The deployment table illustrated in the example of FIG. 53 is equivalent to the deployment table illustrated in the example of FIG. 50. This example indicates an example in which a causal relationship 3902 to be deleted and a causal relationship 3904 to be deleted are set as deletion targets by user's operation.

Then, in the example of FIG. 53, a mark in the deletion target causal relationship 3902, which indicated a causal relationship between a cooking efficiency 3912 and a food ingredient capacity 3921, is deleted, and a mark in the deletion target causal relationship 3904, which indicated a causal relationship between a holding portion friction coefficient 3933 and a holding portion deposit 3949, is also deleted.

FIG. 54 is an explanatory view illustrating an example of a relationship diagram.

In accordance with the deletion target causal relationship 3902, a connection between a cooking efficiency (↑) 4012 and an amount of food ingredients that may be cooked at once (↑) 4021 (the relationship line 3802 illustrated in the example of FIG. 52) is deleted. This is surrounded by an ellipse in the example of FIG. 54.

In accordance with the deletion target causal relationship 3904, a connection between a holding portion deposit 4049 and a surface energy (↑) 4052 (the relationship line 3804 illustrated in the example of FIG. 52) is deleted. This is surrounded by an ellipse in the example of FIG. 54.

A relationship line 4006 between the surface energy (↑) 4052 and a holding portion friction coefficient (↓) 4033 is not deleted, and is displayed in a manner distinguishable from others. This is because when the relationship line 4006 is deleted, a relationship between a holding portion material 4047 and the holding portion friction coefficient (↓) 4033 (in the deployment table illustrated in the example of FIG. 53, a causal relationship between a holding portion material 3947 and the holding portion friction coefficient 3933) is also lost. That is, this corresponds to an example of the above described “case where when a relationship line corresponding to a causal relationship as a deletion target is deleted, another causal relationship in the deployment table is changed.”

The relationship line 4006 is displayed in a manner distinguishable from others, but may be displayed in a manner indistinguishable from others. That is, when the causal relationship 3904 is set as a deletion target in the deployment table illustrated in the example of FIG. 53, the relationship line 4006 may not be set as a deletion target.

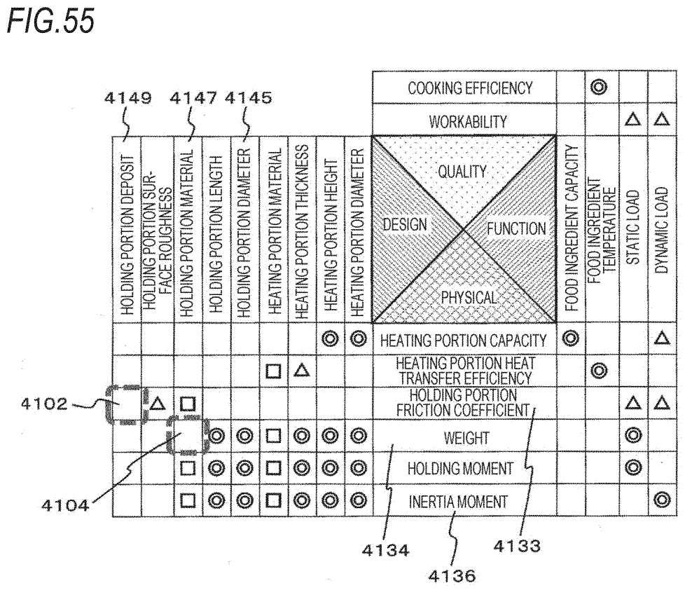

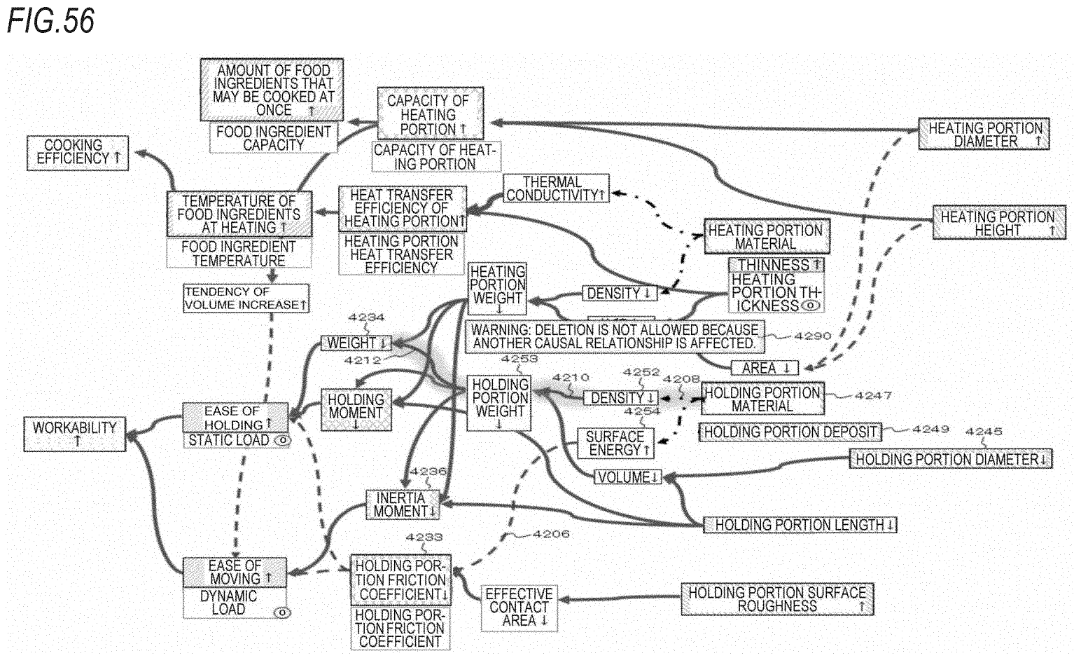

Another example will be described by using an example of FIGS. 55 and 56.

In a case where another causal relationship on a deployment table is changed no matter which one of relationship lines as deletion targets is deleted, a notification is made indicating that deletion is not allowed.

FIG. 55 is an explanatory view illustrating an example of a deployment table. The deployment table illustrated in the example of FIG. 55 is equivalent to the deployment table illustrated in the example of FIG. 50. This example indicates an example in which a causal relationship 4102 to be deleted and a causal relationship 4104 to be deleted are set as deletion targets by user's operation.

Then, in the example of FIG. 55, a mark in the deletion target causal relationship 4102, which indicated a causal relationship between a holding portion friction coefficient 4133 and a holding portion deposit 4149, is deleted, and a mark in the deletion target causal relationship 4104, which indicated a causal relationship between a weight 4134 and a holding portion material 4147, is also deleted.

FIG. 56 is an explanatory view illustrating an example of a relationship diagram.

In accordance with the deletion target causal relationship 4102, a relationship line between a holding portion deposit 4249 and a surface energy (↑) 4254 is deleted. As a relationship line corresponding to the deletion target causal relationship 4102, there is also a relationship line 4206 (connecting the surface energy (↑) 4254 to a holding portion friction coefficient (↓) 4233). However, when this relationship line is deleted, a relationship between a holding portion material 4247 and the holding portion friction coefficient (↓) 4233 is also deleted. Thus, the relationship line 4206 is not deleted.

Thereafter, in accordance with the deletion target causal relationship 4104, there are three relationship lines, that is, a relationship line 4208 (connecting the holding portion material 4247 to a density (↓) 4252), a relationship line 4210 (connecting the density (↓) 4252 to a holding portion weight (↓) 4253), and a relationship line 4212 (connecting the holding portion weight (↓) 4253 to a weight (↓) 4234). Meanwhile, since another causal relationship is affected no matter which one is deleted, a warning display area 4290 is displayed in a state where these three shine in red. In the warning display area 4290, for example, “warning: deletion is not allowed because another causal relationship is affected.” is displayed. This is because when the relationship line 4208 or the relationship line 4210 is deleted, a relationship between the holding portion material 4247 and an inertia moment (↓) 4236 (a causal relationship between the holding portion material 4147 and an inertia moment 4136 illustrated in the example of FIG. 55) is also deleted. Also, this is because when the relationship line 4212 is deleted, a relationship between a holding portion diameter (↓) 4245 and the weight (↓) 4234 (a causal relationship between a holding portion diameter 4145 and the weight 4134 illustrated in the example of FIG. 55) is also deleted.

The deployment table correction module 4815 or the relationship diagram correction module 4830 may include the relationship diagram term deployment table term correspondence table 4300. FIG. 57 is an explanatory view illustrating an example of a data structure of the relationship diagram term deployment table term correspondence table 4300. The relationship diagram term deployment table term correspondence table 4300 includes a relationship diagram term field 4305 and a deployment table term field 4310. The relationship diagram term field 4305 stores a relationship diagram term. The deployment table term field 4310 stores an deployment table term.

For example, it is described that a deployment table term corresponding to a relationship diagram term “ease of having” is “static load.”

The deployment table correction module 4815 or the relationship diagram correction module 4830 may include the relationship diagram term deployment table term correspondence table 4400. FIG. 58 is an explanatory view illustrating an example of a data structure of the relationship diagram term deployment table term correspondence table 4400. The relationship diagram term deployment table term correspondence table 4400 includes a relationship diagram term field 4405, a deployment table term field 4410, and the relationship field 4415. The relationship diagram term field 4405 stores a relationship diagram term. The deployment table term field 4410 stores a deployment table term. The relationship field 4415 stores a relationship.

For example, it is described that a deployment table term corresponding to a relationship diagram term “ease of having” is “static load,” and the relationship is “reversed.”

An example of a hardware configuration of a computer by which a program is executed as the above exemplary embodiment is illustrated in FIG. 59. The hardware includes a general computer, which may be specifically a personal computer or a server. Specifically, a processor (arithmetic unit) includes a CPU 4501, and a storage device includes a RAM 4502, a ROM 4503, and a HD 4504. The HD 4504 may include, for example, a hard disk or a solid state drive (SSD). The hardware includes the CPU 4501 that executes programs such as the relationship diagram deployment table creation module 105, the relationship diagram creation module 110, the deployment table generation module 115, the output module 120, the editing module 145, the deployment table operation receiving module 150, the association information extraction module 155, the display module 160, the relationship diagram editing module 165, the deployment table correcting operation receiving module 2810, the deployment table correction module 2815, the deployment table display module 2820, the relationship diagram correcting operation receiving module 2825, the relationship diagram correction module 2830, the relationship diagram display module 2835, the deployment table relationship diagram correction module 4805, the deployment table operation receiving module 4810, the deployment table correction module 4815, the deployment table display module 4820, the relationship diagram operation receiving module 4825, the relationship diagram correction module 4830, and the relationship diagram display module 4835. The hardware includes the RAM 4502 that stores the programs or data, the ROM 4503 that stores, for example, a program used for activating the present computer, the HD 4504 that is an auxiliary storage device (which may be, for example, a flash memory) functioning as, for example, the relationship diagram deployment table storage module 125, the relationship diagram storage module 130, the deployment table storage module 135, or the relationship diagram deployment table association storage module 140, a receiving device 4506 that receives data based on user's operation (including, for example, action, voice, and gaze) on a keyboard, a mouse, a touch screen, a microphone, or a camera (including, for example, a gaze detection camera), an output device 4505 such as a CRT, a liquid crystal display, and a speaker, a communication line interface 4507 used for connection with a communication network, such as a network interface card, and a bus 4508 that connects these to each other in order to exchange data. In the hardware, plural computers may be connected to each other via a network.

In the above described exemplary embodiments, regarding one by a computer program, the computer program as software is read by a system of the present hardware configuration and then the software cooperates with hardware resources so as to implement the above described exemplary embodiments.

The hardware configuration illustrated in FIG. 59 indicates a configuration example, and the exemplary embodiment is not limited to the configuration illustrated in FIG. 43 as long as a configuration where modules described in the exemplary embodiment are executable is employed. For example, some modules may be constituted by dedicated hardware (e.g., an application specific integrated circuit (ASIC)), and some modules may be provided in the external system connected through a communication line. Further, plural systems illustrated in FIG. 43 may be connected to each other through a communication line to cooperate with each other. Especially, the configuration may be incorporated into, for example, a portable information communication device (including a cellular phone, a smart phone, a mobile device, or a wearable computer), information appliances, a robot, a copier, a facsimile, a scanner, a printer, or a multifunction device (an image processing device having any two or more among functions of, for example, a scanner, a printer, a copier, and a facsimile) as well as the personal computer.

The above described program may be provided while being stored in a recording medium, or may be provided via a communication unit. In such a case, for example, the above described program may be regarded as the disclosure of a “computer readable recording medium having a program recorded therein.”

The “computer readable recording medium having a program recorded therein” refers to a computer readable recording medium having a program recorded therein, which is used for installing, executing, and distributing the program.

Examples of the recording medium may include a digital versatile disk (DVD), e.g., “DVD-R, DVD-RW, and DVD-RAM” which are standards formulated in a DVD forum, and e.g., “DVD+R and DVD+RW” which are standards formulated in DVD+RW, a compact disk (CD), e.g., a read-only memory (CD-ROM), a CD recordable (CD-R), and a CD rewritable (CD-RW), a Blu-ray (registered trademark) disc, a magneto-optical disk (MO), a flexible disk (FD), a magnetic tape, a hard disk, a read only memory (ROM), an electrically erasable programmable read only memory (EEPROM (registered trademark)), a flash memory, a random access memory (RAM), and a secure digital (SD) memory card.

Then, the whole or a part of the above program may be stored or distributed while being recorded in the above recording medium. The program may be transmitted through a communication using a transmission medium such as a wired network or a wireless communication network used in, for example, a local area network (LAN), a metropolitan area network (MAN), a wide area network (WAN), the Internet, an intranet, and an extranet, or a combination thereof. Also, the program may be carried on a carrier wave.

The above program may be a part or the whole of another program, or may be recorded in a recording medium together with a separate program. Also, the program may be dividedly recorded in plural recording media. The program may be recorded in any manner such as compression or encryption, as long as the program may be restorable.

The above described exemplary embodiments (mainly, the first exemplary embodiment) may be grasped as follows.

For example, the exemplary embodiment may address the followings.

When a deployment table is created by specifying an arbitrary item from a relationship diagram as an axis, all items in the relationship diagram are not reflected as axis items in the deployment table. Therefore, it is thought that an inconsistency may occur when the deployment table is corrected, and the correction contents are reflected in the relationship diagram. For example, in a case where an axis item is corrected in the deployment table, even when the same correction is made to the same item as the axis item, in the relationship diagram, it is not possible to determine the relationship between the item as a correction target and another item (in particular, an item not reflected in the deployment table). Thus, it is thought that am inconsistency may occur when a correction result of the deployment table is automatically reflected in the relationship diagram.

According to the exemplary embodiment of the disclosure, there is provided an information processing apparatus and a non-transitory computer readable medium, in which a relationship diagram is displayed in association with a deployment table as a correction target so that reflection of correction contents may be easily performed.

What is claimed is:

1. An information processing apparatus comprising:
a correcting unit that corrects a relationship diagram corresponding to a deployment table when the deployment table is corrected; and
a display unit that displays parts in the relationship diagram corrected by the correcting unit in such a way that a corrected part is displayed in a different mode from uncorrected parts.

2. The information processing apparatus according to claim 1, further comprising a receiving unit that receives a user's operation indicating that the part in the corrected relationship diagram is approved with respect to the relationship diagram displayed by the display unit, wherein
when the operation is received by the receiving unit, the display unit changes the mode of the corrected part to a mode equivalent to the uncorrected parts.

3. The information processing apparatus according to claim 2, wherein
when the operation is received by the receiving unit, the correcting unit confirms correction of the part.

4. The information processing apparatus according to claim 1, further comprising a receiving unit that receives a user's operation indicating that an element is to be added into the middle of a relationship line that is one of parts in the relationship diagram when the relationship line is corrected, wherein
when the operation is received by the receiving unit, the display unit displays addition of the element into the middle of the relationship line.

5. The information processing apparatus according to claim 4, wherein
when the element is added into the middle of the relationship line, the correcting unit confirms correction of the relationship line.

6. The information processing apparatus according to claim 1, wherein
correcting the deployment table includes newly creating a deployment table, and
the display unit displays parts in a relationship diagram newly generated from the deployment table in such a way that a part in the newly generated relationship diagram is displayed in a different mode from a part in a case where a relationship diagram is created alone.

7. The information processing apparatus according to claim 6, further comprising a receiving unit that receives a user's operation indicating that the generated relationship diagram is approved with respect to the relationship diagram displayed by the display unit, wherein
when the operation is received by the receiving unit, the correcting unit confirms correspondence between the deployment table and the relationship diagram.

8. A non-transitory computer readable medium storing a program causing a computer to execute information processing, the information processing comprising:
correcting a relationship diagram corresponding to a deployment table when the deployment table is corrected; and
displaying parts in the corrected relationship diagram in such a way that a corrected part is displayed in a different mode from uncorrected parts.

9. An information processing apparatus comprising:
a receiving unit that receives an operation on a deployment table; and
a display unit that fails to delete, in a relationship diagram corresponding to the deployment table, a relationship line corresponding to a causal relationship in the deployment table and displays the relationship line distinguishably from other relationship lines in the relationship diagram corresponding to the deployment table when the operation instructs to delete the causal relationship in the deployment table.

10. The information processing apparatus according to claim 9, wherein
when the operation instructs to delete the causal relationship in the deployment table, the display unit fails to delete the causal relationship in the deployment table and displays the causal relationship distinguishably from other causal relationships.

11. The information processing apparatus according to claim 9, wherein
when the receiving unit receives an operation that instructs not to delete the relationship line displayed distinguishably from other relationship lines in the relationship diagram, the display unit returns display of the relationship line to display indistinguishable from other relationship lines.

12. The information processing apparatus according to claim 11, wherein
only when the receiving unit receives an operation that instructs to delete the relationship line displayed distinguishably from other relationship lines in the relationship diagram, the display unit deletes the relationship line from the relationship diagram.

13. The information processing apparatus according to claim 9, wherein
when the operation instructs to delete the causal relationship in the deployment table, a relationship line corresponding to the causal relationship is not deleted if deletion of the relationship line in a relationship diagram corresponding to the deployment table will change any other causal relationship in the deployment table.

14. The information processing apparatus according to claim 13, wherein
the display unit displays, distinguishably from other relationship lines, the relationship line that is not deleted.

15. The information processing apparatus according to claim 13, wherein
a relationship line corresponding to the causal relationship in the relationship diagram is deleted if deletion of the relationship line will not change any other causal relationship in the deployment table.

16. The information processing apparatus according to claim 13, wherein
if deletion of any of target relationship lines will change any other causal relationship on the deployment table, it is notified that such deletion is not allowed.
